(19) United States
(12) Patent Application Publication
(10) Pub. No.: US 2024/0185191 A1
(43) Pub. Date: Jun. 6, 2024

(54) Web3 Decentralized Blockchain Based NFT Framework... Applications

(71) Applicant: Avila Technology LLC, Fort Collins, CO (US)

(72) Inventor: ROBERT BERNARDI, MCLEAN, VA (US)

(21) Appl. No.: 18/061,373

(22) Filed: Dec. 2, 2022

(51) Int. Cl. G06Q 20/06; G06Q 20/02; H04L 9/00; H04L 9/32

(52) U.S. Cl. CPC G06Q 20/065; G06Q 20/02; H04L 9/008; H04L 9/3221; G06Q 2220/00

(57) ABSTRACT

The invention provides a Web3 Decentralized Blockchain Based NFT Framework for Buyers and Sellers Who Require Privacy, Security and Confidentiality Interworking with Zero Trust Security, Digital Rights Management (DRM), Self-Sovereign Identity Management, Ricardian Contracts, NFT Ownership and Copyright Validation, IPFS Decentralized Storage, WebRTC-QUIC Real Time Communications, Cross-Chain Interoperability and Tokenization of Illiquid Digital Assets such as Patents and University Research Papers using Blockchain NFTs and Artificial Intelligence (AI) Applications.

### BACKGROUND

### Field of the Invention

The invention relates to systems and methods for providing a Web3 Decentralized Blockchain Based Secure NET Framework for Buyers and Sellers Who Require Privacy, Confidentiality and Copyright Ownership Verification Interworking with Zero Trust Security, Digital Rights Management (DRM), Self-Sovereign Identity Management, NFT Copyright & Ownership Validation, Off-Chain IPFS Decentralized Storage, WebRTC-QUIC Real Time Communications and Cross-Chain Interoperability.

### Background of the Invention

Traditional non-fungible token (NFT) platforms have significant security vulnerabilities.

Security issues associated with software and systems that are integral to NFT systems and products in the market today which are vulnerable to security breaches include: User Authentication, Identity Management and Digital Wallets, Blockchain, Decentralized Applications (DApps) and Smart contract and/or Ricardian contracts, NFT Minting, NFT Bidding and Trading System, On-Chain Storage, NFT Scaling and Off-Chain Indexing, and Off-Chain Storage. NFT security issues also involve external security entities including ERC-721 Compliance and Vulnerabilities, Counterfeit NFT Product Creation, Fraudulent NFT Trading Practices, External Documents and Smart contract and/or Ricardian contracts, Content Messaging and Multimedia Communications between NFT buyers and sellers.

According to a blockchain security firm (Beosin), Web 3.0 witnessed 48 major cyber-attacks in the second quarter of 2022 with total losses of approximately $718.34 million; three attacks with losses of $100 million or more, 12 attacks with losses of $10 million or more, and 28 attacks with losses of $1 million or more. It was noted that this figure is down 40% from the $1.2 billion in losses tallied in the first quarter of 2022 but 142% higher than the recorded losses in Q1 2021 worth $296.56 million.

Non-fungible token (NFT) hacks have led to losses of almost $52 million in the first four months of 2022 alone compared with less than $7 million over the whole of 2021, according to report by Top10VPN, a global digital privacy and research group. Sports NFT platform Lympo suffered the worst loss when it experienced a hot wallet security breach and lost tokens worth $18.7 million in January 2022. Bored Ape Yacht Club, one of the most well-known NFT projects, was hacked in April 2022 when its official Instagram account was compromised and used to send a phishing message. The stolen NFTs because of this were reportedly worth $3 million.

Accordingly, a secure platform is needed for NFT systems and products.

### SUMMARY OF THE INVENTION

The invention provides a Blockchain based private NFT architecture framework based on a “Zero Trust NFT Security Enclave” to provide private NFTs between buyers and sellers who require complete anonymity and confidentiality with private NFT transactions interworking with a zero-trust security platform having public-key encryption, self-sovereign identity management, zero knowledge proofs (ZKP), multi-party computation (MPC), digital rights management (DRM), and homomorphic encryption, where the platform is configured to obfuscate user identities, use blockchain transactions, use smart contract and/or Ricardian contracts, use off-chain IPFS storage and provide secure peer-to peer WebRTC communications between buyers and sellers.

With private NFTs, validation of fungibility happens without opening verifiability to everyone. In other words, verifiable ownership of digital art, digital real estate, or intellectual property (IP) such as patents and copyrights does not have to be public. On a Private NFT platform, the process of validation occurs without compromising any private data, smart contract and/or Ricardian contracts or peer-to-peer messaging communications, including proof of authenticity and ownership transfers.

In a preferred aspect, the Private NFT platform empowers content creators and protects digital rights related to crypto art and property.

In a preferred embodiment, the private NFT platform supports both public and private metadata transactions on Blockchain.

In another preferred embodiment, the Private NFT platform provides an optional private only metadata presentation. This feature unlocks use cases such as, without limitation, for NFT art with embedded secure links to high-value pictures, games with hidden secrets and abilities, and for NFT intellectual property (IP) such as patents which contain unique technology, functionality and methods for patent owners and buyers.

To avoid the problems stemming from NFTs being designed to be scarce, where anyone can discover who owns a traditional public NFT and identify individual buyers and sellers, the invention allows for private NFT ownership to ensure that the valuable assets, smart contract and/or Ricardian contracts and data transactions are not exposed to everyone.

In another preferred embodiment, the Private NFT platform allows creators to choose who has full access to their digital art or patent portfolio. For example, an artist can create a thumbnail or digital watermarked version of a valuable picture so that buyers can have a good perspective of what they are buying, but the full resolution version is private and must be purchased to view it.

In another preferred embodiment, the Private NFT platform architecture is seamlessly integrated with the following Web3 p2p decentralized networks: IPFS P2P Decentralized Data Storage—a peer-to-peer protocol for decentralized media content storage system for storing and accessing files, Websites, and data, and WebRTC-QUIC—a real-time multimedia communications platform that enables Web3 applications to capture and stream audio and/or video media, and to exchange data between browsers without requiring an intermediary servers or websites and without requiring the user to install plug-ins or any other third-party software to provide secure video chats and content messaging between private NFT buyers and sellers.

### BRIEF DESCRIPTION OF THE DRAWINGS

FIG. 1 is a diagram illustrating the comparison of public NFTs vs. Private NFTs.

FIG. 2 is a diagram illustrating the Private NFT architecture and Zero Trust Security Enclave.

FIG. 3 is a diagram illustrating the Web3 p2p decentralized blockchain, self-sovereign identity (SSI) management, off-chain indexing/scaling and Web3 UI/application logic.

FIG. 4 is a diagram illustrating the Private NFT p2p Decentralized Networks including DRM with File Rendering, IPFS Storage, WebRTC-QUIC Multimedia Communications and Video Storage and Sharing Platform.

FIG. 5 is a diagram illustrating a summary of traditional NFT internal and external security issues.

FIG. 6 is a diagram illustrating the Zero Trust Security Framework.

FIG. 7 is a diagram illustrating the Traditional Perimeter Security Versus Zero Trust Security Enclave.

FIG. 8 is a diagram illustrating the Zero Trust Security Enclave Interworking with Blockchain based Private NFTs.

FIG. 9 is a diagram illustrating Public Key Encryption,

FIG. 10 is a diagram illustrating Self Sovereign Identity Management.

FIG. 11 is a diagram illustrating the Zero Knowledge Proof—Its Role in Blockchain for Authentication.

FIG. 12 is a diagram illustrating Digital Rights Management with File Rendering.

FIG. 13 is a diagram illustrating the Secure Multiparty Computation Protocol (Secure MPC).

FIG. 14 is a diagram illustrating Homomorphic Encryption.

FIG. 15 is a diagram illustrating DID infrastructure.

FIG. 16 is a diagram illustrating verifiable credentials.

FIG. 17 is a diagram illustrating an overview of SSI stack.

FIG. 18 is a diagram illustrating SSI for private NFTs interworking with Zero Trust Security using DIDCom messaging and WebRTC.

FIG. 19 is a diagram illustrating SSI for Private NFT Interworking with Zero Trust Security Architecture Design.

FIG. 20 is a diagram illustrating SSI verifiable credentials and decentralized identifiers for credentialing and validation from issuer to holder to verifier.

FIG. 21 is a diagram illustrating SSI Digital Rights (DRM) Protected Messaging for a complete process of sending and viewing a DRM message.

FIG. 22 is a diagram illustrating IPFS Architecture Diagram for Data Sharing on IPFS by a Smart contract and/or Ricardian contract Owner

FIG. 23 is a diagram illustrating the IPFS Content Addressing Flow Process

FIG. 24 is a diagram illustrating the IPFS protocol stack built on top of content addressable Web Modular Naming System and libp2p routing and network protocols.

FIG. 25 is a diagram illustrating the IPFS-Blockchain Workflow—A process for securing and sharing data files.

FIG. 26 is a diagram illustrating the 3 Main Abstractions of WebRTC-QUIC Transport.

FIG. 27 is a diagram illustrating the WebRTC-QUIC Connection Setup for Private NFT Video Chats and Content Messaging.

FIG. 28 is a diagram illustrating the WebRTC-QUIC HTTP/3 Protocol Stack.

FIG. 29 is a diagram illustrating the Comparison of HTTP/2—TLS with HTTP/3 UDP-QUIC.

FIG. 30 is a diagram illustrating the UDP-QUIC versus TCP for RTT Connection Establishment for Video Streams.

FIG. 31 is a diagram illustrating Network stack comparison of QUIC, MPTCP, and MPQUIC.

FIG. 32 is a diagram illustrating WebRTC video service over QUIC media channels.

FIG. 33 is a diagram illustrating Janus WebRTC Gateway implementations.

FIG. 34 is a diagram illustrating Janus Extensible Architecture over API.

FIG. 35 is a diagram illustrating G-streamer with Janus WebRTC gateway.

FIG. 36 is a diagram illustrating WebRTC Media Channel video room broadcasting with Janus.

FIG. 37 is a diagram illustrating WebRTC messaging service over QUIC data channels.

FIG. 38 is a diagram illustrating WebRTC-QUIC+DRM protection.

FIG. 39 is a diagram illustrating WebRTC-QUIC videochat flow diagram with DRM protection.

FIG. 40 is a diagram illustrating private video chat with DRM using WebRTC-QUIC.

FIG. 41 is a diagram illustrating WebRTC-QUIC with DRM violation.

FIG. 42. is a diagram illustrating screen capture disablement for Android and iOS.

FIG. 43 is a diagram illustrating splitting an image into tiles.

FIG. 44 is a diagram illustrating splitting an image into tiles using NumPg.

FIG. 45 is a diagram illustrating applying NumPg to image pixel splitting.

FIG. 46 is a diagram illustrating a summary of screen capture disablement of photos and pics that cannot be captured and copied in a smartphone.

FIG. 47 is a diagram illustrating image pixel splitting technology process.

FIG. 48 is a diagram illustrating image processing and manipulation.

FIG. 49 is a diagram illustrating Screen Capture Disablement of Private NFT Images Using Pixel Interlacing and DRM

FIG. 50 is a diagram illustrating file rendering with fast media server refresh rates image CDNs.

FIG. 51 is a diagram illustrating file rendering with fast refresh for content messaging.

FIG. 52 is a diagram illustrating Screen Capture Disablement picture rendering and screen capture view by receiver smart phone.

FIG. 53 is a diagram illustrating Private NFT Cross-Chain Communications Interworking with IPFS Storage, DRM File Rendering and UDP-QUIC Transport Protocol

FIG. 54 is a diagram illustrating Private NFT Cross-Chain Communications Interworking with Web3 UI, IPFS File Sharing System and IPFS p2p Storage Gateway

FIG. 55 is a diagram illustrating Private NFT Cross-Chain Communications Protocol Stack

FIG. 56 is a diagram illustrating Cross-Chain Communication

FIG. 57 is a diagram illustrating Cross Chain Communications using a Zero Trust Security Interoperability Gateway Nodes to Enable Secure Smart contract and/or Ricardian contract Communications among different Blockchains

FIG. 58 is a diagram illustrating Dynamic NFTs

FIG. 59 is a diagram illustrating Blockchain Integration with Artificial Intelligence

FIG. 60 is a diagram illustrating How Blockchain Can Transform AI

FIG. 61 is a diagram illustrating Web3 Decentralized AI Applications

FIG. 62 is a diagram illustrating Private NFT Patent Marketplace Interworking with Zero Trust Security Enclave.

FIG. 63 is a diagram illustrating NFT Based Patent Framework and Copyright Validation and verification System Integrated with the USPTO and WIPO.

FIG. 64 is a diagram illustrating NFT Marketplace module in communication with an IPFS Gateway Copyright Registry module, an IPFS Decentralized Storage module, a WebRTC-QUIC/UDP Communications module, and an NFT Copyright Insurance module.

FIG. 65 is a diagram illustrating a Comparison Table of Ricardian Contracts vs. Smart contract and/or Ricardian contracts.

FIG. 66 is a diagram illustrating a Ricardian contract exemplified in legal prose vs. structured language.

FIG. 67 is a diagram illustrating NFT Ricardian Contracts for Copyright Ownership in a Validation and Verification Network.

FIG. 68 is a diagram illustrating Copyright Ownership Transfer and Verification Process for NFT Transactions Interworking with Zero Trust Security in a Zero Trust Network Access (ZTNA).

FIG. 69 is a diagram illustrating Zero Trust Network Access (ZTNA) Using DRM File Rendering and Digital Watermarking.

FIG. 70 is a diagram illustrating IPFS Copyright Registry Workflow for Securing and Sharing Ricardian Contracts using IPFS Decentralized Storage, Step 1—Registration, Step 2—File Creation and Storage.

FIG. 71 is a diagram illustrating IPFS Copyright Registry Workflow for Securing and Sharing Ricardian Contracts using IPFS Decentralized Storage, Step 3 File Access and Retrieval.

FIG. 72 is a diagram illustrating IPFS Copyright Registry Workflow for Securing and Sharing Ricardian Contracts using IPFS Decentralized Storage, Step 4 Validation Process for File and Editing Applications.

FIG. 73 is a diagram illustrating Tokenization of Patents for SMEs and Individuals using Blockchain NFTs and Artificial Intelligence (AI).

FIG. 74 is a diagram illustrating the Applicability of Tokenization for Patents.

### DETAILED DESCRIPTION OF THE INVENTION

The invention provides a blockchain based private NFT architecture framework based on a “Zero Trust NFT Security Enclave” to provide private NFTs between buyers and sellers who require complete anonymity and confidentiality with private NFT transactions. In the present invention, validation of fungibility happens without opening verifiability to everyone and verifiable ownership of digital art, digital real estate, or intellectual property (IP) such as patents and copyrights does not have to be public. In the inventive private NFT platform, the process of validation occurs without compromising any private data, smart contract and/or Ricardian contracts or peer-to-peer messaging communications, including proof of authenticity and ownership transfers.

Any of the private NFTs of the present invention support both public and private metadata transactions on Blockchain and may also provide an optional private only metadata presentation. This feature unlocks use cases like for NFT art with embedded private links to high-value pictures, games with hidden privates and abilities, and for NFT intellectual property (IP) such as patents which contain unique technology, functionality and methods for patent owners and buyers.

Since NFTs are designed to be scarce, anyone can discover who owns a traditional public NFT and identify individual buyers and sellers. Allowing for private NFT ownership ensures the valuable assets, smart contract and/or Ricardian contracts and data transactions do not need to be exposed to everyone. Private NFTs allow creators to choose who has full access to their digital art or patent portfolio. For example, an artist can create a thumbnail or digital watermarked version of a valuable picture so that buyers can have a good perspective of what they are buying, but the full resolution version is private and must be purchased to view it.

In a preferred non-limiting embodiment of the present invention, there is provided a system for private NFT architecture with Zero Trust Security platform, comprising:
a Web3 Client Platform (“Platform”) having application logic, JavaScript, HTML, and CSS;
an Ethereum Blockchain module (“EB module”) in operative communication with Web3 clients, the EB module having Smart contract and/or Ricardian contract, Ricardian Contract, and Decentralized IDs;
a Zero Trust Security Platform (“ZTSP”) in operative communication with the EB module and having DRM, Zero Knowledge Proofs, Multi-Party Computation, Homomorphic Encryption, and Asymmetric Encryption (ECDH);
an NFT Marketplace module (“NFT module”) in operative communication with the PPS platform and having seller side ownership verification and NFT creation modules, and a buyer side certification and token issue modules;
a Peer-to-Peer Decentralized Network module (“P2P de-Net”) in operative communication with the NFT module and having DRM, IPFS, and WebRTC-QUIC, and using a HTTP/3-QUIC-UDP Transport layer protocol;
a Mint NFT module is in operative communication with the EB module and receives registration from a Seller-side module having Self-Sovereign ID (SSI), a Digital Wallet and a browser, the Seller-side module is in operative communication with the ZTS Platform and the Seller-side module is in operative communication with a Layer 2 scaling solution on the Ethernet network, the Layer 2 scaling module is in operative communication with the NFT module; and
an On-chain module is in operative communication with the EB module and receives authentication from a Buyer-side module having SSI, a Wallet, and a browser, the Buyer-side module is in operative communication with the ZTS Platform and the Buyer-side module is in operative communication with a an indexing protocol for querying networks like Ethereum and IPFS decentralized storage, the indexing is in operative communications with the NFT module using APIs, called subgraphs, making data easily accessible with the NFT module.

In a preferred non-limiting embodiment of the present invention, there is provided a method, comprising:
implementing a Blockchain based private NFT framework to facilitate both public and private or simply private NFT auctions in an NFT market for NFT buyers and sellers who require security, anonymity, and confidentiality for NFT applications including art, gaming, intellectual property (IP), sports, gaming real estate and music, using the system described and claimed herein.

In another preferred non-limiting embodiment of the present invention, there is provided a system for private NFT architecture with a Zero Trust Security Enclave (ZTSE) designed to secure and restrict user access to private NFT auctions to authorized and vetted buyers and sellers, comprising:
a Web3 Client Platform (“Platform”) having application logic, JavaScript, HTML, and CSS;
a Ethereum Blockchain module (“EB module”) in operative communication with the Web3 client and server, the EB module having Smart contract, Ricardian Contract, and Decentralized IDs;
a Zero Trust Security Platform in operative communication with the EB module and having DRM, Zero Knowledge Proofs, Multi-Party Computation, Homomorphic Encryption, and Asymmetric Encryption (ECDH);
an NFT Marketplace module (“NFT module”) in operative communication with the ZTS platform and having seller side ownership verification and NFT creation modules, and a buyer side certification and token issued modules;
a Peer-to-Peer Decentralized Network (“P2P de-Net”) in operative communication with the NFT module and having DRM, IPFS, and WebRTC-QUIC, and using a HTTP/3-QUIC-UDP Transport Layer Protocol;
a Mint NFT module is in operative communication with the EB module and receives registration from a Seller-side module having SSI, a Wallet, and a browser, the Seller-side module is in operative communication with the ZTS Platform and the Seller-side module is in operative communication with a layer 2 scaling module on the Ethernet network, the scaling module is in operative communication with the NFT module;
an On-chain module is in operative communication with the EB module and receives authentication from a Buyer-side module having SSI, a Wallet, and a browser, the Buyer-side module is in operative communication with the ZTS Platform and the Buyer-side module is in operative communication with a layer 2 scaling module having off-chain indexing, the scaling module is in operative communication with the NFT module; and
a Zero Trust Security Enclave (ZTSE) module configured to secure and restrict user access to a private NFT auction to authorized and vetted buyers and sellers.

In another preferred non-limiting embodiment of the present invention, there is provided a Zero Trust Security Enclave, comprising:
a Zero Trust Architecture module having a Web3 Decentralized Network module with a Blockchain-Smart contract and/or Ricardian contracts module and a UDP-QUIC Protocol Stack module using a HTTP/3-QUIC-UDP Transport layer protocol; and
the Zero Trust Architecture module configured with a Public-key Encryption (PKI) module, a Self-Sovereign Identity (SSI) module, a Zero Knowledge Proof (ZKP) module, a Multi-Party Computation (MPC) module, a Digital Rights Management (DRM) module, and a Homomorphic Encryption (HE) module.

In another preferred non-limiting embodiment of the present invention, there is provided a Private NFT Architecture comprising:
1) an Ethereum 2.0 (EVM) module;
2) a Smart contract and/or Ricardian contracts and Ricardian Contracts module;
3) an On-Chain Storage module;
4) an NFT Minting module;
5) a NFT Scaling module; and
6) an Off-Chain Indexing module.

In another preferred non-limiting embodiment of the present invention, there is provided a Private NFT Marketplace, comprising:
1) an Ownership Verification module;
2) a Certification module;
3) an NFT Creation module; and
4) a Token Issuance module.

In another preferred non-limiting embodiment of the present invention, there is provided a Web 3 Architecture, comprising:
1) a Digital Wallets based on SSI module;
2) a UI/Application Logic module;
3) an SSI—Identity Management module;
4) a Blockchain module;
5) a Private Contracts, Ricardian Contracts module;
6) an Off-Chain Indexing Protocol module; and
7) an L2 Scaling-Sharding-Rollups module.

In another preferred non-limiting embodiment of the present invention, there is provided a Peer-to-Peer Network, comprising:
1) an IPFS Decentralized P2P Storage module; and
2) a WebRTC-QUIC p2p Multimedia Communications module using a HTTP/3-QUIC-UDP Transport layer protocol and having
a Video Channel—Zero latency module,
a Data Channel—Content Messaging+Attachments (pictures) module, and
a Voice Channel—VOIP module.

In another preferred non-limiting embodiment of the present invention, there is provided a Web3 Technologies system, comprising:
1) a Web3 Clients module; 2) SSI-Digital Wallet; 3) UI/Application Logic (Java Script, HTML); 4) an Off-chain Indexing module; 5) a Blockchain module; 6) a Smart contract and/or Ricardian contracts—DAPPS module; and 7) an L2 Scaling module.

Any of the systems or methods provided herein may include an embodiment comprising an NFT Zero Trust Security module configured to provide:
a User Authentication module;
a Blockchain Smart contract and/or Ricardian contracts module;
an NFT Minting module;
an On-Chain Storage module;
an Off-Chain Indexing module;
an Off-Chain Storage module using IPFS decentralized storage; and
an External Security Issues module having
a ERC-721 Compliance Vulnerabilities module;
an Counterfeit NFT Product creation module;
a Fraudulent NFT Trading Practices module; and
an External Document, Smart contract and/or Ricardian contract theft module.

Any of the systems or methods provided herein may include an embodiment comprising an IPFS p2p Protocol Network module for storing and sharing Blockchain data and smart contract and/or Ricardian contracts.

Any of the systems or methods provided herein may include an embodiment comprising a WebRTC-QUIC for private video chats and secure content messaging between buyers and sellers using real-time communications having
QUIC Protocol
Low latency video (p2p)
Content messaging (p2p)—Word, PDF, Jpeg, Mpeg and text

Any of the systems or methods provided herein may include an embodiment comprising a Digital Rights Management (DRM) module configure for using content rendering.

Any of the systems or methods provided herein may include an embodiment comprising a Blockchain-Artificial Intelligence Integration module having: 1) a Decentralized AI applications module configured to provide 1 Adaptive computing, 2 Discovery and Management, 3 Intelligent Agents, 4 Learning Algorithms; and 2) a Decentralized AI Operations module configured to provide 1 IPFS Decentralized Storage, 2 Data Management, 3 Learning Models; and 3) a Decentralized Infrastructure for AI Applications module configured to provide Linear Blockchain and Non-Linear Blockchain.

Any of the systems or methods provided herein may include an embodiment comprising a Screen capture Disablement module for Private NFT Images (Pictures Art, Photos) shared Between Private NFT Buyers and Sellers.

Any of the systems or methods provided herein may include an embodiment comprising an International Private NFT Patent and IP Marketplace module configured to provide
an Embedded Automatic royalty collecting module;
a Licensed Revenues module;
a Digital Assets (Patents, Movies, Art, Virtual Creations) module; and
an International Patent NFT Marketplace module Integrated with a patent database such as USPTO and WIPO.

### Methods

In a preferred non-limiting embodiment of the present invention, there is provided a method, comprising:
Sending, in a WebRTC application on a first NFT transaction party first NFT transaction party user communication device, a private IP address of the first NFT transaction party user communication device and a JSON invite message, to a WebRTC-Gateway Server, the JSON invite message includes a private IP address to a second NFT transaction party user communication device and a message to join a communication session, the WebRTC-Gateway Server sends the JSON invite message to the second NFT transaction party user communication device,
Sending, in a WebRTC application on the second NFT transaction party user communication device, a JSON message reply containing an answer (accept/decline) to the invite to the WebRTC-Gateway Server,
Establishing a communication between the WebRTC-Gateway Server and a Signaling Server, said Signaling server used to provide communication discovery and media format negotiation between the first communication device and the second NFT transaction party user communication device by a first communication device connection offer and a second NFT transaction party user communication device acceptance reply based on connecting a public-private IP address of the first communication device to a public-private IP address of the second NFT transaction party user communication device,
Establishing an encrypted WebRTC peer-to-peer video, audio and/or data connection between the WebRTC application of the first communication device and the WebRTC application of the second NFT transaction party user communication device, and deploying an advanced security technology module to provide user-based permission control when communicating and sharing rich media content including AES 256 Galois/Counter mode (GCM), Elliptical-curve Diffie Hellman encryption, and a asymmetrical key management system,
Providing a Private Blockchain module connected to the WebRTC-Gateway Server to provide a permission-based access control layer to govern network access by the first communication device and the second NFT transaction party user communication device and to generate an immutable record of all WebRTC transactions between the first communication device and the second NFT transaction party user communication device,
Providing a Distributed Ledger Technology (DLT) module connected to the WebRTC-Gateway Server for recording WebRTC transactions including video, audio, and data and storing the WebRTC transactions with user personally identifiable information (PII) in distributed blocks stored and recorded in multiple locations,
Providing a Group Node Coupling module connected to the WebRTC-Gateway Server for searching and connecting the first communication device with the second NFT transaction party user communication device from a Distributed Directory of Connected Devices and to access distributed blocks when the first communication device initiates the communication session,
Providing a DRM module to apply user permissions relating to video/audio/telemetry streaming on a P2P connection, said user permissions including blocking video recording, playback, screenshot disablement, expiration, revocation, and watermarking, and
Providing a private (secret) video chat module using DRM control and ECDH encryption to prevent video recording/playback using an encrypted key with expiration and revocation controls.

Any of the methods provided herein may include an embodiment comprising the step of saving a NFT communication session comprising the video, audio, and data, in an encrypted communication between the first communication device and a Web3 decentralized platform (Platform) comprised of p2p connection module, a Blockchain module, an IPFS storage module, and an optional Rendering module, the Platform connected to the first communication device, wherein the video chat and voice chat are stored by the IPFS platform.

Any of the methods provided herein may include an embodiment wherein the Platform uses a Distributed Hash Table, and wherein the telephone number of the first communication device (or SSI public or private encryption keys) is a key mapped to a second value that is the NFT communication session.

Any of the methods provided herein may include an embodiment comprising: assigning, in a menu of the WebRTC chat application on the first communication device, a DRM permission to the NFT communication session saved to the Platform, wherein the DRM permission is selected from the group consisting of: record, not record, store, screen share, revoke, expire, offline view, blacklist, copy, forward, screen capture, rights violation, and cancel/disappear.

Any of the methods provided herein may include an embodiment comprising: rendering, in a Rendering module of the decentralized Platform, an HTML file of the saved NFT communication session, the HTML file stored in the storage platform and having a URL link associated therewith, the Web3 Platform comprised of p2p connection module, a Blockchain module, an IPFS module, and the connected Rendering module.

Any of the methods provided herein may include an embodiment comprising: enforcing the DRM permission of the NFT communication session, said decentralized storage in encrypted communication with the second communication device, said second communication device having the WebRTC application operatively connected to the WebRTC browser of the second communication device to access, using the URL link, the HTML file of the saved NFT communication session saved in the Platform, wherein the saved NFT communication session is rendered on the Platform, and said WebRTC application enforces the DRM permission of the saved NFT communication session using a DRM enforcement module in the WebRTC application, and said DRM enforcement module configured to send an enforcement command when a DRM permission violation is detected to revoke an encryption key that encrypts an electronic signal between the WebRTC application and the WebRTC browser, wherein the electronic signal is between a CODEC in the WebRTC browser and a playback component or module for a speaker or display of the second communication device.

Any of the methods provided herein may include an embodiment wherein the WebRTC application comprises a Private Blockchain module in communication with the Platform to provide user identity, authentication, a digital hash, personally identifiable information (PII) security, and IPFS decentralized storage using content linking, content searching, and content addressing.

Any of the methods provided herein may include an embodiment wherein the WebRTC application comprises a hardware security module in communication with the Platform to provide AES 256 GCU encryption, and ECDH Diffie-Hellman encryption for audio and video streams.

Any of the methods provided herein may include an embodiment wherein the WebRTC application comprises a key management module in communication with the WebRTC-Gateway Server and the Signaling Server to provide homomorphic encryption of a communication between the WebRTC-Gateway Server and the Signaling Server, said homomorphic encryption allowing the Signaling Server to extract the private IP address without decrypting the JSON SMS message.

Any of the methods provided herein may include an embodiment wherein the WebRTC application has an insertable streams module to provide end-to-end encryption for a middlebox device and for Selective Forwarding Units (SFUs) for media routing in a videoconference application where insertable streams iterate on frames and not RTP packets to transform an encoded frame to an asynchronous insertable stream to support end-to-end encryption.

Any of the methods provided herein may include an embodiment wherein the first communication device is selected from a mobile communication device, a desktop computer communication device, and a tablet communication device.

### Systems & Platforms

In another preferred embodiment of the invention, there is provided an NFT transaction communication system and sharing platform, comprising:
a WebRTC application of a first NFT transaction party communication device having program instructions saved to memory and executable on a processor to establish an encrypted peer-to-peer chat communication with a second NFT transaction party user communication device having said WebRTC application,
said WebRTC application having a discovery module with program instructions to send a discovery request to obtain an IP address of the second NFT transaction party user communication device, wherein the WebRTC application is installed on the second NFT transaction party user communication device,
said WebRTC application having a blockchain module to connect the first NFT transaction party communication device as a first node to the second NFT transaction party user communication device as a second node in a Private Blockchain network,
the WebRTC application having an invite module to send an invite message to a communication session from the first NFT transaction party communication device to the IP address of the second NFT transaction party user communication device through a WebRTC browser extension to a WebRTC signaling server operatively connected to the Private Blockchain network; and
the WebRTC application having an accept-connection module to establish encrypted WebRTC peer-to-peer connection between the WebRTC browser of the first NFT transaction party communication device and a second WebRTC browser of the second NFT transaction party user communication device in response to an acceptance by the second NFT transaction party user communication device of the invite sent by the first NFT transaction party communication device, and
the WebRTC application having a video module, an audio module, and telemetry module.

Any of the systems and platforms provided herein may include an embodiment comprising a Saving Module in the WebRTC application to transmit the communication session, in an encrypted communication between the first NFT transaction party communication device and a Web3 Platform, using a distributed hash table, wherein the IP address of the first NFT transaction party communication device is a key mapped to a second value that is a saved communication session.

Any of the systems and platforms provided herein may include an embodiment comprising a DRM Module in the WebRTC application to assign, using a menu of the WebRTC application on the first NFT transaction party communication device, a DRM permission to the communication session saved to the Web3 Platform, wherein the DRM permission is selected from the group consisting of: record, not record, store, screen share, revoke, expire, offline view, blacklist, copy, forward, screen capture, rights violation, and cancel/disappear.

Any of the systems and platforms provided herein may include an embodiment comprising a Rendering Module in the WebRTC application to render in the Web3 Platform, an HTML file of the saved communication session, the HTML file stored in the Web3 Platform and having a URL link associated therewith.

Any of the systems and platforms provided herein may include an embodiment comprising a DRM Enforcement Module in the WebRTC application to enforce the DRM permission of the communication session, and having programming instructions wherein said Web3 Platform is in encrypted communication with the second NFT transaction party user communication device, said second NFT transaction party user communication device having the WebRTC application operatively connected to the WebRTC browser of the second NFT transaction party user communication device to access, using the URL link, the HTML file of the saved communication session and rendering the saved communication session on the Web3 Platform, and said WebRTC application enforces the DRM permission of the saved communication session using the DRM enforcement module in the WebRTC application, and said DRM enforcement module configured to send an enforcement command when a DRM permission violation is detected to revoke an encryption key that encrypts an electronic signal between the WebRTC application and the WebRTC browser, wherein the electronic signal is between a CODEC in the WebRTC browser and a playback component or module for a speaker or display of the second NFT transaction party user communication device.

Any of the systems and platforms provided herein may include an embodiment comprising a Private Blockchain Module in the WebRTC application to communicate with the Web3 Platform and provide user identity, authentication, a digital hash, Self-Sovereign ID (SSI) security, and IPFS decentralized storage using content linking, content searching, and content addressing.

Any of the systems and platforms provided herein may include an embodiment comprising a Hardware Security Module (HSM) in the WebRTC application to communicate with the Web3 Platform to provide AES 256 GCU encryption, and ECDH Diffie-Hellman encryption for audio and video streams.

Any of the systems and platforms provided herein may include an embodiment comprising a key management module in communication with the WebRTC-Gateway Server and the Signaling Server to provide homomorphic encryption of a communication between the WebRTC-gateway Server and the Signaling Server, said homomorphic encryption allowing the Signaling Server to extract the private IP address without decrypting the JSON SMS message.

Any of the systems and platforms provided herein may include an embodiment wherein the first NFT transaction party communication device is selected from a mobile communication device, a desktop computer communication device, and a tablet communication device.

In another preferred embodiment of the invention, there is provided an NFT transaction communication system and sharing platform, comprising:
a WebRTC application of a first NFT transaction party communication device having program instructions saved to memory and executable on a processor to establish an encrypted peer-to-peer communication with a second NFT transaction party user communication device having said WebRTC application,
a WebRTC-Gateway Server having program instructions saved to memory and executable on a processor to provide communication discovery and media format negotiation between the first NFT transaction party communication device and the second NFT transaction party user communication device,
a Signaling Server connected to the WebRTC-Server, said Signaling Server having program instructions saved to memory and executable on a processor to provide a public-private IP address to the first NFT transaction party communication device in response to a JSON invite to join a video/audio/telemetry communication session and to provide a public-private IP address of the second NFT transaction party user communication device in response to an acceptance reply,
said WebRTC application having program instructions to:
Send, in the WebRTC application on the first NFT transaction party communication device, a private device IP address of the first communication device, and a JSON message invite for the second NFT transaction party user communication device, the JSON message containing an invite to join the video/audio/telemetry communication session, to the WebRTC-Gateway Server to mediate media communications and exchange JSON messages and RTP/RTCP messages with the second NFT transaction party user communication device,
Send, in the WebRTC application on the second NFT transaction party user communication device, a JSON message reply containing an answer (accept/decline) to the invite and a private IP address of the second NFT transaction party user communication device to the WebRTC-Gateway Server,
said WebRTC-Gateway Server and a Signaling Server having program instructions to provide communication discovery and media format negotiation between the first NFT transaction party communication device and the second NFT transaction party user communication device by a first NFT transaction party communication device connection offer and a second NFT transaction party user communication device acceptance reply based on connecting the public-private IP address of the first NFT transaction party communication device to the public-private IP address of the second NFT transaction party user communication device,
and establish an encrypted WebRTC peer-to-peer video and/or audio connection between the WebRTC application of the first NFT transaction party communication device and the WebRTC application of the second NFT transaction party user communication device, and deploy an advanced security technology module to provide user-based permission control when communicating and sharing rich media content including AES 256 Galois/Counter mode (GCM), Elliptical-curve Diffie Hellman encryption, and a asymmetrical key management system,
a Private Blockchain module connected to the WebRTC-Gateway Server to provide a permission-based access control layer to govern network access by the first NFT transaction party communication device and the second NFT transaction party user communication device and to generate an immutable record of all WebRTC transactions between the first NFT transaction party communication device and the second NFT transaction party user communication device,
a Distributed Ledger Technology (DLT) module connected to the WebRTC-Gateway Server for recording WebRTC transactions including video, audio, and data and storing the WebRTC transactions with user Self-Sovereign (SSI) ID in distributed blocks stored and recorded in multiple locations,
a Group Node Coupling module connected to the WebRTC-Gateway Server for searching and connecting the first NFT transaction party communication device with the second NFT transaction party user communication device from a Distributed Directory of Connected Devices and to access distributed blocks when the first communication device initiates the communication session,
a DRM module to apply user permissions relating to video/audio/telemetry streaming on a P2P connection, said user permissions including blocking video recording, playback, screenshot disablement, expiration, revocation, and watermarking, and
a private video chat module using DRM control and ECDH encryption to prevent video recording/playback using an encrypted key with expiration and revocation controls;
wherein the WebRTC application comprises a video module, an audio module, and a telemetry module, each module providing recording, streaming, playback, encryption, and storage,
wherein a communication session comprising the video/audio/telemetry, is saved in an encrypted communication between the first NFT transaction party communication device and a Web3 Platform connected to the first NFT transaction party communication device, wherein the video/audio/telemetry are stored by the Web3 Platform,
wherein the Web3 Platform uses a Distributed Hash Table, and wherein the IP address of the first NFT transaction party communication device is a key mapped to a second value that is the communication session, and
in a menu of the WebRTC application, a selection option to assign a DRM permission to the communication session saved to the Web3 Platform, wherein the DRM permission is selected from the group consisting of: record, not record, store, screen share, revoke, expire, offline view, blacklist, copy, forward, screen capture, rights violation, and cancel/disappear,
a rendering module on the Web3 Platform, to render an HTML file of the saved communication session, the HTML file stored in the Web3 Platform and having a URL link associated therewith,
a DRM enforcement module on the Web3 Platform, to enforce the DRM permission of the communication session using said Web3 Platform in encrypted communication with the second NFT transaction party user communication device, said second NFT transaction party user communication device having the WebRTC application operatively connected to the WebRTC browser of the second NFT transaction party user communication device to access, using the URL link, the HTML file of the saved communication session saved in the Web3 Platform, and,
wherein said WebRTC application enforces the DRM permission of the saved communication session using the DRM enforcement module in the WebRTC application, and said DRM enforcement module configured to send an enforcement command when a DRM permission violation is detected to revoke an encryption key that encrypts an electronic signal between the WebRTC application and the WebRTC browser, wherein the electronic signal is between a CODEC in the WebRTC browser and a playback component or module for a speaker or display of the second NFT transaction party user communication device,
a Private Blockchain module in the WebRTC application in communication with the Web3 Platform to provide user identity, authentication, a digital hash, Group Node Coupling, Self-Sovereign (SSI) ID security, and IPFS decentralized storage with content linking, content searching, and content addressing,
a hardware security module in the WebRTC application in communication with the Web3 Platform to provide AES 256 GCU encryption, and ECDH Diffie-Hellman encryption for audio and video streams,
a key management module in the WebRTC application in communication with the WebRTC-Gateway Server and the Signaling Server to provide homomorphic encryption of a communication between the WebRTC-gateway Server and the Signaling Server, said homomorphic encryption allowing the Signaling Server to extract the private IP address without decrypting the JSON message,
an insertable streams module in the WebRTC application to provide end-to-end encryption for a middlebox device and for Selective Forwarding Units (SFUs) for media routing in a videoconference application where insertable streams iterate on frames and not RTP packets to transform an encoded frame to an asynchronous insertable stream to support end-to-end encryption, and
wherein the first NFT transaction party communication device is selected from a mobile communication device, a desktop computer communication device, and a tablet communication device.

In another preferred embodiment, the invention provides a system for a private NFT cross chain communications inter-working with Web3 UI, I PFS file sharing system, and IPFS P2P storage gateway, comprising:
a Web3 Platform having a UI application in JavaScript; the Web3 Platform is connected to a platform having a side chain Oracle gateway with off chain component receiving inputs from a first main chain having Ethereum on-chain and a second main chain having a different Blockchain such as Solana, Tezos, Flow and Binance on-chain; an SSI ID digital wallet inputs into both first main chain and second main chain; a separate SSI-protected digital wallet inputs into second main chain; the Oracle gateway module is in communication with an IPFS file processing and management system module; the IPFS file processing and management system module is configured to provide registration and authentication functions, file, creation, and storage functions, file access and retrieval functions, and file, validation and editing functions; the SSI digital wallets are in communication with the IPFS file processing and management system to authenticate the communications; an IPFS P2P storage gateway module uses web transport UDP-QUIC protocols to communicate with the IPFS file processing and management system; the IPFS P2P storage gateway module includes smart contract and/or Ricardian contracts, content addressing, content linking, directed acyclic graphs, (DAG), and Content discovery via DHT; the SSI digital wallet includes authenticated communication with the IPFS P2P storage gateway module; a private NFT module, having a smart contract and/or Ricardian contract, a wallet, and DRM functions uses web transport UDP-QUIC communications protocol to communicate with the IPFS P2P storage gateway; the buyer private NFT module, and the seller private NFT module are in duplex communication across a media channel, a separate data channel, and use the WebRTC-UDP/QUIC protocols.

In another preferred embodiment, the invention provides a system for managing an NFT Based Patent Framework and Copyright Validation and Verification System Integrated with the USPTO and WIPO, comprising:
An application layer module includes connections to external databases, such as the USPTO, WIPO, and university research, to provide a patent information and retrieval system; a Blockchain layer module includes an NFT Minting component connected to a Blockchain having Ricardian contracts and connected to on-chain storage; an authentication layer (DIDs) module and verification layer module is connected to a zero trust security enclave; the zero trust security enclave includes a self-sovereign identity (SSI) digital wallet; the zero trust security enclave also includes a DRM component, a zero knowledge proofs component, a digital watermark component, and a multi-party computation (MPC) component; an NFT indexing scaling module includes compoents for scaling, sidechains, rollup, and indexing tokens and DeFi distributed finance.

In another preferred embodiment, the invention provides a system for managing an NFT Marketplace, comprising:
an NFT marketplace module in communication with an IPFS Gateway Copyright Registry module, an IPFS Decentralized Storage module, a WebRTC-QUIC/UDP Communications module, and an NFT Copyright Insurance module; the NFT marketplace includes a patent seller having an NFT marketplace application on a seller smart device and a patent buyer having the NFT marketplace application on a buyer smart device, the NFT marketplace application is configured to input the patent seller ownership information, verification and creation of an NFT, and the NFT marketplace application is configured to input the patent buyer copyright certification requirement, and to issue a token; an IPFS gateway registry has a copyright and ownership registry, an NFT, contract, hash, and an owner hidden signature; an IPFS decentralized storage module has an IPFS p2p storage component, Ricardian contract component, DHT hash component, Merkel DAG component, content addressing component, content linking component, and content discovery component; a WebRTC-QUIC/UDP communications module has a seller SSI wallet with a browser extension and a buyer SSI wallet with a browser extension that are in peer to peer secure communication for transferring voice, data, and video communications; an NFT copyright insurance module includes a data breach component, a cyber hack component, and a crime damage component.

In another preferred embodiment, the invention provides a system for managing NFT Ricardian Contracts for Copyright Ownership in a Validation and Verification Network, comprising:
a mint NFT module in communication with the Blockchain module, having Ricardian contracts, contract hash, and hidden signature; the Blockchain module is in communication with on chain storage; the Blockchain module is connected to a zero trust security module, having digital rights management (DRM), digital watermarking, zero knowledge proof (ZKP), and multi-party computation (MPC); a seller SSI wallet and a buyer SSI wallet are in communication with the zero trust security module; an NFT scaling module receives input from the zero trust security module; an off chain indexing module receives input from the zero trust security module; an NFT marketplace module includes a seller component, buyer component, ownership component, verification component, copyright component, certification component, a create NFT module, and an issue token module; an IPFS gateway registry module receives input from the NFT marketplace module; the IPFS gateway registry module includes a copyright component, a registry component, a contract component, a hash, and hidden signature; an IPFS decentralized storage module is connected to the IPFS gateway registry module; the IPFS decentralized storage module includes a Ricardian contract and receives input as a DHT hash and Merkel DAG.

### Scope of Terminology

The terminology used herein is for the purpose of describing embodiments only and is not intended to limit the full scope of the claims. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

As used herein, the singular forms “a”, “an” and “the” are intended to include the plural forms as well, unless the context clearly indicates otherwise. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” etc.). Similarly, the terms “comprises” and/or “comprising,” when used in this specification, specify the presence of stated features, integers (or fractions thereof), steps, operations, elements, and/or components, but do not preclude the presence or addition of one or more other features, integers (or fractions thereof), steps, operations, elements, components, and/or groups thereof. As used in this document, the term “comprising” means “including, but not limited to.”

As used herein the term “and/or” includes any and all combinations of one or more of the associated listed items. It should be understood that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All ranges disclosed herein also encompass any and all possible subranges and combinations of subranges thereof unless expressly stated otherwise. Any listed range should be recognized as sufficiently describing and enabling the same range being broken down into at least equal subparts unless expressly stated otherwise. As will be understood by one skilled in the art, a range includes each individual member.

The embodiments herein, and/or the various features or advantageous details thereof, are explained more fully with reference to the non-limiting embodiments that are illustrated in the accompanying drawings and detailed in the following description. Descriptions of well-known components and processing techniques are omitted so as to not unnecessarily obscure the embodiments herein. Like numbers refer to like elements throughout.

The examples and/or embodiments described herein are intended merely to facilitate an understanding of structures, functions, and/or aspects of the embodiments, ways in which the embodiments may be practiced, and/or to further enable those skilled in the art to practice the embodiments herein. Similarly, methods and/or ways of using the embodiments described herein are provided by way of example only and not limitation. Specific uses described herein are not provided to the exclusion of other uses unless the context expressly states otherwise.

### Definitions

Description of WebRTC-QUIC

The term “WebRTC” as used herein refers to a free, open-source platform which facilitates browser-based P2P communications (voice and video) on Android, IOS and PC platforms. WebRTC is supported by most browser technologies including Chrome, Firefox, Safari, Opera and MSEdge. WebRTC supports video, voice, and data content including Word docs, PDF, Pics, etc. to be sent between (and among) peers allowing developers to build voice and video-communications solutions and services. The technologies behind WebRTC are implemented as an open web standard and available as regular JavaScript APIs in all major browsers. For native clients, like Android and IOS applications, a library is available that provides the same functionality.

JavaScript API's

WebRTC consists of three main JavaScript objects: the RTC Peer Connection Object, the Mainstream API, and the RTC Data Channel API.

The term “RTC Peer Connection Object” as used herein refers to an object that is the main entry point to the WebRTC API. It helps connect to peers, initialize connections, and attach media streams, as shown in the attached diagram. The RTC Peer Connection API is the core of the peer-to-peer connection between each of the communicating browsers.

The term “Mainstream API” as used herein refers to an object designed to provide easy access to media streams (video and audio) from cameras, microphones and audio and video codecs on mobile devices and PC's.

The term “RTC Data Channel API” as used herein refers to an object designed to transfer arbitrary data including data messages in addition to audio and video streams

WebRTC Protocols

The main currently released protocol for WebRTC is WebRTC-QUIC with earlier versions of WebRTC using DTLS-TLS, SRTP, and SIP.

The term QUIC is the name of a transport layer network protocol. Initially, proposed as Quick UDP Internet Connections, QUIC is not an acronym, but simply the name of the protocol that improves performance of connection-oriented web applications by establishing several multiplexed connections between two endpoints using User Datagram Protocol (UDP). In preferred embodiments, the present invention uses QUIC as the primary transport protocol for transporting large amounts of data in the data channel (Word docs, PDF, Pics), especially to facilitate Web3 duplex communications and transfer. The media channel provides p2p video chats and videoconferencing and the audio channel provides VoIP based phone calls.

The term “Datagram Transport Layer Security (DTLS) as used herein refers to an alternative WebRTC protocol that adds encryption and message authentication but had been replaced with the QUIC protocol which provides near zero video latency. DTLS is a communications protocol that provides security for datagram-based applications, specifically voice and video by allowing them to communicate based on a stream-oriented transport layer security (TLS) protocol and is intended to provide similar security guarantees. DTLS uses User Datagram Protocol (UDP) streaming protocol to establish low latency and loss toleration communications between applications on the Internet, such as WebRTC based P2P connection.

The term “Secure Real-Time Transport Protocol (SRTP)” as used herein refers to another alternative WebRTC-QUIC protocol that is a profile for Real-Time Transport Protocol (RTP) intended to provide encryption, message authentication, and replay attack protection to the RTP data in both unicast and multicast video applications.

The term “Session Initiation Protocol (SIP)” as used herein refers to another WebRTC protocol that is a signaling protocol used for initiating, maintaining, and terminating real-time voice, video, and messaging sessions. SIP is widely used for signaling and controlling multimedia communications sessions over Internet telephone for voice and video calls, in private IP telephone systems and in instant messaging over IP.

The term “Session Description Protocol (SDP)” refers to a format for describing multimedia communications sessions for the purpose of session announcement and session invitation to support streaming media applications such as voice (VoIP) and video conferencing.

The term “WebRTC Network servers” refers to remote servers that facilitate the WebRTC connection.

The term “Signaling Server” refers to a WebRTC Signaling server used to establish a Web Transport Connection between p2p users using public and private IP address translation.

The term “Interactive Connectivity Establishment (ICE)” refers to a WebRTC server used to discover which IP addresses can connect to each other and the method used to make that connection through a typical Network Address Translation (NAT) servers called STUN servers and TURN servers.

The term “STUN server” refers to a WebRTC server used as primary connection set up server.

The term “TURN server” refers to a WebRTC server that is a secondary connection set-up server when the STUN server is unreachable.

The term “Selective Forward Units (SFU's)” refers to a type of video routing device used for receiving multiple media streams and then forwarding these media streams to multiple users in a video conferencing session.

The term “module” refers to a separate unit of hardware or software or both that has a specific task or function within a larger hardware, software, or electronic system. The term “component” may be synonymous within context. The term module may also include programmable electronics that include both hardware and software or firmware programming.

The term “software module” refers to a separate unit of software programming code that has a specific task or function within a larger software system. A software module may handle one step in a process or may handle a series of related steps required for completing a task or function.

The term “hardware module” refers to a separate unit of hardware that has a specific task or function within a larger electronic system and is usually programmed or programmable by software or firmware or by a user establishing specific settings to achieve a specific task or function.

The term “Platform” or alternatively “Web3 Platform” refers to a set of Web3, non-cloud technologies in replacement of traditional Web2 cloud servers that include: (i) a WebRTC-QUIC P2P communication system that provides 256-AES encrypted streaming/chats, DRM-controlled messaging, and an SSI-digital wallet, (ii) an IPFS platform that provides decentralized P2P storage having a content addressing module, a DHT HASH module, a Merkle DAG module, and an Immutable Persistence module, (iii) a Content Rendering module for creation of links to stored content, and (iv) a Smart contract and/or Ricardian contract in an NFT Content module.

The term “browser farm” refers to a cloud-based browser farm is where a plurality of virtual machines, each has a browser loaded thereon and includes browser infrastructure. Since preferred embodiments of the invention use Web3, and which does not use a traditional “cloud server”, a browser farm embodiment is only provided as an alternative embodiment.

### WebRTC Security Issues

There are several ways that a browser based P2P communications application such as WebRTC may impose certain security risks, especially the interception of unencrypted data or media streams during transmission or when decrypted at middlebox server points in a P2P configuration including Signaling Server, ICE servers (Stun server and Turn servers) and with Selective Forwarding Units (SFU's). The main security issue is with a man-in-the-middle (MITM) cyber-attack and theft of private IP addresses and unencrypted data and streamed video sessions while traversing middlebox network servers. This can occur between browser-to-browser or browser-to-server communications with eavesdropping third parties able to see all sent data including IP addresses, voice conversations, and video streams. TLS is the de facto standard for Web2 based encryption using HTTPS/2. But as discussed earlier, WebRTC uses DTLS with less than reliable Datagram transport such as UDP and with the implementation of DTLS to generate encryption keys for SRTP media sessions, where normal protections from TLS encryption are not available. WebRTC-QUIC has recently supplanted WebRTC-TCP/TLS due to video streaming latency performance and the enhancement of the WebRTC Data channel to accommodate large files including Word docs, PDF, JPEGs etc.

### Signaling Server

WebRTC uses a signaling server network to establish a Web Transport (formerly WebSocket's) connection between peer-to-peer users. A form of discovery and media format negotiation must take place for the two devices (i.e., 2 Android or IOS devices) on different networks to locate one another. This process is called signaling and involves both devices connecting to the mutually agreed-upon signaling server. A signaling servers function is to serve as an intermediary to allow the two peers to find and establish a connection while minimizing exposure of potentially private information. However, to complete a secure connection between 2 peers, the signaling server decrypts the senders private IP address and exchanges it with a public IP address to route the audio or video call to the receiver. As a result, both the sender and receivers private IP address is exposed (unencrypted) and is subject to a man-in-the-middle (MITM) attack whereby the private IP information and other PII information of both users is now compromised.

### Peer Connections Using ICE—Protocol—Stun & Turn Servers

ICE (Interactive Connectivity Establishment) is used to discover which IP addresses can connect to each other and the method used to make that connection through a typical NAT (Network Address Translation) which is a method of remapping an IP address space into another by modifying network address information in the IP header of packets while they are in transit across a traffic routing device. ICE uses both Stun and Turn servers to resolve the public IP address of a device running behind a NAT and to solve problems such as one-way audio during a phone call or streamed video between 2 or more peers. Stun messages are usually sent in User Datagram Protocol (UDP) packets. Since UDP does not provide reliable transport guarantees, reliability is achieved by application-controlled retransmissions of the Stun request. Since WebRTC uses DTLS versus TLS, the connection with a Stun server may or may not be always encrypted. Once a session between peer A and peer B, for P2P communications, Session Initiation Protocol (SIP) and Session Description Protocol (SDP) are used. Since the Stun isn't always encrypted, it is easy for a MITM attack to be executed thus obtain the users private IP addresses and the personal identifiable info. The sessions between both peers will be end-to-end encrypted regardless of your secured/unsecured connection with Stun. This P2P ICE/STUN/TURN—Audio and streamed audio connection process is widely used and accepted as a major security risk with WebRTC browser based P2P communications.

### Selective Forwarding Unit (SFU)

WebRTC has settled on the SFU as the preferred method of extending WebRTC to multiparty conferencing including simulcast and multicast. SFU's enable the deployment of P2P streamed video in efficient and scalable hub and spoke technologies with low latency and high-quality videos. In the SFU architecture, every participant (peer) sends their media stream to a centralized server (SFU) and receives streams for all other participants via the SFU. The SFU does not need to decode and re-encode received streams, but simply acts as a forwarder of streams between call participants. The main advantage of the SFU architecture is the ability to work with asymmetric bandwidth or (higher downlink bandwidth than uplink bandwidth), which makes it suitable for mobile communications. The problem with SFU is that they do not support E2E media encryption, as the media server terminates the encryption once it receives the media stream and has direct access to it. This represents a serious blocker for the usage of off-the-shelf SFU's for WebRTC applications.

### Man-In-the-Middle (MITM) Middlebox Security Concerns

WebRTC is encrypted by design, using DTLS to exchange encryption keys (and encrypt data channel messages) and SRTP to exchange real-time audio and video streams. As such, each peer connection established between two peers is secure (the P2P one-to-one scenario). The moment you add a server to the mix, including a signaling server, ICE servers (Stun and Turn servers) and a Selective Forwarding Unit (SFU), media is not peer-to-peer anymore; you are sending media to a server, and the server sends the media on to other peers. So, it is the peers in the media conversation that change—that is if a server is handling the media, WebRTC requires that peer connections connect directly to the server, not the other peer. This means that, in the simple 1-1 peer to peer video/audio call case, two separate and independent peer connections are established: Connection between the caller and server; and Connection between the sender/caller and receiver/callee.

As such, both connections are secure, but only up to or from the server since the server terminates the DTLS connectivity and as a result the server has access to the unencrypted media and any other PII information, including private IP addresses.

### Distributed Trust Platform

For video streaming, video conferencing and audio communication over a browser based (WebRTC) P2P network, it is imperative to augment certain deficiencies with Datagram Transport Layer Security (DTLS) and Real-Time Transport Protocol (Secure RTP) to provide strong end-to-end security guarantees. This section defines and explains a Distributed Trust Platform that consists of: AES 256 Galois/Counter Mode (GCM) encryption, Elliptic-Curve Diffie-Hellman (ECDH) encryption, Homomorphic encryption, Insertable Media Streams, Key Management System for Encryption, Hardware Security Module (HSM), Blockchain-Distributed Hash (DHT), and Digital Signatures/Authentication.

### AES 256 GCM

AES with Galois/Counter Mode (AES-GCM)—(is a mode of operation for symmetric key cryptography block ciphers) provides both authenticated encryption and the ability to check the integrity and authentication of additional authenticated data (AAD) that is sent in the clear. These are four inputs for authenticated encryption: the private key, initialization vector (called nonce), the plaintext and optional additional authentication data (AAD). The nonce and AAD are passed in the clear. These are two outputs; the ciphertext, which is the same length as the plaintext, and an authentication tag (the “tag”). The tag is sometimes called the Message Authentication Code (MAC) or integrity check value (ICV).

### ECDH

Elliptic-curve Diffie-Hellman (ECDH) is a key agreement protocol that allows two parties, each having an elliptic-curve public-private key pair, to establish a shared private over an insecure channel. This shared private may be directly used as a key, or to derive another key. The key or the derived key, can then be used to encrypt subsequent communications using a symmetric-key cipher. It is a variant of the standard Diffie-Hellman protocol using elliptic-curve cryptography (ECC). ECC is a public-key cryptography based on the algebraic structure of elliptical curves over finite fields. Elliptical curves can be used for encryption by combining the key agreement (key exchange system) with a symmetric encryption scheme.

### Homomorphic Encryption

Homomorphic encryption solves a vulnerability inherent in all other approaches to doctor protection. Homomorphic encryption (HE) is a form of encryption allowing one to perform calculations on encrypted data without decrypting it first. The result of the computation is in an encrypted form, when decrypted the output is the same as if the operations had been performed on the unencrypted data. In a nutshell, homomorphic encryption is a method of encryption that allows any data to remain encrypted while it is being processed and manipulated. It enables a third party (such as a video streaming service) to apply functions on encrypted data without needing to reveal the values of the data. A homomorphic cryptosystem is like other forms of public encryption in that it uses a public key to encrypt data and allows only the individual with the matching private key to access its unencrypted data (though there are also examples of symmetric key homomorphic encryption as well). However, what sets it apart from other forms of encryption is that it uses an algebraic system to allow you or others to perform a variety of computations (or operations) on the encrypted data.

Homomorphic encryption is a form of encryption with an additional evaluation capability for computing over encrypted data without access to the private key to decrypt the encrypted data. The result of such a computation remains encrypted.

Applying HE to WebRTC signaling requires both the caller and callee to upload their private IP address to the signaling server so that a media session (video streaming) can be routed and traversed over the public IP network using a public IP address. In this way both the caller and callee's private IP addresses are never decrypted or exposed to MITM attack.

There are two main types of homomorphic encryption. The primary difference between them boils down to the types and frequency of mathematical operations that can be performed on their ciphertext. Types of homomorphic encryption include Partially Homomorphic Encryption and Fully Homomorphic Encryption.

Partially homomorphic encryption (PHE) helps sensitive data remain confidential by only allowing select mathematical functions to be performed on encrypted values. This means that one operation can be performed an unlimited number of times on the ciphertext. Partial homomorphic encryption (about multiplicative operations) is the foundation for RSA encryption, which is commonly used in establishing secure connections through SSL/TLS.” A partial HE implementation can also support limited operations such as addition and multiplication up to a certain complexity because most complex functions typically require significant computing capability and computation time.

### Insertable Media Streams

In a preferred embodiment of the invention, media transport is handled using QUIC for all Blockchain based private NFT tranactions. In alternative embodiments, WebRTC encryption may be provided using DTLS-SRTP. This technology works by using a DTLS handshake to derive keys for encrypting the media payload of the RTP packets. It is authenticated by comparing fingerprints in the SDP (session description Protocol) that are exchanged via the signaling server with the fingerprints of the self-signed certificates used in the handshake. This is often called E2E encryption since the negotiated keys do not leave the local device (signaling server) and the browser does not have access to them. However, without authentication it is still vulnerable to MITM attacks focusing on private IP address theft.

Another unsecure media server is the SFU's. SFU's are packet routers that forward a single or small set of media streams from one user to many users (typically up to 50 users). In terms of encryption, DTLS-SRTP negotiation happens between each peer endpoint and the SFU. This means that the SFU has access to the unencrypted payload and can listen in. This is necessary for features like recording. On the security side, it means you need to trust the entity running the SFU and/or the client code (a video app) to keep the stream private. Zero trust is always the best policy.

Unlike a VoIP Multipoint Control Unit (MCU) which decodes and mixes media, SFU only routes packets. It ignores the media content (except header information and whether a frame is a keyframe). So, a SFU is not required to decode and decrypt the media stream data.

So, what is required and provided here is to implement a “frame encryption” approach built on a JavaScript API to solve this problem—which is referred to here as Insertable Media Streams. This approach works as follows:

### Opens Two Connections

Applies the encryption on both connections based on a simple XOR cipher, an additive cipher (an encryption algorithm) that operates as follows:

A⊕O=A

A⊕A=A

(A⊕B)⊕C=A⊕(B⊕C)

(B⊕A)⊕A=B⊕O=B

where ⊕ denotes the exclusive disjunction (XOR) operation and is applied to the content which contains the encryption key.

Only decryption on one of them.

The transform function is then called for every video frame. This includes an encoded frame object and a controller object. The controller object provides a way to pass the modified frame to the next step. The frame header is not required to be encrypted.

The insertable media stream API operates between the encoder/decoder and the packetizer that splits the frames into RTP packets. In summary, this is a sophisticated APO for inserting frame encryption which in the case of insertable streams needs to be asynchronous.

### Key Management System (KMS)

Encryption key management is administering the full lifecycle of cryptographic keys. This includes generating, using, storing, archiving, and deleting of keys. Protection of the encryption keys includes limiting access to the keys physically, logically, and through user/role access.

There is an entire physical and digital cryptosystem that must be accounted for as well as each key's full lifecycle. Therefore, a robust encryption key management system and policies includes Key lifecycle: key generation, pre-activation, activation, expiration, post-activation, escrow, and destruction. Physical access to the key server(s), Logical access to the key server(s), and User/Role access to the encryption keys are important.

### Asymmetric Keys: Data-In-Motion.

Asymmetric keys are a pair of keys for the encryption and decryption of the data. Both keys are related to each other and created at the same time. They are referred to as a public and a private key:

Public Key: this key is primarily used to encrypt data and can be freely given as it will be used to encrypt data, not decrypt it.

Private Key: this key is used to decrypt the data that it's counterpart, the public key, has encrypted. This key must be safeguarded as it is the only key that can decrypt the encrypted data.

Asymmetric keys are primarily used to secure data-in-motion. An example might be a streamed video where an AES symmetric session key is used to encrypt the data and a public key is used to encrypt the session key. Once the encrypted data is received, the private key is used to decrypt the session key so that it can be used to decrypt the data.

### Asymmetric Key System Flow Process

The Sender and Recipient verify each other's certificates. The sender sends a certificate to the recipient for verification. The recipient then checks the certificate against their Certificate Authority (CA) or an external Validation Authority (VA) for authentication. Once the sender's certificate has been verified, the recipient then sends their certificate to the sender for authentication and acceptance. Once the sender and recipient have mutual acceptance. The sender requests the recipient's public key. The recipient sends their public key to the sender. The sender creates an ephemeral symmetric key and encrypts the file to be sent. (an ephemeral symmetric key is a symmetric encryption key used only for one session.) The sender encrypts the symmetric key with the public key. The sender then sends the encrypted data with the encrypted symmetric key. The recipient receives the packet and decrypts the symmetric key with the private key. The recipient decrypts the data with the symmetric key.

Hardware security module (HSM) is a physical computing device that safeguards and manages digital keys, performs encryption and decryption functions for digital signatures, strong authentication, and other cryptographic functions. These modules traditionally come in the form of a plug-in card or an external device that attaches directly to a computer or network server. A hardware security module contains one or more secure crypto processor chips.

Digital signature is a mathematical scheme for verifying the authenticity of digital messages or documents. A valid digital signature, where the prerequisites are satisfied, gives a recipient very strong reason to believe that the message was created by a known sender (authentication), and that the message was not altered in transit (integrity).

Elliptical Curve Digital Signature Algorithm (ECDSA) offers a variant of the Digital Signature Algorithm (DSA) which uses elliptic curve cryptography.

Cryptographic splitting, also known as cryptographic bit splitting or cryptographic data splitting, is a technique for securing data over a computer network. The technique involves encrypting data, splitting the encrypted data into smaller data units, distributing those smaller units to different storage locations, and then further encrypting the data at its new location.

### Encrypted Media Extensions (EME)

EME is a W3C specification for providing a communication channel between web browsers and a Content Decryption Module (CDM) software which implements Digital Rights Management (DRM). This allows the use of HTML5 video to play back DRM-wrapped content such as streaming video without the use of 3rd party media plugins to the browser including Adobe Flash or MS Silverlight. The use of a third-party encryption key management system is recommended.

EME is based on the HTML5 Media Source Extensions (MSE) specification which enables adaptive but rate streaming in HTML5 using MPEG-DASH protected content. (Dash-Dynamic Adaptive Streaming over HTTP). The transport protocol that MPEG-DASH uses is TCP.

As of 2016, EME has been implemented in Google Chrome, IE, Safari, Firefox and MS Edge browsers.

### Content Decryption Module

The invention includes a stack implementation of using the APO for the Content Decryption Module. The CDM is the client component that provides decryption for one or more encryption key systems including the key management systems proposed in the SRTCS Distributed Trust Platform which supports AES 256 GCM encryption, Elliptic Curve Diffie-Hellman (ECDH) encryption and Homomorphic encryption.

### Encrypted Media Extension (EME)

The invention provides an EME for providing a communication channel between web browsers and a Content Decryption Module (CDM).

### Private Blockchain

The invention provides a Private Blockchain with Distributed Hash Tables, Group Node coupling, Distributed (encrypted) Identity and Digital Rights (DRM).

As used herein, the Private Blockchain is an invitation-only network governed and controlled by a single (or group) entity. Entrants to the blockchain network require permission to join, read, write, and participate in the blockchain. There are different levels of access, and the information is encrypted to protect the commercial services confidentiality. The SRTCS system described in the invention has implemented a permission-based blockchain (Private Blockchain) that deploys an access control layer to govern who has access to the network and users (subscribers) on the Private Blockchain network are vetted and controlled by the network rules.

The SRTCS blockchain contains a growing list of records (transactions) referred to as blocks that are linked using cryptography (encryption). Each block contains a cryptographic hash of the previous blocks (a timestamp) and transaction data (metadata), represented as a Merkle tree.

### Distributed Ledger Technology (DLT)

The SRTC invention deploys Distributed Ledger Technology (DLT) for recording “transactions” or video and audio chats in which the transactions and their details are recorded in multiple places (multiple nodes) at the same time. Distributed ledgers have no central data store or administrative functionality which is contrasted with widely used cloud databases such as SQL server. Ledgers are essentially a permanent record of transactions and data. Blockchain, which bundles transactions into blocks that are chained together (“connected”). DLT also has the potential to speed transactions since they remove the need for central authority. Blockchain technology makes use of cryptography for transactions, security and privacy-preserving protocols. Blockchain cryptography includes public-key cryptography, distributed hashing and Merkle trees.

### SRTCS Private Blockchain Architecture

This invention also describes a new method and implementation of a Private Blockchain which includes: Blockchain Group Node Coupling, Distributed Hash Tables, Distributed Identity and Directories (searching), Public Key Cryptography, Cryptographic Hashing, and Merkle Trees. Each of the above-mentioned technologies are discussed below in greater detail.

Blockchain with Distributed Identity Directory, Distributed Hash Tables with Group Node Coupling)

The invention provides Group Node Coupling, Distributed Identities (DII) and Directories. SRTCS deploys blockchain to provide a record of each user PII (personal identifiable information) including a private IP address and to provide directory searching capability to find and connect 2 or more users to a video/audio/telemetry communication session. This process also includes node addressing, node discovery and group node coupling.

A profile of each subscriber is created in the blockchain that contains all PII and historical metadata of video/audio chats made with other subscribers (called “Buds”) in SRTCS. A node coupling profile of “Buds” is created which streamlines the blockchain discovery (searching) algorithms to quickly identify and retrieve addressing linking information to achieve rapid connection between subscribers in the system.

WebRTC signaling server is used to connect 2 or more subscribers over the P2P network. As discussed earlier, the signaling server translates each user's private IP address to a public IP address to effectuate a connection over the ICE (Stun, Turn) server network. An encrypted Websocket Connection is made between the users WebRTC based browser and the signaling server in an encrypted (hop-to-hop ???) scenario. SRTCS uniquely deploys homomorphic encryption to extract the private IP addresses of each subscriber without decrypting the private IP address payload in the signaling server. This protects the users from any potential MITM private IP address impersonation and theft and provides a true end-to-end encryption implementation without the need to decrypt the users private IP address at the signaling server.

Private Blockchain with Distributed Hash Tables & Group Node Coupling)

The invention provides Public-Key Cryptography. An important feature of the SRTCS system is the implementation of public key cryptography with Blockchain. Public-key cryptography (also called asymmetric cryptography) is a cryptographic system that uses a pair of keys—a public key and a private key. The public key may be widely distributed, but the private key is meant to be known only by its owner. Keys are always created in pairs—every public key must have a corresponding private key.

Public-key cryptography is most often used for encrypting messages between two people or two computers in a secure way. Anyone can use someone's public key to encrypt a message, but once encrypted, the only way to decrypt that message is by using the corresponding private key.

### FIGURES

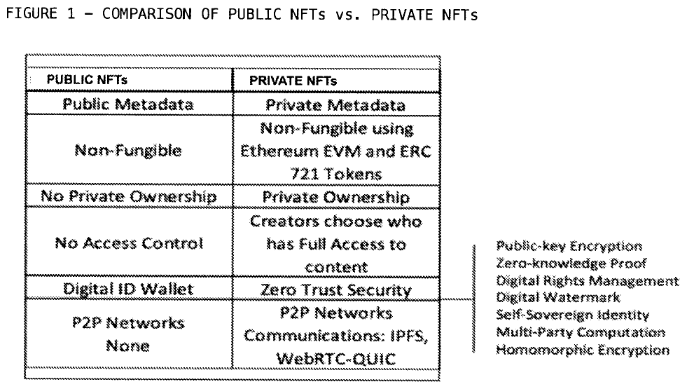

Referring now to FIG. 1, the private NFT architecture is seamlessly integrated with the following Web3 p2p decentralized networks. IPFS P2P Decentralized Data Storage—a peer-to-peer protocol for decentralized media content storage system for storing and accessing files, Websites, and data. And WebRTC-QUIC—a real-time multimedia communications platform that enables Web3 applications to capture and stream audio and/or video media, and to exchange data between browsers without requiring an intermediary and without requiring the user to install plug-ins or any other third-party software to provide secure video chats and content messaging between private NFT buyers and sellers.

FIG. 1 illustrates that the private NFT invention includes a public-key encryption module, a self-sovereign identity management module, a zero knowledge proofs (ZKP) module, a multi-party computation (MPC) module, a digital rights management (DRM) module, a digital water-marking module, and a homomorphic encryption module.

### Zero Trust Security Enclave Framework

A Zero Trust Security Enclave is a strategic approach to cybersecurity that consists of a set of security system resources and technologies that operate in the same security domain and that share the protection of a single, common, and continuous security perimeter. Rooted in the principle of “never trust, always verify,” Zero Trust Security Enclave is designed to protect communications environments such as NFTs and p2p Web3 networks and enable digital transformation by using strong authentication methods, leveraging network segmentation, preventing lateral movement, providing application layer threat prevention, and simplifying granular, “least access” policies.

Zero Trust Security Enclave addresses the problem stemming from traditional security models that operate on the outdated assumption that everything inside a network should be implicitly trusted. This implicit trust means that once on the network, users—including threat actors and malicious insiders—are free to move laterally and access or exfiltrate sensitive data due to a lack of granular security controls.

With digital transformation accelerating in the form of Web3 peer-to-peer decentralized networks based on Blockchain and the HTTP/3-UDP-QUIC protocol stack, taking a Zero Trust approach provides a solution that results in higher overall levels of security, reduced security complexity and operational overhead.

Zero Trust Security Enclave Interworking with Private NFTs

The Private NFT architecture framework supports private NFT auctions between buyers and sellers who require complete anonymity and confidentiality with private, confidential, and secure NFT transactions. The Private NFT system integrates advanced security-based technologies based on a Zero Trust Security Enclave to restrict user access to the private NFT auctions only to authorized buyers and sellers.

The Zero Trust NFT Security Enclave seamlessly integrates the following security technologies: Public-key encryption, Self-sovereign identity management, Zero knowledge proofs (ZKP), Multi-party computation (MPC), Digital rights management (DRM), Homomorphic encryption, and which are all designed to obfuscate user identities, protect Blockchain transactions, protect smart contract and/or Ricardian contracts, provide off-chain storage and to secure all peer-to-peer communications between buyers and sellers.

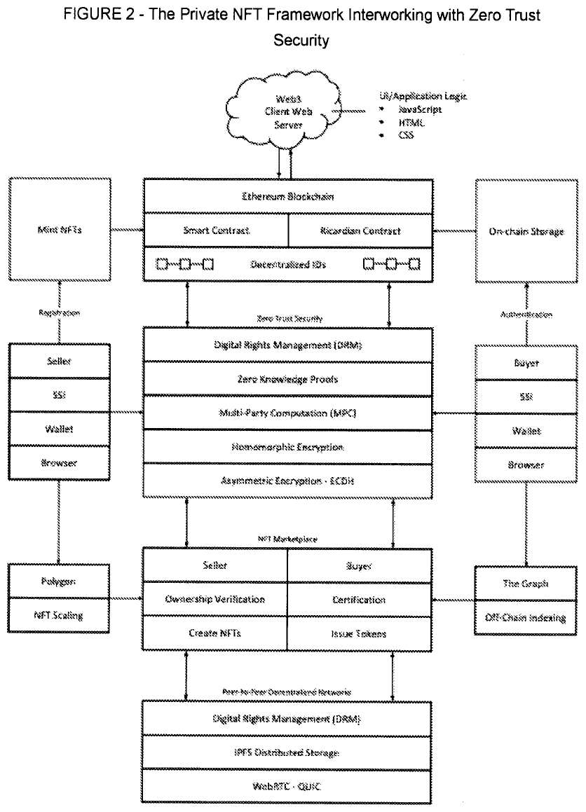

### FIG. 2

Referring now to FIG. 2, the Private NFT architecture and Zero Trust Security Enclave comprises a Web3 client web server with user interface (UI), and application logic for providing JavaScript, HTML, and CSS. The Web3 client web server communicates with an Ethereum blockchain module having smart contract and/or Ricardian contract and Ricardian contract functionality and having decentralized IDs. The ethereal blockchain is in communication with a zero trust security platform having a digital rights management (DRM) module, a zero knowledge proofs (ZKP) module, a multi-party computation (MPC) module, a homomorphic encryption module, and an asymmetric encryption—ECDH module. The zero trust security platform is in communication with an NFT marketplace for sellers and buyers having ownership verification, creation of NFTs, certification and issuance of tokens. The NFT marketplace is in communication with a peer-to-peer decentralized network(s), the P2P network having a digital rights management (DRM) module, an interplanetary file system (IPFS) distributed storage module, and a web real-time communication (WebRTC)-QUIC module. QUIC is the name of a transport layer network protocol, Initially, posed as Quick UDP Internet Connections, QUIC is not an acronym, but simply the name of the protocol that improves performance of connection-oriented web applications by establishing a number of multiplexed connections between two endpoints using User Datagram Protocol (UDP).

The zero-trust security platform communicates with a seller side module including an SSI-protected wallet with browser, and a buyer side module including an SSI protected wallet and browser. The seller-side module provides registration to a Mint NFT module, that is in communication with the previously described ethereal blockchain. The buyer-side module provides authentication to an on-chain storage module that is in communication with the previously described ethereal blockchain.

The seller-side module is in communication with Polygon and NFT scaling, and the buyer-side module is in communication with The Graph and off-chain indexing.

### Web3 Private NFT Decentralized Networks

While Blockchain and NFTs have been implemented for numerous applications that represent tradable rights of digital assets (pictures, music, films, and virtual creations) where ownership is recorded in blockchain with smart contract and/or Ricardian contracts, there is a growing need to provide an NET framework for generating, recording, tracing securing NFTs in a Blockchain network integrated with decentralized off-chain storage and with peer-to-peer multimedia communications between buyers and sellers during scheduled NFT auctions.

The private NFT architecture is seamlessly integrated with the following Web3 p2p decentralized networks: IPFS P2P Decentralized Data Storage—The InterPlanetary File System (IPFS) is a peer-to-peer protocol for decentralized media content storage system for storing and accessing files, Websites, and data. Instead of being location based, IPFS addresses a file by what's in it, or by its content. WebRTC-QUIC—real-time multimedia communications platform is a technology that enables Web applications and sites to capture and stream audio and/or video media, as well as to exchange data between browsers without requiring an intermediary. The set of standards that comprise WebRTC makes it possible to share data and perform peer-to-peer videoconferencing, without requiring that the user install plug-ins or any other third-party software that provides secure video chats and DRM protected content messaging between private NFT buyers and sellers.

The Blockchain Private NET framework is designed to support most popular NFT marketplaces including for artwork, intellectual property (IP), sports, gaming, virtual real estate, music, events and ticketing, fashion, and wearables and for emerging metaverse VR/AR applications.

The Private NET framework has also been designed to seamlessly integrate with most NFT Blockchains including Ethereum, Cardano, Solana, Binance, Algorand and Tezos. Additionally, the private NFT framework provides a scalable Cross-Chain communication capability among different Blockchains using a scalable multi-chain design that seamlessly integrates with P2P networks and protocols including Libp2p, IPFS decentralized storage and UDP-QUIC messaging protocols that facilitate off-chain smart contract and/or Ricardian contract and data sharing among different Blockchains.

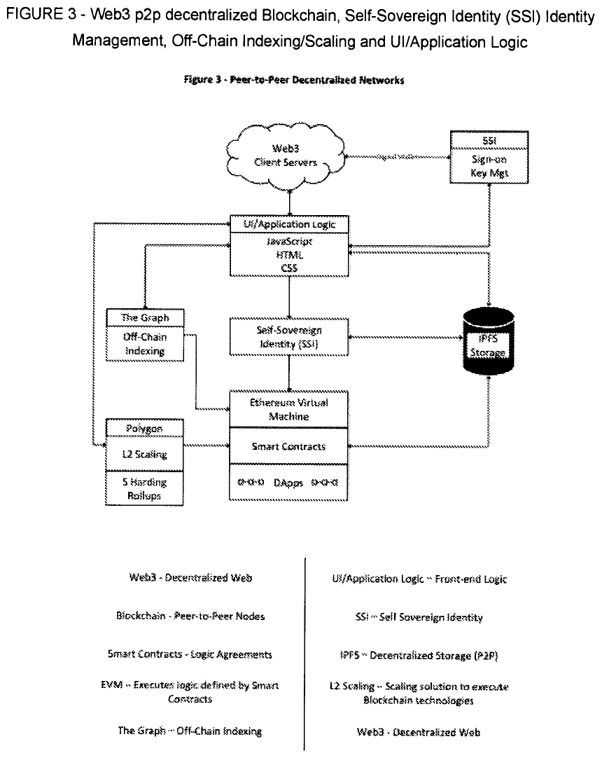

### FIG. 3

Referring now to FIG. 3, FIG. 3 is a diagram illustrating the Web3 p2p decentralized blockchain, self-sovereign identity (SSI) management, off-chain indexing/scaling and Web3 UI/application logic. FIG. 3 shows the Web3 (decentralized web) client servers in communication with a digital wallet protected by SSI for sign-on key management. The Web3 client server(s) are also in communication with IPFS storage, using UI/application logic, through an SSI module connected to an Ethereum Virtual Machine. The EVM is associated with Smarts Contracts and the DApps. The UI/application logic also connects the Graph and Off-chain Indexing module to the EVM. The Polygon/L2 scaling/S Harding Rollups module is in communication with the Smart contract and/or Ricardian contracts/Smart contract and/or Ricardian contracts module.

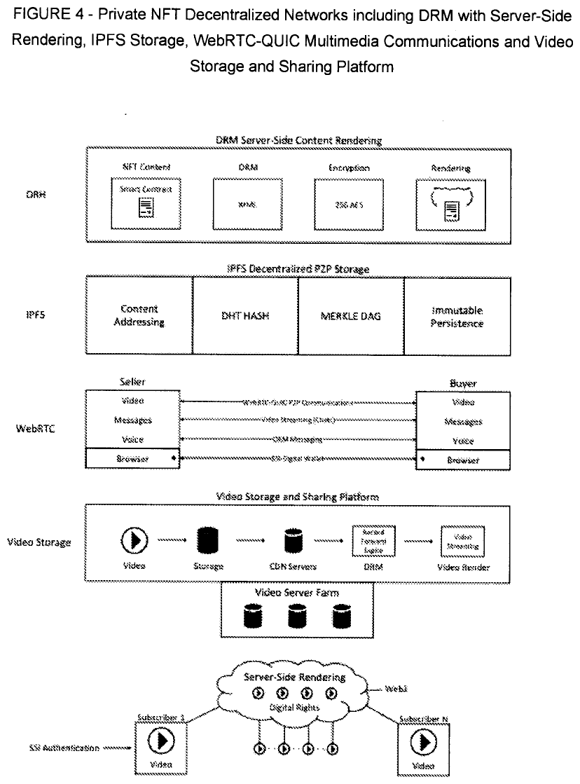

### FIG. 4

Referring now to FIG. 4, FIG. 4 is a diagram illustrating the Private NFT p2p Decentralized Networks including DRM with File Rendering, IPFS Storage, WebRTC-QUIC Multimedia Communications and Video Storage and Sharing Platform. In operation, Subscriber 1 (lower left), uses SSI to upload a video file/stream to a Web3 File Rendering Platform for access by Subscriber N. The video is stored in a Video Storage platform having CDN storage, a DRM module, and a video rendering module, in communication with a video server farm. A WebRTC platform manages the seller-buyer relationship using WebRTC-QUIC P2P communications, providing video streaming/chats, DRM messaging, and includes an SSI-digital wallet. An IPFS platform provides decentralized P2P storage having a content addressing module, a DHT HASH module, a Merkle DAG module, and an Immutable Persistence module. A DRH platform provides DRM File Content Rendering using a Smart contract and/or Ricardian contract in an NFT Content module, a DRM module using XrML, an encryption module for 256-AES, and a rendering module for creation of links to stored content.

### Scalable Cross-Chain Communications Interoperability

Blockchain works on a decentralized ecosystem that depends on a distributed ledger system. However, one downside that the current blockchain system suffers from is that it is not a cumulative platform. Different blockchain networks operate in isolation which does not allow them to communicate with each other. However, with the rise in emerging platforms, cross-chain technology is one such innovation that can address these issues and bring the required solutions.

Cross-chain communications refer to the transferring of information between one or more blockchains. Cross chain communications are motivated by two requirements common in distributed systems: accessing data, accessing smart contract and/or Ricardian contracts, and accessing functionality which is available in other Blockchain or decentralized storage systems such as IPFS. Cross-chain communication provides a single-messaging interface for all cross-chain communication. It enables easy integration into any smart contract and/or Ricardian contract application with only a few lines of code, ensuring developers don't waste effort in writing custom code to integrate separately with each chain.

Cross-Chain communication protocols are open-sourced standards for developers to easily build secure cross-chain services and applications. With a universal messaging interface, smart contract and/or Ricardian contracts can communicate across multiple blockchain networks, eliminating the need for developers to write custom code for building chain-specific integrations. It opens a new category of DeFi applications that can be built by developers for multi-chain ecosystem.

Since no defined approach can be equally applied for all networks, it differs from network to network. Every network uses a different system on blockchain interoperability to enable transactions without applying third-party integrations.

Here are some of the most common and widely known approaches to isolated transactions across various Blockchains:
(a) Atomic Swaps—These are exchange facilitators that enable two different parties to trade their tokens on multiple blockchains. This type of mechanism does not involve the requirement for a centralized third party to facilitate the trades. Instead, it allows the user to directly trade their tokens on a peer-to-peer basis.
(b) Relays—Relays enable blockchain networks to keep a check on the transactions and events taking place on other chains. They work on a chain-to-chain basis without the involvement of distributed nodes facilitating a single contract to act as a central client of other nodes on multiple chains.

The Private NFT framework provided herein provides a proprietary multichain ecosystem to provide cross-chain communications for retrieving and sharing Blockchain based smart contract and/or Ricardian contracts and transactional data among different Blockchain platforms that are stored off-chain in the IPFS p2p decentralized data storage system. The Cross-Chain protocol and communications system includes the following special features: (i) Off-Chain Consensus, (ii) Cross-Platform protocols and libraries, (iii) IPFS p2p decentralized off-chain smart contract and/or Ricardian contract and data storage, (iv) WebRTC-UDP/QUIC transport protocols, and (v) Zero Trust Security Enclave with Anti-Fraud Cryptography.

### II. Private NFT Framework

The invention includes a blockchain-based private NFT framework to facilitate both public and private or private NFT auctions to address the market for NFT buyers and sellers who require security, anonymity, and confidentiality for NFT applications including art, gaming, intellectual property (IP), sports, gaming real estate and music.

The Blockchain private NET framework includes five main technology stack layers: Storage, Authentication, Verification, Ethereum Blockchain (EVM), and Web3 Applications. Details of each stack layer and the general concepts are presented below.

### IPFS Peer-to-Peer Decentralized Storage

The continuous rise of data in blockchain technology has created a market for the development and use of decentralized storage networks. This stack layer implicitly provides the infrastructure required for data storage. NFT platforms have unique characteristics that must be included for content identification and retrieval. NFT metadata provides information that describes a particular token ID. NFT metadata is either on the Blockchain called on-chain storage or in a separate decentralized location called off-chain P2P storage. On-chain means direct incorporation of the metadata into the NFT's smart contract and/or Ricardian contract, which represents the tokens. Off-chain storage means hosting the metadata separately. Blockchains provide on-chain storage, but it is expensive and is never allow data to be removed. For example, because of the Ethereum blockchain's current storage limits and high maintenance costs, metadata is almost always maintained off-chain

The off-chain technology stack solution selected in the design and implementation of private NFTs is the IPFS decentralized storage platform. The InterPlanetary File System (IPFS) is a peer-to-peer protocol for decentralized media content storage. IPFS is a distributed system for storing and accessing files, Websites, and data. Instead of being location based, IPFS addresses a file by what's in it, or by its content. The content identifier is a cryptographic hash of the content at that address. The hash is unique to the content that it came from. Because the address of a file in IPFS is created from the content itself, links in IPFS can't be changed. Content is accessible through peers located anywhere.

In summary, there are three fundamental principles of IPFS: (1) unique identification via content addressing, (2) content linking via directed acyclic graphs (DAGs), and (3) content discovery via distributed hash tables (DHTs).

Authentication using Self-Sovereign Identity (SSI) and Decentralized Identity

The Decentralized Identity (DID) approach assists users in collecting credentials from a variety of issuers and saving them in a digital wallet. The verifier then uses these credentials to verify a person's validity by using a blockchain-based ledger to follow the “identity and access management (IAM)” process. Therefore, Blockchain DIDs allow users to be in control of their identity. A lack of NFT verifiability causes intellectual property and copyright infringements. The private NFT architecture uses Self-Sovereign Identity (SSI) as the solution for Authentication. SSI is a inventive decentralized identity management platform for the Web3 Internet. SSI applications use public-key cryptography with public blockchains to generate persistent identities for people with private and selective information disclosure.

### Zero Trust Verification

In permissioned blockchains, identified nodes can read and write in the distributed ledger. Nodes can act in different roles and have various permissions. In the private NFT architecture, verification includes four levels as below:

Digitalization—For a seller to publish as an NFT in the blockchain, it must have a digitalized format. This level is the “falling step” in traditional NFT registering.

Recording—NFTs provide valuable information and would bring financial benefits for their owner. The owner and seller should record his NFT privately first using proof of existence. The inventor generates the hash of the NFT and records it in the blockchain. As soon as it is recorded in the blockchain, the timestamp and the hash are available for others publicly. Then, the owner can prove the existence of the NFT whenever it is needed. The inventor can make sure that their NFT is recorded confidentiality and immutably.

Validating—In this phase, the inventors first create NFTs and publish it to the miners/validators. Validation will be done by Blockchain miners. Miners are some identified nodes that validate NFTs to record in the blockchain.

Digital Certificate—Digital certificates are digital credentials used to verify networked entities' online identities. They include a public key as well as the owner's identification. They are issued by Certification Authorities (CAs), who must verify the certificate holder's identity. Certificates contain cryptographic keys for signing, encryption, and decryption. As discussed earlier, the private NFT architecture deploys the SSI platform for authentication and verification of NFT owners.

Certificate Authority—A Certificate Authority (CA) issues digital certificates. CAs encrypt the certificate with their private key, which is not public, and others can decrypt the certificate containing the CA's public key. The validator can use the certificate to assure others about their eligibility. Other nodes can check the requesting node's information by decrypting the certificate using the public key of the CA. Therefore, people can join the network's miners/validators using their credentials.

### Blockchain—Ethereum Virtual Machine

Blockchain acts as middleware between the Verification and Application steps in the NFTs architecture. Blockchain systems can be mainly classified into two major types: permissionless (public) and permissioned (private) Blockchains based on their consensus mechanism.

In a public blockchain, any node can participate in the peer-to-peer network, where the blockchain is fully decentralized. A node can leave the network without any consent from the other nodes in the network. Bitcoin is one of the most popular examples that fall under the public and permissionless blockchain. Proof of Work (POW), Proof-of-Stake (POS), and directed acyclic graph (DAG) are some examples of consensus algorithms in permissionless blockchains. Bitcoin and Ethereum, two famous and trustable blockchain networks, use the PoW consensus mechanism.

Private Blockchain platforms typically adopt the PoS consensus. Nodes require specific access or permission to get network authentication in a private blockchain. Hyperledger is among the most popular private blockchains, which allow only permissioned members to join the network after authentication. This provides security to a group of entities that do not completely trust one another but wants to achieve a common objective such as exchanging information. All entities of a permissioned blockchain network can use Byzantine-fault-tolerant (BFT) consensus. The fabric has a membership identity service that manages user IDs and verifies network participants. Therefore, members are aware of each other's identity while maintaining privacy and secrecy because they are unaware of each other's activities.

Blockchain is a decentralized network with no central node to observe and check all transactions. There is a need to design protocols that indicate all transactions are valid. The consensus algorithms are considered as the core of each blockchain. In decentralized systems, consensus has become a problem in which all network members (nodes) agree on accept or reject of a block. When all network members accept the new block, it can append to the previous block. The main concern in the blockchains is how to reach consensus among network members. Blockchain consensus algorithms are mainly classified into three groups: Voting-based consensus, chain-based consensus, and DAG-based consensus. Proof-based consensus algorithms require the nodes joining the verifying network to demonstrate their qualification to do the appending task. Voting-based consensus requires validators in the network to share their results of validating a new block or transaction before making the final decision. DAG-based consensus allows several different blocks to be published and recorded simultaneously on the network. The private NFT platform is a solution that removes barriers by addressing fundamental issues within the traditional NFT ecosystem as it exists today.

### III. NFT Security Issues

The NFT market has witnessed several high-profile and high value asset sales and a tremendous growth in trading volumes over the last year. Unfortunately, these marketplaces have not yet received much security scrutiny. Instead, most analysis has focused on attacks against decentralized finance (DeFi) protocols, Blockchain and smart contract and/or Ricardian contract vulnerabilities.

Security issues associated with software and systems that are integral to NFT systems and products in the market today which are vulnerable to security breaches. These security breaches include: User Authentication, Identity Management and Digital Wallets, Blockchain, Decentralized Applications (DApps) and Smart contract and/or Ricardian contracts, NFT Minting, NFT Bidding and Trading System, On-Chain Storage, NFT Scaling and Off-Chain Indexing, and Off-Chain Storage

NFT security issues also includes an analysis of external security entities including: ERC-721 Compliance and Vulnerabilities, Counterfeit NFT Product Creation, Fraudulent NFT Trading Practices, External Documents and Smart contract and/or Ricardian contracts, Content Messaging and Multimedia Communications between NFT buyers and sellers.

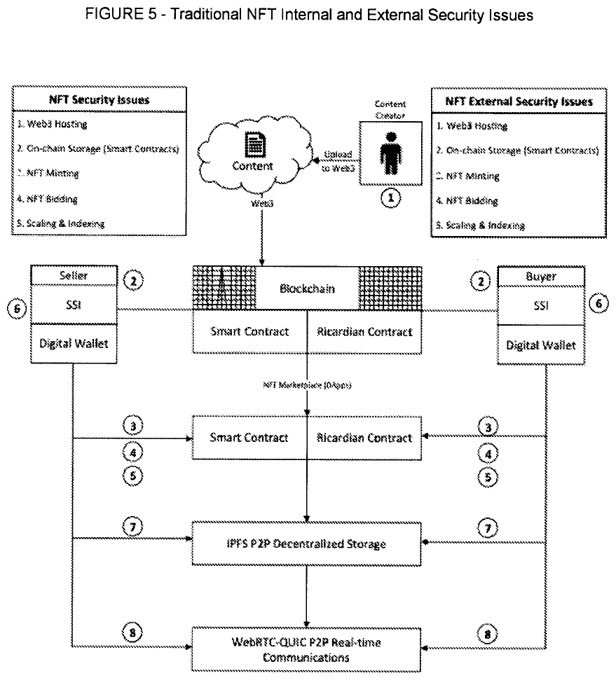

### FIG. 5

Referring now to FIG. 5, FIG. 5 is a diagram illustrating a summary of traditional NFT internal and external security issues. FIG. 5 shows a content creator uploading to Web3 to a Content Platform, which is in communication with a Blockchain having Smart contract and/or Ricardian contract and Ricardian Contract. A Seller and a Buyer, each having a digital wallet connected by SSI, access the NFT Marketplace using DApps. IPFS P2P decentralized storage provides storage, and a WebRTC-QUIC P2P module provides real-time communications.

### User Authentication and Identity Verification

Art in the physical world has been used in money laundering schemes. NFTs may make this process easier, as trades are executed by anonymous users, and there are no physical artworks to be transported. Identity verification is the first step to deter such security breaches. Major crypto exchanges, such as Coinbase and Binance US, are highly regulated. To create an account with these exchanges, one needs to provide personally identifiable information (PII), e.g., name, residential address, social security number (SSN), along with supporting documents confirming these details. Without getting the identity verified, it is either impossible to use the platform, or it can only be used with tight financial restrictions in place. Universally, no NFTs on the market today have made any steps towards enforcing KYC (Know Your Customer) rules nor implemented AML/CFT (Anti-Money Laundering/-Combating the Financing of Terrorism) measures. As a result, apart from being able to hide the identity, a user can create several accounts on the platform that are hard to trace back to one single entity.

### Token Minting—Verifiability of Token Contracts

A token contract is considered “verifiable” if its source code is submitted to Etherscan. Given the functional complexity of these token contracts, source code is much easier to audit than bytecode. The verifiability of external token contracts is crucial as they can be malicious or buggy. As an example, many users complained about a malicious token contract that did not transfer tokens after purchase. Also, to make a particular NFT valuable, sometimes NFT projects promise to circulate only a certain number (rarity) of that token. A malicious token contract can be abused to mint more tokens than the rarity threshold, thus dropping the token's price, which hurts the buyers. A malfunctioning contract can burn gas without even doing any real work. Ideally, an NFT project should make the source of the underlying token contract available for public scrutiny before the NFTs are minted to make sure that they are neither malicious nor buggy. Unfortunately, none of the NFTMs that support external token contracts mandates such contracts to be open source.

Tampering with Token Metadata

The metadata of a token holds the pointer to the corresponding asset. Hence, if the metadata changes, the token loses its significance. The ERC-721 standard for NFTs allows for the possibility to change a token's metadata. However, when an NFT represents a particular asset (such as a piece of art) that is sold, changing the metadata violates the expectation of the buyer. The location and the content of the metadata are decided at the time of minting. A malicious creator/owner A can alter the metadata by manipulating either of the two post-minting: (i) by changing the metadata URL, and (ii) by modifying the metadata itself. Even if (i) can be disallowed at the contract level, metadata hosted on third-party (web) domains can be freely modified by A if the user controls the domain. This second attack can be prevented if the metadata is hosted in IPFS. Since the URL of an object stored in IPFS includes the hash of its content, the metadata cannot be modified while retaining the same URL recorded in the NFT. For internal token contracts, CryptoPunks, Foundation, Rarible, and Nifty offer no way to update the metadata URL of an NFT. Axie allows the creator to modify the URL at any time. OpenSea, SuperRare, and Sorare allow modification by the creator until the first sale. Since only Foundation mandates storing the metadata on IPFS, other NFTs are susceptible to the second attack for the internal contracts. Since no NFTM supporting external token contracts employs any check to prevent metadata tampering, both attacks are feasible.

### Token Listing

While listing an NFT, the NFT takes control of the token so that when a sale is executed, it can transfer the ownership of the NFT from the seller to the buyer. To this end, the NFT needs to be either (i) the owner of the NFT: that is, the current owner transfers the asset to an escrow account during listing, or (ii) a controller: an Ethereum account that can manage that specific NFT on behalf of the owner, or (iii) an operator: an Ethereum account that can manage all the NFTs in that collection. The escrow model in case (i) is risky because one single escrow contract/wallet managed by the NFT holds all assets being traded on the platform. Therefore, the security of all assets in a marketplace depends on the security of the escrow contract or the external account that manages such contract. This design essentially violates the principle of least privilege. As a result, either a vulnerability in the contract or a leak of the private key of the external account could compromise the security of all the stored NFTs. Nifty, Foundation, SuperRare follow this approach.

A safer alternative would be to adopt (ii) or (iii), where a proxy contract deployed by the NFT becomes the controller of the NFT, or the operator of the entire NFT collection, respectively. As enforced by the marketplace contract, the NFTM can transfer an NFT only when it has been put on sale and the required amount is first paid to the seller. This ensures the safety of the NFT token even in case of a marketplace hack. If the private key of a seller (owner of an NFT) gets leaked, it can, at most, compromise the safety of that specific NFT or collection, as opposed to all the NFTs as in the case of the escrow model.

### Invalid Caching

While displaying an NFT on sale, OpenSea and Rarible leverage a local caching layer to avoid repeated requests to fetch the associated images. If the image is updated, or disappears, the cache goes out of sync. This could trick a buyer into purchasing an NFT for which the asset is either non-existent or different from what the NFTM displays using its stale cache.

### Seller and Collection Verification

Listings by verified sellers/collections are not only given preferential treatment by the NFTs, but they also attract greater attention from the buyer community. However, the verification mechanism is typically ad-hoc, and the final decision is at the discretion of the NFTs. Common requirements include sharing the social media handles of the sellers and proving their ownership, sharing contact information, collections needing to reach certain trading volume, submitting the draft files of the digital artworks, etc. Marketplaces such as Foundation adopt a stricter policy by mandating verification of all the sellers on their platform. However, there are NFTs, e.g., OpenSea, Rarible, where verification is optional. Buyers are expected to exercise self-judgment when trading on these platforms, which, unfortunately, puts them at greater risk. Since verification comes with financial benefits, it has been abused in different ways:
(i) Forging verification badge. Scammers forged profile pictures with an image of the verification badge overlaid on them, making the profiles appear visually indistinguishable from the verified ones at a cursory glance;
(ii) Impersonation. Abusing weak verification procedures, scammers got their fake profiles verified by just submitting social media handles, without proving the ownership of the corresponding accounts; and
(iii) Wash trading. One of the requirements of OpenSea to verify a collection is to have at least 100 ETH in trading volume, which is possibly hard to attain for a newly launched collection. Historically, this requirement has incentivized people to perform wash trading, i.e., performing fictitious trades between multiple accounts that are all under the control of the attacker, to artificially inflate sales volumes.

### Token Trading

### Lack of Transparency

NFTs are asset-ownership records that should be stored on the blockchain to allow for public verifiability. In a decentralized setting, an NFT sale is handled by a marketplace contract that invokes the transfer API of the token contract to transfer the token from the seller to the buyer. Every sale transaction and the associated transfer, for example, in case of OpenSea, is visible on the blockchain. Among other things, each transaction includes the following information: (i) address of the seller (current owner), (ii) address of the buyer (new owner), (iii) how much the NFT was sold for, (iv) time of ownership transfer. Querying for ownership has further been made easier by ERC-721 API that returns the current owner of a token. The sales records, in conjunction with the API, permit one to reconstruct the precise sales and ownership history of an NFT. On the other hand, if sales records and transactions are stored off chain, it becomes impossible to verify any trades and the ownership history of an NFT. Moreover, a malicious NFTM can abuse this fact to forge spurious sales records to inflate the trading activity and volume. Off-chain records are susceptible to tampering, censorship, and prone to disappear if the NFTM database goes down.

### Fairness in Bidding

NFTMs implement bidding either (i) on chain, through a smart contract and/or Ricardian contract that requires the bid amounts to be deposited while placing the bid, or (ii) off-chain, through the NFT dApp which maintains an orderbook without requiring any upfront payment. Off-chain bidding is unfair as it can be abused by both the NFT and the users. Since bids are not visible from the blockchain, NFTs can inflate the bid volume to create hype. Also, placing bids is inexpensive, as there is no money transfer involved. Therefore, such NFTs are more susceptible to bid pollution, a form of abuse where many casual bids are placed on items. Since no money is locked, most of these bids are likely to fail due to a shortage of funds in the bidder's account at the time of execution. Since on-chain bidding costs gas to place/cancel bids, it deters scammers from placing spurious bids, making abuses less frequent. Moreover, on-chain bids reserve the bid amount upfront. Therefore, such bids invariably succeed during settlement.

### Royalty Distribution and Marketplace Fee Evasion

Where a royalty is set, every trade should earn a fee for the creator. However, there are ways in which users can potentially abuse the royalty implementations:
(i) Cross-platform. Royalty is enforced by either the marketplace contract or the dApp, both of which are specific to an NFT. Also, NFTs do not share royalty information with each other. Therefore, royalty set on one platform is not visible from the other. Leveraging this lack of coordination, a malicious seller can evade royalty by trading the NFT through a platform where royalty is not set, though it is set on another.
(ii) Non-enforcement. Neither royalty nor marketplace fees are enforced in ERC-721 token contracts. A malicious seller can thus avoid both payments by transferring (using ERC-721 transfer) the NFT to the buyer directly and settling the payment off-platform. Both royalty and fees could be levied inside the transfer method of the token contract, though the additional logic makes the API more expensive.
(iii) Post-sales modification. OpenSea and Rarible allow the creator to modify the royalty amount even after the primary sale. Now, the royalty is calculated on the price listed by the seller. In a potential abuse scenario, a creator can first lure a buyer by setting a low royalty and then increasing it post-sales. During secondary sales, the buyer may not notice this change at all, and may end up giving more royalty to the creator than initially advertised.

### Security Issues Related to External Entities

The asset (picture, video) that an NFT points to must be accessible for this NFT to be “meaningful.” NFTs can point to assets in two ways. If the NFT contract is ERC-721-compliant and implements the metadata extension, then the token includes a metadata URL on-chain, which points to a metadata record (JSON). This record, in turn, includes an image URL field that points to the actual digital asset. Many older tokens, on the other hand, are not standard-compliant and do not contain any on-chain image URL. Instead, they use some ad-hoc, off chain scheme to link to an asset. For such NFTs, NFTs implement custom support so that they can generate valid image URLs. Since both the metadata record and the asset are stored off-chain, those do not enjoy the same guarantee of immutability as the NFT itself. When any URL becomes inaccessible, that breaks the link between the NFT and the corresponding asset. In practice, the URLs frequently point to a distributed storage service, e.g., IPFS decentralized storage, or centralized storage, e.g., a web-domain or Amazon S3 bucket. For IPFS URLs, if the NFT owner is aware, they can keep the NFT “alive” by pinning the resource (i.e., storing it persistently). Even that could also be problematic, because NFTs do not store the hash value of the actual resource but rather store URLs that point to an IPFS gateway web service. If the gateway becomes unavailable, the NFT “breaks.” In general, NFTs that include URLs that point to domains outside the control of the NFT owners risk getting invalidated when the corresponding domains go away.

### Counterfeit NFT Creation

The authenticity of an NFT is endorsed by the smart contract and/or Ricardian contract managing the collection. Therefore, to ensure that the token one is buying is legitimate, buyers are advised to verify the contract address of the collection from official sources, e.g., the project's web page, before making a purchase. Unfortunately, buyers are not always aware of the existence of counterfeits, or of how they can verify an NFT's authenticity. Instead, they only rely on the names and visual appearances of items in the marketplaces. This makes it possible for malicious users to offer “fake” NFTs. Here are the following types of counterfeits:
(i) Similar Collection Names. There are fake NFTs that use the name of a collection or individual piece that resembles the original victim) one. A common trick is to substitute ASCII characters in the original name with non-ASCII characters that look alike. To prevent such abuse, OpenSea restricts users from using popular collection names and certain special characters. Still, it is often possible to circumvent these limitations, e.g., by adding a dot(.) at the end of the name or substituting an upper-case character with a lower-case one. Moreover, restrictions can cause problems for legitimate users, e.g., French users complained about not being able to use the accented characters in collections;
(ii) Identical Image URLs. Some fake NFTs point to existing assets, i.e., they simply copy the image urls of legitimate NFTs. For example, CryptoPunks is a well-known collection. Of course, nothing prevents a scammer from deploying her own token contract on the blockchain and mint tokens that point to CryptoPunks. A buyer who just looks at the appearance of items in a collection will see the CryptoPunks images and might mistake the NFTs for the originals;
(iii) Similar Images. Instead of copying the image url, a scammer might copy the digital asset and then mint an NFT that points to this copy. As of now, no NFTM runs any similarity check to detect if a media file has already been used by other NFTs.

### Trading Malpractices

Illicit trading practices, specifically, wash trading, shill bidding, and bid shielding are summarized as follows.

### Wash Trading

In wash trading, the buyer and the seller collude to artificially inflate the trading volume of an asset by engaging in spurious trading activities. In NFTs, users wash trade to either create the illusion of demand for a specific asset, artist, etc., or to inflate metrics that are of their financial interest, such as getting a profile/asset verified, or collecting rewards. For example, Rarible users are incentivized by $RARI governance tokens where the more a user spends, the more tokens they receive. It is suspected that many high-value NFT sales related to popular projects such as Decentraland are instances of wash trading.

### Shill Bidding

Shill bidding is a common auction fraud where a seller artificially inflates the final price of an asset either by placing bids on her own asset or colluding with other bidders for placing spurious bids with increasingly higher bid amounts. This can lead to honest bidders paying higher prices than they would have otherwise. With high-value bids on assets becoming increasingly common, it is suspected that many sales suffer from artificial price inflation.

### IV. Zero Trust NFT Security Enclave

The Zero Trust Security framework was developed by the CIA and published by NIST in 2019. The following 5 steps summarize the main features of the Zero Trust architecture, and which was designed by NIST to address security issues associated with corporate and Internet of Things (IOT) networks.

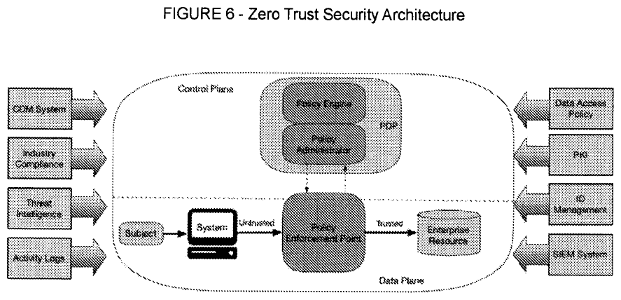

### FIG. 6

Referring now to FIG. 6, FIG. 6 is a diagram illustrating the Zero Trust Security Framework. A Control Plane contains a PDP module having a policy engine and a policy administrator. A Data Plane shows flow from a subject through a system with untrusted access to a Policy Enforcement Point, having trusted access to an Enterprise Resource. A series of modules feed into the Control Plane and the Data Plane, including a CDM System module, an Industry Compliance module, a Threat Intelligence module, and Activity Log module, a Data Access Policy module, a PKI module, an ID management module, and an SIEM System module.

### Step 1: Segment the Network

Traditional cybersecurity has a single boundary of trust: The edge of the enterprise network. Zero trust is more secure where users must constantly request access to areas they need to be, and if there isn't an absolute need for them to be there then security keeps them out.

Network segmentation is a key feature of ZTA. There are lots of security boundaries throughout a segmented network, and only the people who absolutely need access can get it. This is a fundamental part of zero-trust networking and eliminates the possibility that an attacker who gains access to one secure area can automatically gain access to others.

### Step 2: Implement Access Management and Identity Verification

Multi-factor authentication (MFA) is a fundamental part of good security, whether it's zero trust or not. Under zero trust security system, users should be required to use at least one two-factor authentication method, and possibly different methods for different types of access.

Along with MFA, roles for employees need to be tightly controlled, and different roles should have clearly defined responsibilities that keep them restricted to certain segments of a network. The ZTA recommends using the principle of least privilege (POLP) when determining who needs access to what.

### Step 3: Extend the Principle of Least Privilege to the Firewall

Zero trust isn't concerned only with users and the assets they use to connect to a network. It's also concerned with the network traffic they generate. Best practices require that privilege should be applied to network traffic both from without and within a network.

Establish firewall rules that restrict network traffic between segments to only those absolutely needed to accomplish tasks. It's better to have to unblock a port later than to leave it open from the get-go and leave an open path for an attacker.

Step 4: Firewalls should be Contextually Aware of Traffic

Rules-based firewall setups are not enough. What if a legitimate app is hijacked for nefarious purposes, or a DNS spoof sends a user to a malicious webpage?

To prevent problems like those it's essential to design firewalls to look at all inbound and outbound traffic to ensure it looks legitimate for an app's purpose as well as checking it against blacklists, DNS rules, and other data described in Figure -- above.

### Step 5: Gather, and Analyze, Security Log Events

Zero trust, just like any other cybersecurity framework, requires constant analysis to find its weaknesses and determine where to reinforce its capabilities. There's a lot of data generated by cybersecurity systems and parsing it for valuable information can be difficult. Zero Trust recommends using SEIM software to do a lot of the analytics legwork, saving time on the tedious parts so IT leaders can do more planning for future attacks. Security Information and Event Management (SIEM) is a software solution that aggregates and analyzes activity from many different resources across your entire IT infrastructure. SIEM collects security data from network devices, servers, domain controllers etc.

Zero Trust Security Enclave Interworking with Blockchain Based Private NFTs

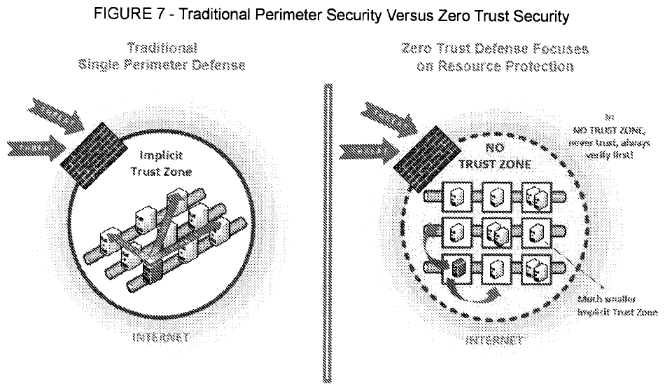

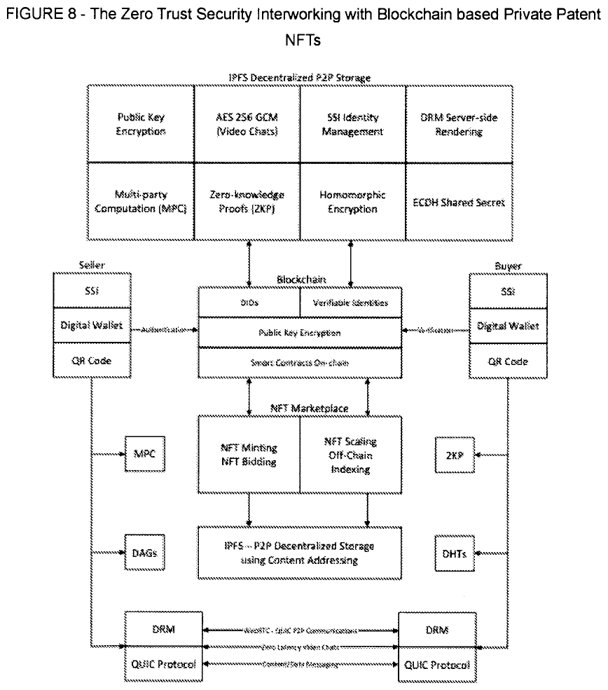

The Company has designed a unique and novel implementation of a Zero Trust Security Enclave applied to Blockchain based Private NFTs, as summarized in FIGS. 7 and 8.

### FIG. 7

Referring now to FIG. 7, FIG. 7 is a diagram illustrating the Traditional Perimeter Security Versus Zero Trust Security Enclave. FIG. 7 shows how threats are blocked by traditional firewall but allow access inside the implicit trust zone. However using a zero trust defense platform, where threats may be blocked using firewalls, there is a no trust zone where devices are not permitted to trust but access must always be verified. In some zero trust platforms, there may be a hybrid approach where a combination of zero trust and implicit trust policies are used.

### FIG. 8

Referring now to FIG. 8, FIG. 8 is a diagram illustrating the The Zero Trust Security Enclave Interworking with Blockchain based Private NFTs. FIG. 8 shows IPFS Decentralized P2P Storage in communication with a Seller and a Buyer accessing an NFT Marketplace through a Blockchain and having DRM protected WebRTC-QUIC P2P communications. The IPFS includes programming code executable on a processor to provide Public Key Encryption, AES 256 GCM, SSI identity management, DRM file rendering, Multi-party Computation (MPC), Zero-Knowledge Proofs (ZKP), Homomorphic Encryption, and ECDH Shared Private.

A description of the Zero Trust Security Enclave interworking with Blockchain, Private NFTs and Web3 p2p networks including IPFS decentralized storage, WebRTC-QUIC real time multimedia communications and scalable cross chain interoperability is described below.

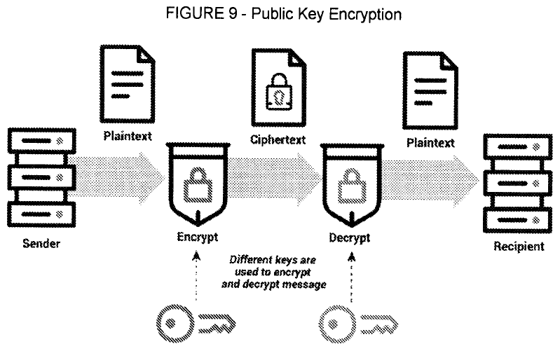

### FIG. 9

Referring now to FIG. 9, FIG. 9 is a diagram illustrating Public Key Encryption.

### Public—Key Encryption

Public—key cryptography is a cryptographic system that uses pairs of keys. Each pair consists of a public key (which may be known to others) and a private key (which may not be known by anyone except the owner). The generation of such key pairs depends on cryptographic algorithms which are based on mathematical problems termed one-way functions. Effective security requires keeping the private key private; the public key can be openly distributed without compromising security.

With public-key cryptography, robust authentication is also possible. A sender can combine a message with a private key to create a short digital signature on the message. Anyone with the sender's corresponding public key can combine that message with a claimed digital signature; if the signature matches the message, the origin of the message is verified (i.e., it must have been made by the owner of the corresponding private key).

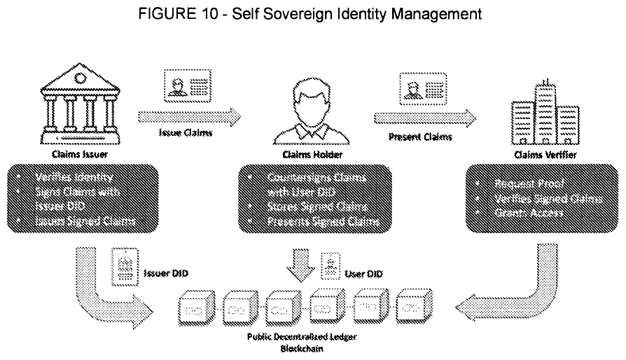

### FIG. 10

Referring now to FIG. 10, FIG. 10 is a diagram illustrating Self Sovereign Identity Management.

### Self-Sovereign Identity Management (SSI)

Self-sovereign identity (SSI) is an approach to digital identity that gives individuals control of their digital identities. SSI addresses the difficulty of establishing trust in an interaction. To be trusted, one party in an interaction will present credentials to the other parties, and those relying parties can verify that the credentials came from an issuer that they trust. In this way, the verifier's trust in the issuer is transferred to the credential holder. This basic structure of SSI with three participants is sometimes called “the trust triangle”.

Decentralized identifier documents or DIDs are a type of identifier that enables a verifiable, decentralized digital identity. They are based on the Self-sovereign identity paradigm. A DID identifies any subject (e.g., a person, organization, thing, data model, abstract entity, etc.) that the controller of the DID decides that it identifies. These identifiers are designed to enable the controller of a DID to prove control over it and to be implemented independently of any centralized registry, identity provider, or certificate authority. DIDs are URIs that associate a DID subject with a DID document allowing trustable interactions associated with that subject. Each DID document can express cryptographic material, verification methods, or service endpoints, which provide a set of mechanisms enabling a DID controller to prove control of the DID. Service endpoints enable trusted interactions associated with the DID subject. A DID document might contain semantics about the subject that it identifies. A DID document might contain the DID subject itself (e.g., a data model).

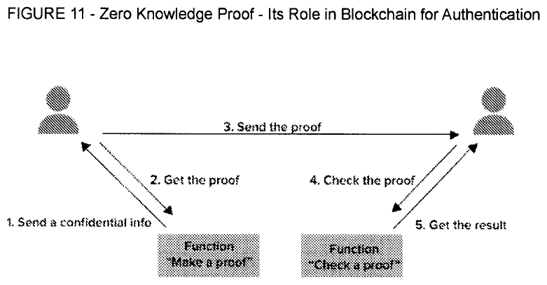

### FIG. 11

Referring now to FIG. 11, FIG. 11 is a diagram illustrating the Zero Knowledge Proof—Its Role in Blockchain for Authentication.

### Zero Knowledge Proof (ZKP)

In cryptography, a zero-knowledge proof or zero-knowledge protocol is a method by which one party can prove to another party that a given statement is true while the prover avoids conveying any additional information apart from the fact that the statement is indeed true.

Zero Knowledge Proof is typically deployed as Layer-2 Ethereum scaling solutions zero-knowledge proof (ZKP) identity management service. The solution will enable users to verify their credentials and identity without ever revealing any personal information. The ZKP identity platform has been designed to complement the decentralized finance and decentralized application (DApp) economies by providing users greater privacy and sovereignty within Web3. ZKP implements authentication without passwords and protects proprietary information by sharing proofs about the data without sharing the actual data.

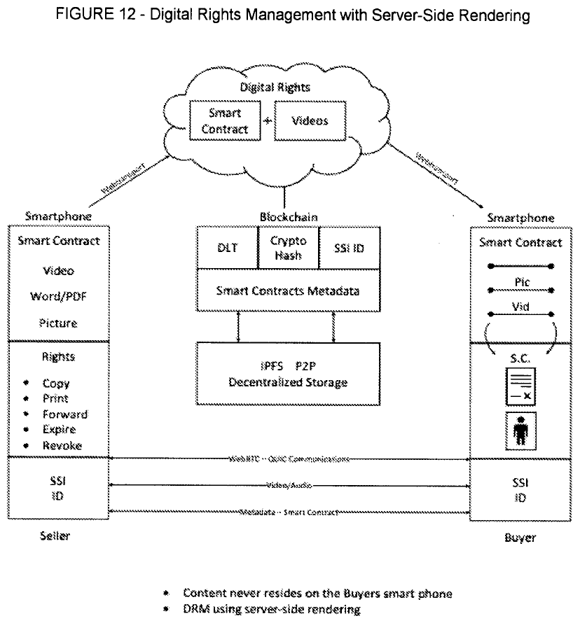

### FIG. 12

Referring now to FIG. 12, FIG. 12 is a diagram illustrating Digital Rights Management with File Rendering. FIG. 12 shows a Digital Rights platform having Smart contract and/or Ricardian contracts and Videos in communication with a Seller Smartphone and a Buyer Smartphone. The App on the Smartphones provides SSI ID and DRM assignment. The Digital Rights platform is connected to a Blockchain having DLT, Crypto Hash, and SSI ID features, as well as Smart contract and/or Ricardian contract metadata. The Blockchain is connected to the IPFS P2P decentralized storage. The WebRTC-QUIC communications platform provides video/audio as well metadata for the Smart contract and/or Ricardian contract. The content never resides on the buyer's phone, but is accessed thru a DRM-protected link using file rendering of a link providing access to platform-based content.

### Digital Rights Management—File Rendering

NFTs revolutionized the creative landscape for art, culture, music, sports, etc. But the ability to integrate and wrap this NFT tokenized representation with enciphered verification and a validation process guaranteed by the blockchain is not straight forward. That is, because these are confined to a single network and may need to use bridges to move the tokenized representations with additional verification, and that only addresses the ownership or claim. It does not guarantee “digital rights.”

A need exists for a secure digital rights management (DRM) system to be integrated into the Zero Trust Security Enclave to manage, protect, and control all private messaging and multimedia communications between private NFT patent buyers and sellers. The inventive DRM system consists of a secure content based messaging and object sharing mobile or desktop application connected to a Web3 DRM server that provides digital rights management of messages, videos, content attachments, blockchain transactions, and smart contract and/or Ricardian contracts with the capability of rendering links to such electronic messaging objects, e.g. messages, documents, photos, video, smart contract and/or Ricardian contracts shared between NFT users and the ability to revoke access to the electronic messaging objects when a DRM violations occur.

In this DRM design, the application can interface with a user's contacts application and operate in both Android and iOS environments. The secure text messaging and object sharing application connects to DRM server to locate an attachment, assign DRM permissions to either the text message, the attachment, or both, store the DRM-modified electronic messaging object, and transmit an HTML link from a Sender to a Receiver. The DRM design also includes a zero trust cryptographic system for secure messaging and object sharing that comprises an encrypted DRM mobile messaging app, and an encrypted DRM server. The term “File rendering”, is the ability of an application to display the webpage on the server instead of rendering it in the browser. File rendering sends a fully rendered page to a client-device. In one embodiment, the SSR uses static rendering to send a fully rendered HTML to a recipient browser. In another embodiment, the SSR uses dynamic rendering to produce HTML on-demand for each URL link. In a preferred embodiment, the DRM Platform dynamically selects the type of depending on the type of messaging content being delivered.

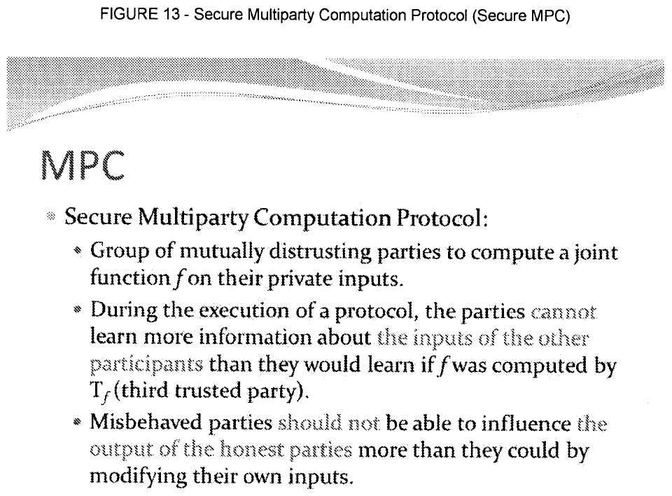

### FIG. 13

Referring now to FIG. 13, FIG. 13 is a diagram illustrating the Secure Multiparty Computation Protocol (Secure MPC).

### Secure Multi-Party Computation (MPC)

Secure multi-party computation (also known as secure computation or privacy-preserving computation) is a subfield of cryptography with the goal of creating methods for parties to jointly compute a function over their inputs while keeping those inputs private. Unlike traditional cryptographic tasks, where cryptography assures security and integrity of communication or storage and the adversary is outside the system of participants (an eavesdropper on the sender and receiver), the cryptography in this model protects participants' privacy from each other.

In a democratic world, we rely on mechanisms in which all concerned parties are consulted and heard before important decisions are taken. Multi-Party Computation (MPC) imbibes this philosophy in which two or more parties jointly compute an output by combining their individual inputs. The combined computed output could be used for taking important actions such as executing transactions on blockchain. MPC also ensures that the private inputs of each party are kept confidential, thus adding another dimension of Zero Knowledge Proof (ZKP) as described earlier.

### MPC Solutions Must Adhere to Two Main Principles:

Input privacy—the private data held by parties collaborating to build a combined output cannot be inferred or deduced

Correctness—the output obtained is always correct and parties should not be able to influence an incorrect output

MPC works on the assumption that all concerned parties can communicate on a secured and reliable channel. Each party exchanges an encrypted version of their private input, which undergoes computational operations to build the desired output. MPC systems also need to consider that certain parties can be dishonest (adversaries) and the implementation complexity is directly proportional to the type of adversaries (partially or fully dishonest) expected in a particular use case.

In Secure MPC, computations can be performed on data contributed by multiple parties without any individual party being able to see more than the portion of the data they contributed. This enables secure computation to be performed without the need for a trusted third party.

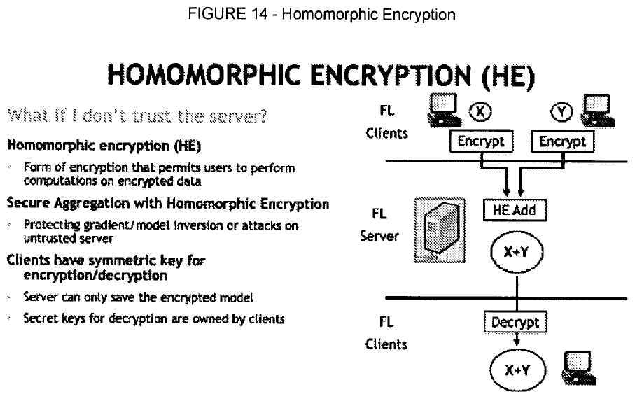

### FIG. 14

Referring now to FIG. 14, FIG. 14 is a diagram illustrating Homomorphic Encryption.

### Homomorphic Encryption

Homomorphic encryption is a form of encryption that permits users to perform computations on its encrypted data without first decrypting it. These resulting computations are left in an encrypted form which, when decrypted, results in an identical output to that produced had the operations been performed on the unencrypted data. Homomorphic encryption can be used for privacy-preserving outsourced storage and computation. This allows data to be encrypted and outsourced to commercial platform environments for processing, all while encrypted.

For sensitive data, such as private NFTs, homomorphic encryption can be used to enable new services by removing privacy barriers inhibiting data sharing or increase security to existing services. Moreover, even if the NFT service provider is compromised, the data would remain secure.

Homomorphic encryption is a form of encryption with an additional evaluation capability for computing over encrypted data without access to the private key. The result of such a computation remains encrypted. Homomorphic encryption can be viewed as an extension of public-key cryptography. Homomorphic refers to homomorphism in algebra: the encryption and decryption functions can be thought of as homomorphisms between plaintext and ciphertext spaces.

Homomorphic encryption includes multiple types of encryption schemes that can perform different classes of computations over encrypted data. The computations are represented as either Boolean or arithmetic circuits. Some common types of homomorphic encryption are partially homomorphic, somewhat homomorphic, and fully homomorphic encryption.

For most homomorphic encryption schemes, the multiplicative depth of circuits is the main practical limitation in performing computations over encrypted data. Homomorphic encryption schemes are inherently malleable. In terms of malleability, homomorphic encryption schemes have weaker security properties than non-homomorphic schemes.

### V. A Secure Blockchain Based Self-Sovereign Identity Management for Private NFTS

### V a Secure Blockchain Based Self-Sovereign Identity (SSI) for Private NFTs

Self-sovereign identity (SSI) is an approach to digital identity that gives individuals control of their digital identities.

SSI addresses the difficulty of establishing trust in an interaction. To be trusted, one party in an interaction will present credentials to the other parties, and those relying parties can verify that the credentials came from an issuer that they trust. In this way, the verifier's trust in the issuer is transferred to the credential holder. This basic structure of SSI with three participants is sometimes called “the trust triangle”.

It is generally recognized that for an identity system to be self-sovereign, users control the verifiable credentials that they hold, and their consent is required to use those credentials. This reduces the unintended sharing of users' personal data. This is contrasted with the centralized identity paradigm where identity is provided by some outside entity.

In an SSI system, holders generate, and control unique identifiers called Decentralized Identifiers. Most SSI systems are decentralized, where the credentials are verified using Public-key cryptography anchored on a distributed ledger or Blockchain. The credentials may contain data from an issuer's database, a messaging service contact list, a social media account, a history of transactions on an e-commerce site, or attestation from friends or colleagues.

DIDs are a type of identifier that enables a verifiable, decentralized digital identity. They are based on the Self-sovereign identity paradigm. A DID identifies any subject (e.g., a person, organization, thing, data model, abstract entity, etc.) that the controller of the DID decides that it identifies. These identifiers are designed to enable the controller of a DID to prove control over it and to be implemented independently of any centralized registry, identity provider, or certificate authority. DIDs are URIs that associate a DID subject with a DID document allowing trustable interactions associated with that subject. Each DID document can express cryptographic material, verification methods, or service endpoints, which provide a set of mechanisms enabling a DID controller to prove control of the DID. Service endpoints enable trusted interactions associated with the DID subject. A DID document might contain semantics about the subject that it identifies. A DID document might contain the DID subject itself (e.g., a data model).

### A. Self-Sovereign Identity Description

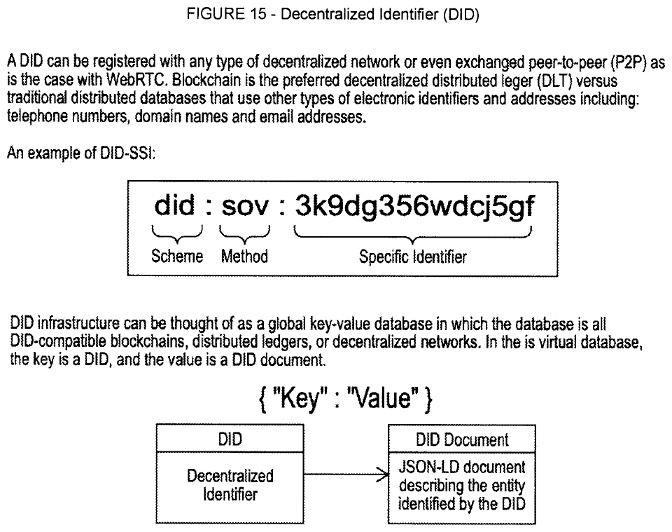

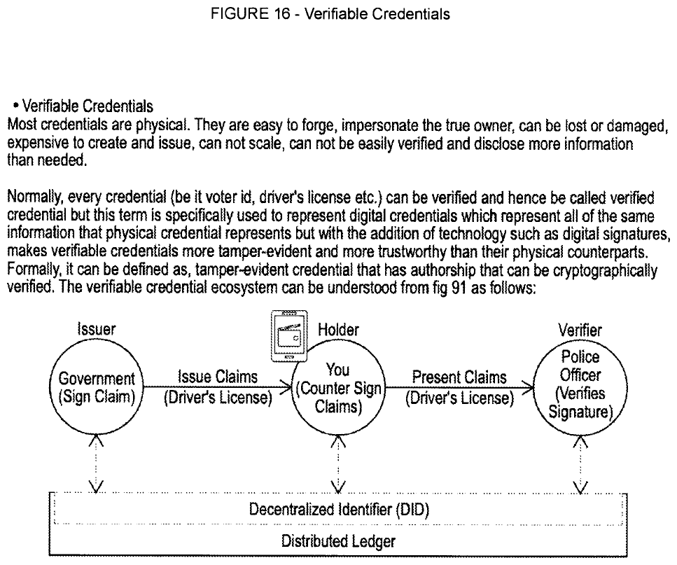

FIGS. 15 and 16 are the building blocks and work flow of the SSI model. A description of each building block of SSI is discussed below:

DID infrastructure can be thought of as a global key-value database in which the database is all DID-compatible blockchains, distributed ledgers, or decentralized networks. In this virtual database, the key is a DID, and the value is a DID document.

A Decentralized Identifier (DID) is a new type of identifier that is globally unique, resolvable with high availability, and cryptographically verifiable. The DID are addresses on the DLT of those public keys of users. DID is associated with cryptographic materials such as public key and service endpoints and are used to establish secure communication channels. Also note that one user can have more than one DIDs. In short it fulfils 4 requirements of SSI system:
Permanent—It never need to change
Resolvable—You can look it up to get metadata
Cryptographically verifiable—You can prove the ownership using cryptography
Decentralization—No centralized registration authority is required.

A DID can be registered with any type of decentralized network or even exchanged peer-to-peer (P2P) as is the case with WebRTC. Blockchain is the preferred decentralized distributed leger (DLT) versus traditional distributed databases that use other types of electronic identifiers and addresses including telephone numbers, domain names and email addresses.

An example of DID-SSI is summarized below:

### FIG. 15

did: sov: 3kidg356wdcj5gf.

### Scheme Method Specific Identifier

DID infrastructure can be thought of as a global key-value database in which the database is all DID-compatible blockchains, distributed ledgers, or decentralized networks. In this virtual database, the key is a DID, and the value is a DID document.

FIG. 15 shows a {“Key”: “Value” }, a DID as a Decentralized Identifier for a DID Document and a JSON-LD document describing the entity identified by the DID

### Blockchain—Distributed Leger

Blockchains are highly tamper-resistant transactional distributed databases that no single party controls. This means they can provide an authoritative source of data that many different peers can trust without any single peer being in control. Blockchains intentionally trade off many other standard features of distributed transactional databases—performance, efficiency, scalability, searchability, ease of administration—to solve one really hard problem—trusted data that does not need to rely on a central trusted authority. From the standpoint of SSI—and specifically for registering and resolving the DIDs and public keys that enable digital wallets and digital agents to securely communicate and exchange verifiable credentials—the differences between the various types of blockchains (permissionless, permissioned, hybrid, etc.) do not matter much. A DID method can be written to support pretty much any modern blockchain or other decentralized network.

It solves a problem that has never had a solution in the history of cryptography: they are globally distributed databases that can serve as a source of truth for public keys without being subject to single points of failure or attack. This is what provides the strong foundation needed for the ubiquitous adoption of the verifiable digital credentials at the heart of SSI.

### DID Document

The purpose of the DID document is to describe the public keys, authentication protocols, and service endpoints necessary to implement cryptographically verifiable interactions with the identified entity. It includes six components:
DID (for self-description)
Set of public keys (for verification)
Set of auth methods (for authentication protocol)
Set of service endpoint (for interaction)
Timestamp (for audit history)
Signature (for integrity)
Decentralized Key Management System (DKMS)

DKMS provides a decentralized key management system so users can easily manage large numbers of DIDs and private cryptographic keys.

DKMS is an emerging open standard for managing user's (DIDs and private keys. The foundation for DKMS is laid by the DID specification. It applies to wallets where the user stores his DIDs and private keys. The concept is to have a standard for developing wallets so that the user does not worry about security, privacy or vendor lock-in.

### DID Auth (Authority)

DID Auth is a ceremony where an identity owner, with the help of various components such as web browsers, mobile devices, and other agents, proves to a relying party that they are in control of a DID. Essentially DID Auth is the protocol for authentication and authorization in SSI systems. DID Auth includes the ability to establish mutually authenticated communication channels and to authenticate web sites and applications. Authorization, Verifiable Credentials, and Capabilities are built on top of DID Auth.

A successful DID Auth interaction may create the required conditions to allow the parties to exchange further data in a trustworthy way. DID Auth may be a one-way interaction where party A proves control of a DID-A to party B, or a two-way interaction where mutual proof of control of DIDs is achieved. In the latter case, party A proves control of DID-A to party B and party B proves control of DID-B to party A.

Like other authentication methods, DID Auth relies on a challenge-response cycle in which a relying party authenticates the DID of an identity owner. During this cycle, an identity owner demonstrates control of their authentication material that was generated and distributed during DID Record Creation through execution of the authentication-proof mechanism.

### FIG. 16

FIG. 16 is an illustration of a non-limiting preferred embodiment of the Verifiable Credentials. FIG. 16 shows an example of Verifiable Credentials where the Issuer, e.g. Gov't (sign claim), and Issue claims (Driver's license) to a Holder, who then, You (counter sign claims), making them available to Present claims (Driver's license) to a Verifier, e.g. Police Officer (verifies sig). Similar activities now are processed using Decentralized Identifier (DID) and the Distributed Ledger.

### Verifiable Credentials

Most credentials are physical. They are easy to forge, impersonate the true owner, can be lost or damaged, expensive to create and issue, cannot scale, cannot be easily verified, and disclose more information than needed.

Normally, every credential (be it voter id, driver's license etc) can be verified and hence be called verified credential but this term is specifically used to represent digital credentials which represent all of the same information that a physical credential represents but with the addition of technology such as digital signatures, makes verifiable credentials more tamper-evident and more trustworthy than their physical counterparts. Formally, it can be defined as, tamper-evident credential that has authorship that can be cryptographically verified.

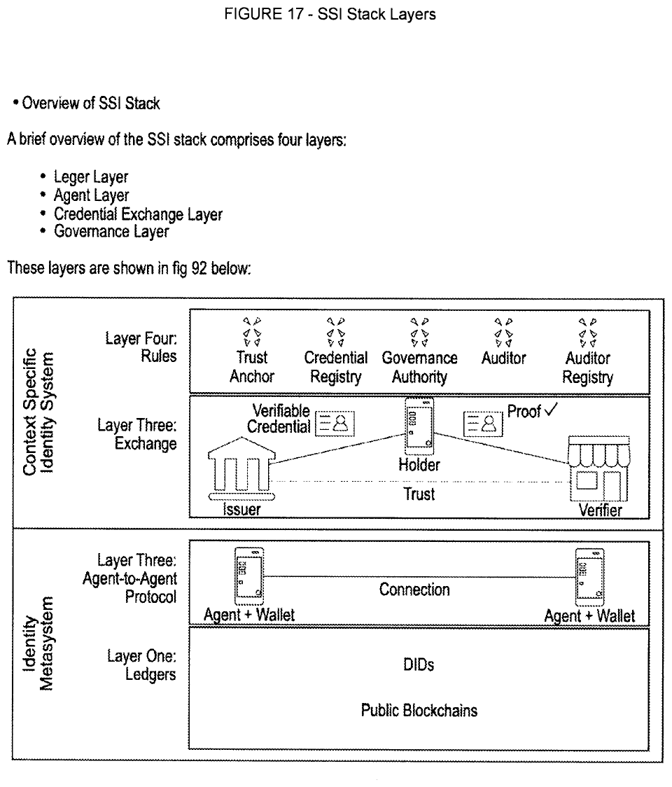

### FIG. 17

FIG. 17 is an illustration of a non-limiting preferred embodiment of the Overview of an SSI Stack. FIG. 17 shows a Context Specific Identity System having Layer Four: Rules comprising a Trust Anchor, a Credential Registry, a Governance Authority, an Auditor, and an Auditor Accreditor. Layer Three: Exchange shows the Issuer sending a Verifiable Credential to a Holder to establish Trust, and Proof to the Verifier.

FIG. 17 shows the Identity Metasystem, comprising Layer Two: Agent-to-Agent Protocol having the Agent+Wallet connections, and Layer One: Ledgers having the DIDs and Public Blockchains.
Layer One—Blockchain and DIDs—is the foundational layer consisting of DIDs registered and resolved via Blockchain using distributed leger technology (DLT)
Layer Two—Platform layer (Agent-to-Agent Protocol, non-Cloud)—consists of Platform agents and digital wallets that provide a means of communicating and mediating between the DID layer and the Edge or Exchange layer. The Platform layer enables encrypted peer-to-peer communications exchange and verification of DIDs, public keys and verifiable credentials. The SSI stack technology shall be integrated with WebRTC—video, audio and data communication using peer-to-peer communications.
Layer Three—Edge-Exchange Layer—consists of the local devices, agents and digital wallets used directly by identity owners (on WebRTC clients) to generate and store most private keys and perform most key management operations.
Layer Four—consists of a Trust Anchor, the Credential Registry, the Governance Authority and the Auditor/Accreditor.

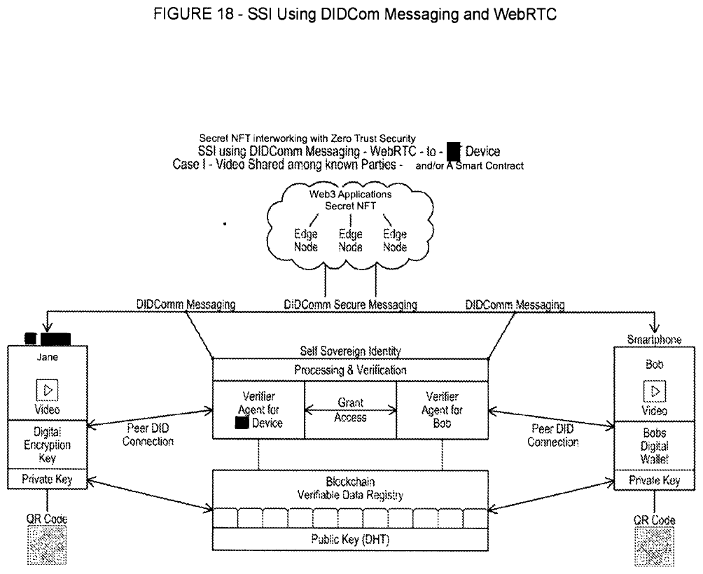

### FIG. 18

FIG. 18 is an illustration of a non-limiting preferred embodiment of the Relationship between Owners, DIDs and VCs. FIG. 18 shows the Relationship Between Owners, DIDs and VCs. Individual Owner/Organization provide Any Identity owner can create VC and attach attributes to devices, and Individuals can create, control, reveal or destroy DIDs. Decentralized IDs (DIDs), DID-1, DID-2, DID-3 establish Verifiable Claims VC-1, VC-2, VC-3 to deploy DID on devices.

### (2) Deploying DIDs on Devices

For most devices, DIDs can be deployed directly on the device and can be used without any deployment or execution issues, including computing resources, storage capabilities, key storage, and cryptographic calculations. For devices that are extremely constrained or not trusted to store important privates such as private keys, a proxy-server based approach, where the proxy performs the above complex operations (eg. Public-private key cryptography) on behalf of the device may be used.

In order to utilize distributed identifiers and verifiable credentials, the device should have (1) sufficient performance for cryptographic operations, (2) a sufficient amount of energy to perform the required operations, (3) nonvolatile storage space to store the code and cryptographic keys, and (4) sufficient entropy source to generate random cryptographic keys.

From the performance point of view, the most limiting factor is the performance of public-key cryptographic operations, namely, key generation, signature generation, and signature verification. Presently, most DID solutions utilize elliptic curve cryptography (ECC) (as opposed to, e.g., RSA) due to its significantly smaller key size and the fact that all three operations are relatively fast and take roughly a similar amount of time (with RSA, key generation can take orders of magnitude longer than signature generation or verification operations). Lately, there has been much research about the performance of ECC on constrained devices.

FIG. 18 shows SSI for Private NFTs Interworking with Zero Trust Security. FIG. 18 shows the case of a Smart contract and/or Ricardian contract and/or Video Shared Among Known Parties using Web3 Applications for a Private NFT, having Edge Nodes, and using Smart Phones. FIG. 18 shows Jane Video connected to Jane's Digital Wallet using a Private Key. A QR Code can be used. jane's device provisions a Peer DID Connection using Self Sovereign Identity for Processing & Verification. A Verifier Agent for Jane grants Access along with a Verifier Agent for Bob. A Blockchain Verifiable Data Registry provides the Public Key (DHT). A

Smart Phone provides Bob Video connected to Bob's Digital Wallet, protected by a Private Key. A QR Code can be used to facilitate the process.

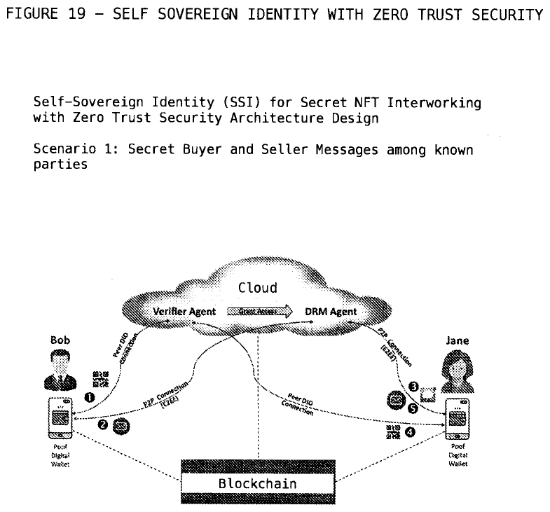

### FIG. 19

FIG. 19 is an illustration of a Self-Sovereign Identity (SSI) for private NFT Interworking with Zero Trust Security Architecture Design. FIG. 19 shows Scenario 1: Private Buyer and Seller Massages among known parties. In this scenario Bob and Jane know each other. Jane is in Bob's contact list and is a App user. The diagram below shows the message flow: Platform, Verifier Agent, Peer DID Connection, Bob, Digital Wallet, P2P Connection (E2EE). Then, the process Grants Access, and a DRM Agent governs the P2P Connection (E2EE). Jane uses the App Digital Wallet, along with a Peer DID Connection, and access for the Blockchain.

The steps numbered in the diagram are described below.

Bob opens his Digital Wallet on his phone and scans the QR code to establish his identity with the platform service. Credentials are exchanged between Bob's Digital Wallet and the Verifying Agent in the Platform. Bob's identity is verified, and he is granted access to send his message.

Bob composes his message addressed to Jane and selects the send button. The message is transmitted to Platform's DRM Agent over the secure peer-to-peer E2E encrypted connection.

SSI service recognizes Jane's address and sends her a notification that a message is waiting for her. The notification could be sent over the phone network or over the secured P2P connection.

Jane logs in to the service by scanning QR code with her Digital Wallet. Jane's identity is verified by the Verifying Agent, and she is granted access to DRM Agent.

The DRM Agent sends a link to Jane over the secure P2P E2EE connection. Jane clicks on the link and views the message sent to her by Bob. The DRM Agent enforces the rights given to Jane by Bob for viewing the message.

### Scenario 2: Private Buyer and Seller Messages Among Unknown Parties

In this scenario Bob does not know Jane and has been told about her or has read her blog. Bob looks up Jane on the user list and wishes to send her a message.

To accept messages from people not known to Jane, her Digital wallet requires identification and validation of the sender. This can be accomplished by Bob presenting his Verifiable Credentials (VCs) which can be examined and verified cryptographically by Jane's wallet. Jane has established certain requirements for the nature of VCs, based on which her Digital Wallet can accept Bob's message or reject it.

There are three parties involved in the issuing and verification of VCs.

Issuer: any entity can issue VCs. However, for the VC to be credible they should be issued by a trusted organization such as government agencies (passport, driver license), financial institutions (credit cards), universities (degrees), corporations (employment credentials), NGOs (membership cards), churches (awards), etc.

If the requester/holder is eligible to get a VC, the issuer will send a digitally signed VC to the holder. The issuer then writes the issuance of VC to a Blockchain network using holder's DID and signed by issuer's digital signature. The record then becomes available to anyone verifying the validity of the VC.

Holder: is the person to whom the credentials belong. The credentials are held in the holder's digital wallet and the holder always maintains possession of them.

If the holder accepts a request for sharing the credentials, proof of necessary information is given to the requester/verifier. The VCs never leave the digital wallet of the holder.

A verifier is seeking trust assurance of holder's identity and credibility. Verifiers can request proof from the holders for one or more claims from their VCs. If the holder agrees, the holder's wallet responds with proof, which the verifier can then verify. The critical step in this process is the verification of the issuer's digital signature, typically accomplished using a DID and Blockchain.

The process of Bob to obtain VCs and their verification by Jane's wallet is shown in the following diagram.

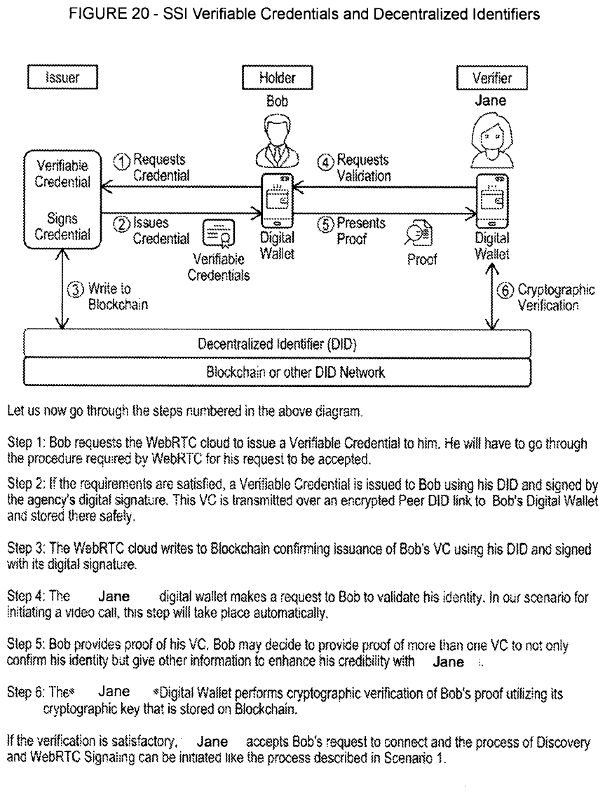

### FIG. 20

FIG. 20 shows the steps of: 1 Requests Credential, 2 Issues Credential, 3 Write to Blockchain, 4 Requests Validation, 5 Presents Proof, and 6 Cryptographic Verification.

Let us now go through the steps numbered in the above diagram.

Bob requests an agency to issue a Verifiable Credential to him. He will have to go through the procedure required by the agency for his request to be accepted.

If the agency's requirements are satisfied, a Verifiable Credential is issued to Bob using his DID and signed by the agency's digital signature. This VC is transmitted over an encrypted Peer DID link to Bob's Digital wallet and stored there safely.

The agency writes to Blockchain confirming issuance of Bob's VC using his DID and signed with its digital signature.

Jane's digital wallet makes a request to Bob to validate his identity. In our scenario for messaging this step will take place automatically since Jane is not in Bob's contact list.

Bob provides proof of his VC. Bob may decide to provide proof of more than one VC to not only confirm his identity but give other information to enhance his credibility with Jane.

Jane's Digital wallet performs cryptographic verification of Bob's proof utilizing the information written on Blockchain.

If the verification is satisfactory, Jane accepts Bob's request to connect.

The process described above is complicated, but all the heavy lifting is seamlessly done in the background. Sophisticated cryptographic techniques and Blockchain make it completely effortless for both Bob and Jane. Moreover, it happens rapidly and automatically.

The complete process of Bob sending a DRM message and Jane viewing it, is shown in the following diagram.

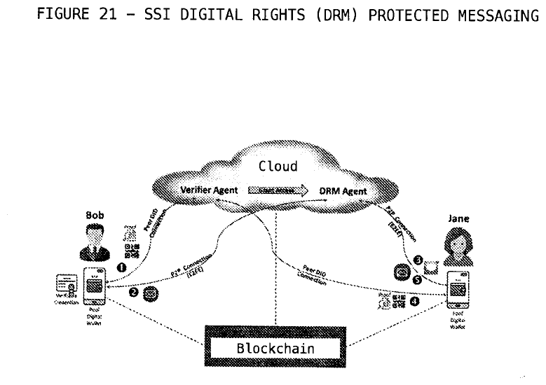

### FIG. 21

FIG. 21 is an illustration showing sending a DRM message.

In the above diagram it is assumed that Bob has obtained Verifiable Credentials to establish his identity and credibility and these VCs are safely stored in his digital wallet.

Below is the description of the numbered steps.

Bob logs into the service using the QR code to send a message to Jane. Bob's digital wallet knows that Jane is not a trusted connection of Bob and sends the proof of Bob's VCs.

The Verifier Agent examines Bob's credentials and proof requirements. Bob is granted access to DRM. Bob sends a DRM message to Jane over the encrypted network.

The DRM notifies Jane that a message is waiting for her.

Using the QR code, Jane's digital wallet examines the proofs sent by Bob and verifies them against the cryptographic data on Blockchain. If the information is satisfactory, Jane's digital wallet accepts the connection request.

Jane is given access to Bob's message to view it.

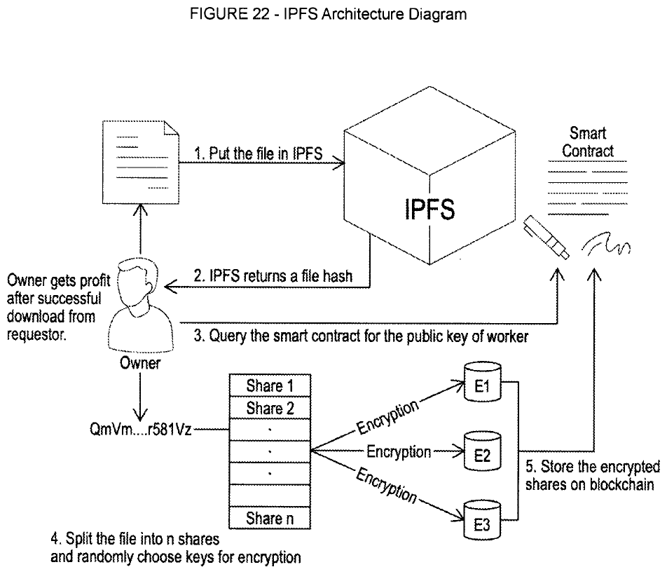

### FIG. 22

### VI. Interplanetary File System (IPFS) Decentralized p2p Data Storage

IPFS is a distributed system for storing and accessing files, websites, applications, and data. IPFS makes this possible for not only web pages but also any kind of file a computer might store, whether it's a document, an email, or even a database record. Instead of being location-based, IPFS addresses a file by what's in it, or by its content. The content identifier above is a cryptographic hash of the content at that address. The hash is unique to the content that it came from, even though it may look short compared to the original content. It also allows you to verify that you got what you asked for—bad actors can't just hand you content that doesn't match. Because the address of a file in IPFS is created from the content itself, links in IPFS can't be changed. For example, If the text on a web page is changed, the new version gets a new, different address. The content can't be moved to a different address.

### IPFS Fundamental Principles

There are three fundamental principles to understanding IPFS:
Unique identification via content addressing
Content linking via directed acyclic graphs (DAGs)
Content discovery via distributed hash tables (DHTs)
Content Addressing

IPFS uses content addressing to identify content by what's in it rather than by where it's located. Every piece of content that uses the IPFS protocol has a content identifier, or CID, that is its hash. The hash is unique to the content that it came from, even though it may look short compared to the original content.

Many distributed systems use content addressing through hashes as a means for not just identifying content, but also linking it together—everything from the commits that back your code to the blockchains that run cryptocurrencies leverage this strategy. However, the underlying data structures in these systems are not necessarily interoperable.

This is where the Interplanetary Linked Data (IPLD) project comes in. IPLD translates between hash-linked data structures, allowing for the unification of the data across distributed systems. IPLD provides libraries for combining pluggable modules (parsers for each possible type of IPLD node) to resolve a path, selector, or query across many linked nodes, allowing you to explore data regardless of the underlying protocol. IPLD provides a way to translate between content-addressable data structures: “Oh, you use Git-style, no worries, I can follow those links. Oh, you use Ethereum, I got you, I can follow those links too!” IPFS follows data-structure preferences and conventions. The IPFS protocol uses those conventions and IPLD to get from raw content to an IPFS address that uniquely identifies content on the IPFS network.

### Directed Acyclic Graphs (DAGs)

IPFS and many other distributed systems take advantage of a data structure called directed acyclic graphs (opens new window), or DAGs. Specifically, they use Merkle DAGs, where each node has a unique identifier that is a hash of the node's contents. Identifying a data object (like a Merkle DAG node) by the value of its hash is content addressing.

IPFS uses a Merkle DAG that is optimized for representing directories and files, but one can structure a Merkle DAG in many ways. For example, Git uses a Merkle DAG that has many versions of the repo inside of it. To build a Merkle DAG representation of the content, IPFS often first splits it into blocks. Splitting it into blocks means that different parts of the file can come from different sources and be authenticated quickly.

With Merkle DAGs everything has a CID. Let's say there is a file, and its CID identifies it. What if that file is in a folder with several other files? Those files will have CIDs too. What about that folder's CID? It would be a hash of the CIDs from the files underneath (i.e., the folder's content). In turn, those files are made up of blocks, and each of those blocks has a CID. This is how a file system on your computer could be represented as a DAG. This is how Merkle DAG graphs start to form.

Another useful feature of Merkle DAGs and breaking content into blocks is that if there are two similar files, they can share parts of the Merkle DAG, i.e., parts of different Merkle DAGs can reference the same subset of data. For example, when updating a website, only updated files receive new content addresses. The old version and ther new version can refer to the same blocks for everything else. This can make transferring versions of large datasets (such as genomics research or weather data) more efficient because there is only a need to transfer the parts that are new or changed, instead of creating entirely new files each time.

### Distributed Hash Tables (DHTs)

To find which peers are hosting the content you're after (discovery), IPFS uses a distributed hash table, or DHT. A hash table is a database of keys to values. A distributed hash table is one where the table is split across all the peers in a distributed network. To find content, ask these peers.

The libp2p project (discussed later) is the part of the IPFS ecosystem that provides the DHT and handles peers connecting and talking to each other. (Note that, as with IPLD, libp2p can also be used as a tool for other distributed systems, not just IPFS.)

Once it is known where the content is (or, more precisely, which peers are storing each of the blocks that make up the content sought), use the DHT again to find the current location of those peers (routing). So, to get to content, use libp2p to query the DHT twice.

Content is then discovered, and the current location(s) of that content is found. Now, there is need to connect to that content and get it (exchange). To request blocks from and send blocks to other peers, IPFS currently uses a module called Bitswap (opens new window). Bitswap allows one to connect to the peer or peers that have the content desired, send them the wantlist (a list of all the blocks you're interested in), and have them return the blocks that have been requested. Once those blocks arrive, they can be verified by hashing their content to get CIDs and compare them to the CIDs that you requested. These CIDs also allow deduplicating blocks if needed. There are other content replication protocols available as well, the most developed of which is Graphsync. SHA file hashes and content IDs may be used to verify the integrity of a file by matching SHA hashes, but SHA hashes won't match CIDs. Because IPFS splits a file into blocks, each block has its own CID, including separate CIDs for any parent nodes. The DAG keeps track of all the content stored in IPFS as blocks, not files, and Merkle DAGs are self-verified structures.

### Modular Paradigm

The IPFS ecosystem is made up of many modular libraries that support specific parts of any distributed system. Any part of the stack can be used independently or combined in novel ways. The IPFS ecosystem gives CIDs to content and links that content together by generating IPLD Merkle DAGs. Discovery of content using a DHT that's provided by libp2p, opening a connection to any provider of that content, and downloading it using a multiplexed connection is possible. All of this is held together by the middle of the stack, which is linked with unique identifiers; that's the essential part that IPFS is built on.

### FIG. 22

Referring now to FIG. 22, FIG. 22 is a diagram illustrating Data Sharing on IPFS by a Smart contract and/or Ricardian contract Owner. FIG. 22 shows the steps of: 1. Put the file in IPFS, 2. IPFS returns a file hash, 3. Query the smart contract and/or Ricardian contract for the public key of worker, 4. split the file into n shares and randomly choose keys for encryption, and 5. store the encrypted shares on blockchain.

FIG. 22 shows the IPFS-Blockchain Workflow for Secure Data/File Sharing Steps 1-4.

Step 1: Registration & Authentication of a User to create a Public-Private Key. Then provide the Registration Key in a File Processing Application to Register and Create User Smart contract and/or Ricardian contract on a Blockchain. The Smart contract and/or Ricardian contracts use Content Addressing. When Creating Smart contract and/or Ricardian contracts, the Metadata of the Smart contract and/or Ricardian contract and the User Smart contract and/or Ricardian contract are Deployed to Ethereum Blockchain.

Step 2: File Creation & Storage for a User to Create with Editor Application, starting by Creates Private Key & Encrypts the File using a File Processing Application. Then, Upload File to IPFS, Send Hash to File App on the Ethereum Blockchain (EVM). Using Dapps and Cryptography in a User Smart contract and/or Ricardian contract. The Metadata Smart contract and/or Ricardian contract Adds Smart contract and/or Ricardian contract Address using Metadata and the Metadata Smart contract and/or Ricardian contract Creates Smart contract and/or Ricardian contract and Returns the Address of Deployed Smart contract and/or Ricardian contract, and the App Files the Smart contract and/or Ricardian contract.

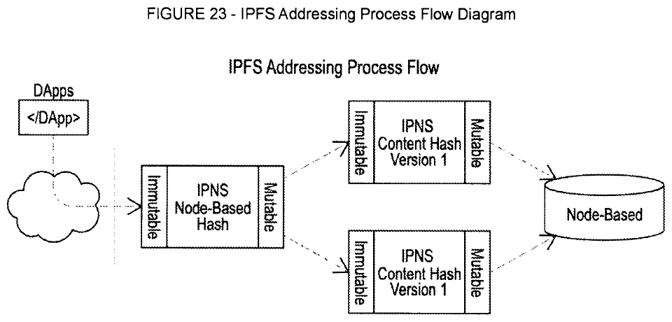

### FIG. 23

Referring now to FIG. 23, FIG. 23 is a diagram illustrating the IPFS Content Addressing Flow Process. FIG. 23 shows a DApp accessing through Web3, an immutable connect to an IPNS node-based hash, with a mutable connect to immutable IPFS content hash ver. 1 and IPFS content hash ver. 2, with swarm access to node storage. Step 3: The Step 3 process labels each subpart, including: File Access & Retrieval, Registration Details, File Processing & Mgt., Text Editor Application, Decrypts Encrypted Key using Public Key, Decrypts file using Produced key, Requests file using Hash, Sends Encrypted File, IPFS Storage, Requests user validation, Returns validation, Ethereum Blockchain (Ethereum Virtual Machine), File Smart contract and/or Ricardian contract, Users Metadata Smart contract and/or Ricardian contract, Access using map, Users Smart contract and/or Ricardian contract, and Files Metadata Smart contract and/or Ricardian contract

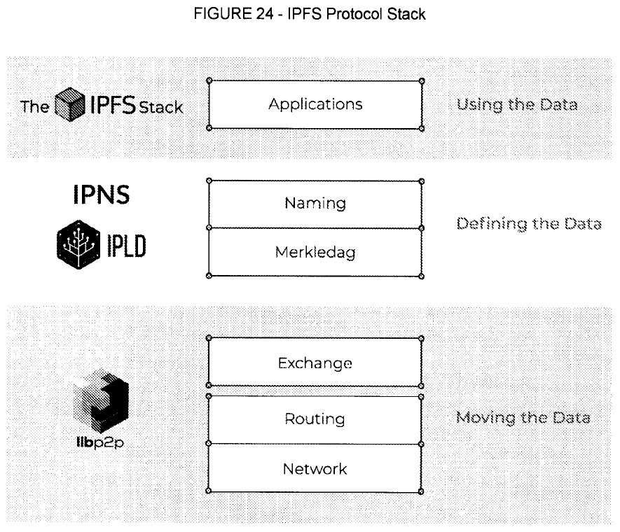

### FIG. 24

Referring now to FIG. 24, FIG. 24 is a diagram illustrating the IPFS Stack Built on Top of Content Addressable Web (IPLD and IPNS) Modular Naming System and libp2p Routing and Network Protocols. FIG. 24 shows the IPFS stack using applications for using the data, the IPNS and IPLD using Naming and Merkledag for defining the data, and libp2p using Exchange, Routing, and Network functions for moving the data.

Step 4: IPFS Validation Process for File and Editing Application. This process provides the functionality and various technologies and includes the labels: File Processing and Editing Application, IPFS API, Web 3.0, IPFS Daemon, SSI-Digital ID, Public/Private Keys, Data Transfer, Transactions, IPFS Storage, Ethereum Blockchain, and IPFS Node Network.

As a protocol for peer-to-peer data storage and delivery, IPFS is a public network of Nodes participating in the network store data affiliated with globally consistent content addresses (CIDs) and advertise that they have those CIDs available for other nodes to use through publicly viewable distributed hash tables (DHTs). This paradigm is one of IPFS's core strengths—at its most basic, it's essentially a globally distributed “server” of the network's total available data, referenceable both by the content itself (those CIDs) and by the participants (the nodes) who have or want the content.

What this does mean, however, is that IPFS itself isn't explicitly protecting knowledge about CIDs and the nodes that provide or retrieve them. This isn't something unique to the distributed web; on both the d-web and the legacy web, traffic and other metadata can be monitored in ways that can infer a lot about a network and its users. Some key details on this are outlined below, but in short: While IPFS traffic between nodes is encrypted, the metadata those nodes publish to the DHT is public. Nodes announce a variety of information essential to the DHT's function—including their unique node identifiers (PeerIDs) and the CIDs of data that they're providing—and because of this, information about which nodes are retrieving and/or re-providing which CIDs is publicly available.

IPFS protocol itself explicitly does not have a privacy or security layer built in. This is in line with key principles of the protocol's modular design, that is, different uses of IPFS over its lifetime may call for different approaches to privacy. Explicitly implementing an approach to privacy within the IPFS core could “box in” future builders due to a lack of modularity, flexibility, and futureproofing. On the other hand, freeing those building on IPFS to use the best privacy approach for the situation at hand ensures IPFS is useful. To address this security issue, additional measures such as disabling reproving, encrypting sensitive content, or even running a private IPFS network.

All traffic on IPFS is public, including the contents of files themselves, unless they're encrypted. For purposes of understanding IPFS privacy, this may be easiest to think about in two halves: content identifiers (CIDs) and IPFS nodes themselves.

### Content Identifier

Because IPFS uses content addressing rather than the legacy web's method of location addressing, each piece of data stored in the IPFS network gets its own unique content identifier (CID). Copies of the data associated with that CID can be stored in any number of locations worldwide on any number of participating IPFS nodes. To make retrieving the data associated with a particular CID efficient and robust, IPFS uses a distributed hash table (DHT) to keep track of what's stored where. When you use IPFS to retrieve a particular CID, your node queries the DHT to find the closest nodes to you with that item—and by default also agrees to re-provide that CID to other nodes for a limited time until periodic “garbage collection” clears your cache of content you haven't used in a while. You can also “pin” CIDs that you want to make sure are never garbage-collected—either explicitly using IPFS's low-level pin API or implicitly using the Mutable File System (MFS)—which also means you're acting as a permanent provider of that data.

This is one of the advantages of IPFS over traditional legacy web hosting. It means retrieving files—especially popular ones that exist on lots of nodes in the network—can be faster and more bandwidth-efficient. However, it's important to note that those DHT queries happen in public. Because of this, it's possible that third parties could be monitoring this traffic to determine what CIDs are being requested, when, and by whom. As IPFS continues to grow in popularity, it's more likely that such monitoring will exist.

### Node Identifiability

The other half of the equation when considering the prospect of IPFS traffic monitoring is that nodes' unique identifiers are themselves public. Just like with CIDs, every individual IPFS node has its own public identifier (known as a PeerID).

While a long string of letters and numbers may not be a “Johnny Appleseed” level of human-readable specificity, your PeerID is still a long-lived, unique identifier for your node. Keep in mind that it's possible to do a DHT lookup on your PeerID and, particularly if your node is regularly running from the same location (like your home), find your IP address. It's possible to reset your PeerID if necessary, but similarly to changing your user ID on legacy web apps and services, is likely to involve extra effort. Additionally, longer-term monitoring of the public IPFS network could yield information about what CIDs your node is requesting and/or re-providing and when.

### IPFS Security

If there are situations in which a user needs to remain private but still want to use IPFS, one of the approaches outlined below will work.

### Controlled Sharing

By default, an IPFS node announces to the rest of the network that it is willing to share every CID in its cache (in other words, reproviding content that it's retrieved from other nodes), as well as CIDs that you've explicitly pinned or added to MFS to make them consistently available. If you′d like to disable this behavior, you can do so in the re-provider settings (opens new window) of your node's config file. Changing your re-provider settings to “pinned” or “roots” will keep your node from announcing itself as a provider of non-pinned CIDs that are in your cache—so you can still use pinning to provide other nodes with content that you care about and want to make sure continues to be available over IPFS.

### IPFS Public Gateway

Using a public IPFS gateway is one way to request IPFS-hosted content without revealing any information about your local node—because you aren't using a local node. However, this method does keep you from enjoying all the benefits of being a full participant in the IPFS network.

Public IPFS gateways are primarily intended as a “bridge” between the legacy web and the distributed web; they allow ordinary web clients to request IPFS-hosted content via HTTP. That's great for backward compatibility, but if you only request content through public gateways rather than directly over IPFS, you're not actually part of the IPFS network; that gateway is the network participant acting on your behalf. It's also important to remember that gateway operators could be collecting their own private metrics, which could include tracking the IP addresses that use a gateway and correlating those with what CIDs are requested. Additionally, content requested through a gateway is visible on the public DHT, although it's not possible to know who requested it.

### IPFS Encryption

There are two types of encryptions in a network: transport-encryption and content-encryption.

Transport-encryption is used when sending data between two parties. Transport Layer Security (TLS), the successor of the now-deprecated Secure Sockets Layer (SSL), is a cryptographic protocol designed to provide communications security over a computer network. The protocol is widely used in applications such as email, instant messaging, and voice over IP, but its use in securing HTTPS remains the most publicly visible. The TLS protocol aims primarily to provide cryptography, including privacy (confidentiality), integrity, and authenticity through the use of certificates, between two or more communicating computer applications. It runs in the application layer and is itself composed of two layers: the TLS record and the TLS handshake protocols.

Content encryption is used to secure data until someone needs to access it. In cryptography, encryption is the process of encoding information. This process converts the original representation of the information, known as plaintext, into an alternative form known as ciphertext. Ideally, only authorized parties can decipher a ciphertext back to plaintext and access the original information. Encryption does not itself prevent interference but denies the intelligible content to a would-be interceptor. Modern encryption schemes use the concepts of public-key and symmetric-key. Modern encryption techniques ensure security because modern computers are inefficient at cracking the encryption.

IPFS uses transport encryption but not content encryption. This means that the data source is secure when being sent from one IPFS node to another. However, anyone can download and view that data or smart contract and/or Ricardian contract if they have a CID. The lack of content encryption is an intentional decision. Instead of forcing the user to deploy a specific encryption protocol, the user is free to choose whichever method is best for the security of the project. This modular design keeps IPFS lightweight and free of vendor lock-in.

If your privacy concerns are less about the potential for monitoring and more about the visibility of the IPFS-provided content itself, this can be mitigated simply by encrypting the content before adding it to the IPFS network. While traffic involving the encrypted content could still be tracked, the data represented by encrypted content's CIDs remains unreadable by anyone without the ability to decrypt it. The Zero Trust Security Platform always deploys advanced encryption to the content either 256 AES symmetric key encryption (approved by the NSA) or RSA Asymmetric Encryption Algorithm.

IPFS Design for Secure File Sharing Interworking with Web3 Blockchain

The inventive Blockchain-IPFS architecture design and workflow for decentralized file sharing consisting of: A File Processing and Text Editor Application (dApp); Ethereum Blockchain; Smart contract and/or Ricardian contracts used to govern, manage, and provide traceability into stored and shared content.

IPFS decentralized storage system; File security using AES-256 symmetrical encryption and Elliptical Curve Digital Signature (ECDA); and Encrypted files stored on IPFS which can only be accessed by the file editor.

The file and data sharing application ensures that the digital content would only be accessible in the application and will not be available in the end-users' operating system. Any modify or share operations performed on shared files are recorded separately to the blockchain to ensure security, integrity, and transparency.

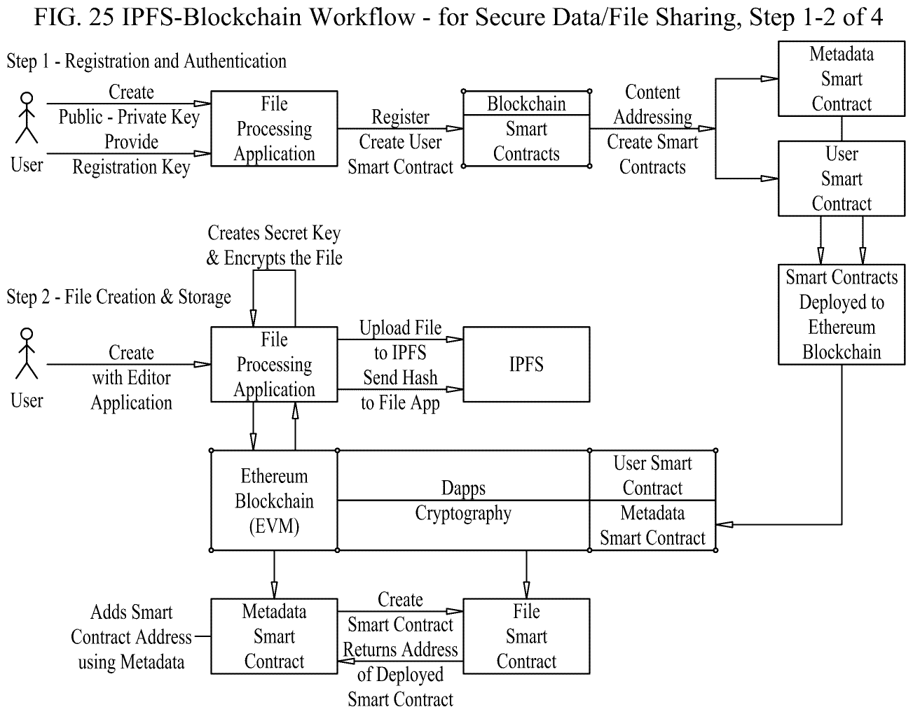

### FIG. 25

Referring now to FIG. 25, FIG. 25 is a diagram illustrating IPFS-Blockchain Workflow—A 4-step process for securing and sharing data files.

The Blockchain-IPFS system workflow shows the interworking system components and process of the inventive IPFS file storage and sharing architecture. Users first register to the File Processing application. The registration details of the user are added to the Ethereum blockchain by the application. After creation of the file in the application's inbuilt text processing and editor application, users can decide if the file should be shared or made public. If the file is supposed to be shared, the file owner provides the public key of recipients with whom the file should be shared with. The application then deploys a smart contract and/or Ricardian contract which stores the file metadata. It then encrypts the document and adds to IPFS in an encrypted format. To access the files, users are required to use the file sharing application since the file would be decrypted only in the application editor. The application uses the file smart contract and/or Ricardian contract to access the file metadata, fetches the file from IPFS, decrypts the file and opens in the file processing and editor application. To collect data and files, a user log calls to functions of smart contract and/or Ricardian contracts to request the files or data performed in the application editor. After an operation is performed, a permanent record is generated which is then uploaded to the Ethereum blockchain network and securely stored in the blockchain.

The inventive IPFS-Blockchain data and file sharing architecture can be divided into four main steps or phases:
Step 1—User Registration and Authentication,
Step 2—File creation and storage,
Step 3—File Access and retrieval, and
Step 4—File data collection, storage, and validation

A detailed discussion of the 4-step workflow process for IPFS data and file sharing interworking with Web3 is described below.

### Step 1—User Registration and Authentication

Users are required to register to the system to have a unique identity. Every user is required to create a smart contract and/or Ricardian contract which will act as a unique identity for them. The Metadata smart contract and/or Ricardian contract acts as a gatekeeper to generate a smart contract and/or Ricardian contract for every user after their registration. During the registration process, each user provides a registration key in the form of a string as an input to the application. Using this registration key and a current timestamp, the application generates public-private key pair using Elliptical Curve Digital Signature Algorithm (ECDSA). The Metadata deploys a smart contract and/or Ricardian contract of the registered user and obtains address of the deployed smart contract and/or Ricardian contract. The deployed user's smart contract and/or Ricardian contract contains user's Metadata which includes user's public key, registration key, an array of information regarding the files which have been shared with the user.

The Metadata also contains a mapping of every registered user's public key to the address of their deployed smart contract and/or Ricardian contract. After the deployment of the user's smart contract and/or Ricardian contract, the received deployed address of the user's smart contract and/or Ricardian contract is added to the mapping in the Metadata's smart contract and/or Ricardian contract. The public key generated during the registration process is used by the file owner while specifying the recipient to whom the file will be shared with. The registration key and private key will be used to validate the user authenticity during the login process of the file processing and sharing application. For authentication, users will provide registration which includes public and private key as an input to the file sharing application. The registration key is encrypted using a private key. Using the received public key as an input, user's smart contract and/or Ricardian contract deployed address can be fetched from the Metadata's mapping. As the user's smart contract and/or Ricardian contract is fetched from the obtained address, to validate the user, the application sends the Encrypted Registration Key to the encryption validation function of the user's smart contract and/or Ricardian contract. The Encrypted Registration Key is then decrypted using the public key of the user, and if resulting string is same as registration key of the user's smart contract and/or Ricardian contract, then user will be validated otherwise the authentication would fail.

### Step 2—File Creation and Storage

The owner creates a file in the application editor and requests a selected file for sharing on the File Processing application. The application creates a random key to encrypt the file using AES-256 symmetric key encryption. This random key will be the ‘Private Key’ for any given file which will only reside in the owner's File Processing application. The application then encrypts the file with the Private Key. This encrypted file is added to the IPFS network. IPFS network returns the hash of the uploaded file. As shown in Step 2, a smart contract and/or Ricardian contract is created for every deployed file on IPFS. The metadata smart contract and/or Ricardian contract acts as a factory to generate smart contract and/or Ricardian contracts for every file shared on the application. File's smart contract and/or Ricardian contract contains metadata which includes filename, IPFS address of the encrypted file and owner's public key. After deployment of the smart contract and/or Ricardian contract, the shared file application will receive the deployed file smart contract and/or Ricardian contract's address. Now, the file owner can specify the following types of access control for the specified file:

Shared File: In this access control, the owner can share the file with other users by using the public key of the user that they want to share the file with. After giving this public key to the File application as an input, the application will encrypt the private key of the file with the public key of the user with whom the file is to be shared to create an ‘Encryption Key’. This is asymmetric encryption, whereas the ‘Encryption Key’ can only be decrypted by the user who has corresponding Private Key. The Smart contract and/or Ricardian contract of the file, for shared mode contains a mapping of the receiver user's public key to the Encryption Key of the file. This mapping will be added to the shared file's smart contract and/or Ricardian contract. The files Metadata will access the user's Metadata to obtain the deployed address of receiver's user smart contract and/or Ricardian contract. The shared files smart contract and/or Ricardian contract address will be added to the receiver's user smart contract and/or Ricardian contract. Thus, the receiver user smart contract and/or Ricardian contract now will contain an array of deployed addresses of all the files which are shared with them.

Public: In this access control, the owner can share the file with every user who is registered on the file sharing application. The owner will specify the Private Key in the file's smart contract and/or Ricardian contract. The owner will send their public key along with deployed file smart contract and/or Ricardian contract's address to the Metadata smart contract and/or Ricardian contract. After these specifications are sent to the file's smart contract and/or Ricardian contract, other users will be able to access it if they are authorized of the File Sharing application.

### Step 3—File Access and Retrieval

On the file sharing application interface, after giving user's logging details such as registration key, public key and private key, the application will retrieve the user's deployed smart contract and/or Ricardian contract using Metadata smart contract and/or Ricardian contract. If user is validated, then file sharing application will now access the user's smart contract and/or Ricardian contract using Metadata. The user smart contract and/or Ricardian contract contains the address of deployed smart contract and/or Ricardian contracts of all files shared with them. These files will appear on the application interface as ‘my fileshares’. The Application interface will also retrieve all files which are publicly shared using Metadata smart contract and/or Ricardian contract. The following mechanisms are performed for the inventive access control types:

Shared File: Using the file's deployed smart contract and/or Ricardian contract address, the file sharing application will retrieve the key available in the mapping of the public key to encrypted key using the user's own public key. The received key will then be decrypted by user's private key in the application, and the generated key will be used to decrypt the accessed files by the file sharing application.

Public: Using the file deployed smart contract and/or Ricardian contract address, the file sharing application will request the decryption key of the file from corresponding file's smart contract and/or Ricardian contract deployed on blockchain. This key will be internally sent to the application and file share will decrypt the file and open in the application editor. The file accessed will be available to read for a session where session time would be a defined parameter. Also, the file can be modified in file share application, which will be redeployed in application along with original owner's public key attached to it. The uploaded content can only be accessed by using the application editor. The content cannot be downloaded nor be copied to clipboard of operating system from the editor.

Step 4—IPFS Process Validation and Integration with Web3 Applications

The IPFS validation process for the file and editing application consists of the following:

React.js is an open-source front-end JavaScript library for building user interfaces based on UI components and is used for the front end and interfaces with the Web3 client UI and Web3 servers.

Solidity—is an object-oriented programming language for writing smart contract and/or Ricardian contracts and is used for developing Smart contract and/or Ricardian contracts; and

Web3.js—is a collection of libraries that allow users to interact with local or remote Ethereum nodes and is used to interact with Ethereum nodes using an HTTP connection.

### VII. WebRTC—QUIC P2P Real-Time Communications

WebRTC is a free, open-source platform which facilitates browser-based P2P communications (voice, video, and data) on Android, IOS, and PC platforms. WebRTC is supported by most browser technologies including Chrome, Firefox, Safari Opera, and MS Edge.

QUIC Transport over WebRTC—General API Overview

The API has 3 main abstractions of WebRTC are RTC Ice Transport, RTC QUIC Transport and RTC QUIC Steam.

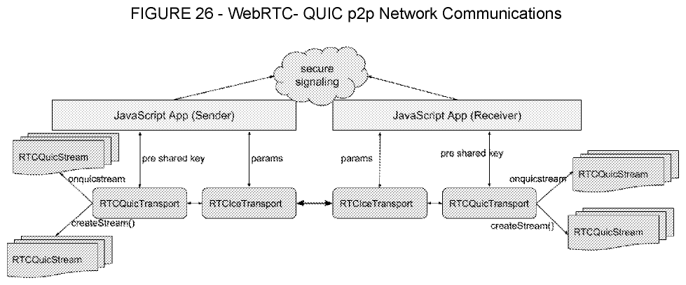

### FIG. 26

Referring now to FIG. 26, FIG. 26 is a diagram of WebRTC—QUIC p2p Network Communications illustrating the 3 Main Abstractions of WebRTC-QUIC Transport.

RTC Ice Transport—ICE is a protocol to establish peer-to-peer connections over the internet and is used in WebRTC today. This object provides a standalone API to establish an ICE connection. It is used as the packet transport for the QUIC connection, and the RTCQuicTransport takes it in its constructor

RTC QUIC Transport—Represents a QUIC connection. It is used to establish a QUIC connection and create QUIC streams. It also exposes relevant stats for the QUIC connection level.

RTC QUIC Stream—Used for reading and writing data to/from the remote side. Streams transport data reliably and in order. Multiple streams can be created from the same RTCQuicTransport and once data is written to a stream it fires an “onquicstream” event on the remote transport. Streams offer a way to distinguish different data on the same QUIC connection. Common examples can be sending separate files across separate streams, small chunks of data across different streams, or different types of media across separate streams. RTC QUIC Streams are lightweight, are multiplexed over a QUIC connection and do not cause head of line blocking to other RTC QUIC Streams.

Connection Setup—The following is an example for setting up a peer-to-peer QUIC connection. Like RTCPeerConnection, the RTCQuicTransport API requires the use of a secure signaling channel to negotiate the parameters of the connection, including its security parameters. RTCIceTransport negotiates its ICE parameters (ufrag and password), as well as RTCIceCandidates.

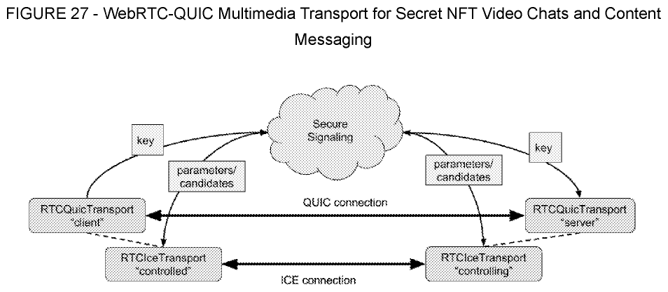

### FIG. 27

Referring now to FIG. 27, FIG. 27 is a diagram illustrating the WebRTC-QUIC Connection Setup for Private NFT Video Chats and Content Messaging.

WebRTC—QUIC Browser Based P2P Communications

WebRTC-QUIC is a technology that enables Web applications and sites to capture and optionally stream audio and/or video media, as well as to exchange arbitrary data between browsers without requiring an intermediary. The set of standards that comprise WebRTC makes it possible to share data and perform teleconferencing peer-to-peer, without requiring that the user install plug-ins or any other third-party software.

Multiple video and audio messaging systems have been developed recently. However, many systems require proprietary hardware and software systems, and are complicated to set up for an average user. Systems that are easy to set up and use often provide low quality video and audio. Commercial grade systems provide high quality video and audio, but these systems are expensive to install and require specialized technical support to operate and maintain.

WebRTC is a powerful, and highly disruptive cutting-edge technology and standard that has been developed over the last decade. As opposed to specialized applications and hardware, WebRTC leverages a set of plugin-free APIs used in both desktop and mobile browsers to provide high-quality functional video and audio streaming services. Previously, external plugins were required to achieve similar functionality to that provided by WebRTC.

WebRTC provides a secure real-time communications service for audio and video streaming communications and content sharing that securely connects multiple users using a proprietary application that uses WebRTC technology to establish a Peer-to-Peer (P2P) connection. WebRTC uses multiple standards and protocols, including data streams, STUN/TURN servers, signaling, JSEP, ICE, SIP, SDP, NAT, UDP/TCP, and network sockets.

However, there continues to be a need for security, encryption, DRM protection, and the advantages provided by incorporating blockchain technology for storage and sharing of streamed video, streamed audio, real-time messages, and DRM-protected files.

WebRTC-QUIC uniquely combines advanced security technologies to provide user-based permissions control when communicating and sharing rich media content with other users including End-to-End Encryption (E2EE), Hash Technology (DHT), and Digital Rights Protection (DRM). It has also designed a unique platform based streamed video storage and sharing platform service for consumers and business video storage and sharing applications.

U.S. Pat. No. 11,100,197 describes WebRTC that provide push-button connectivity between users for video and audio streaming using WebRTC technology for Web3 services to discover and establish peer-to-peer connection between users having a proprietary mobile or desktop application. Using the browser-based app, a sender may select one or more receivers, who also have the app, to have a video or audio chat, or share a file. Selecting the receiver(s) to send an invite initiates a complex group of processes, programming, and protocols, including generating a specific discovery communication file, sending the discovery communication file in a series of specially encrypted communications to a networked Web3 platform that includes a WebRTC Gateway Server, a Signaling Server, an IPFS Storage Server, and a Private Blockchain.

The WebRTC Gateway Server provides the discovery communication to the receiver using subscriber information managed in a private blockchain and stored in distributed IPFS storage with all lookup and delivery communications and all stored data specially encrypted. The receiver app generates a specific response/acceptance file, sends encrypted notification back to the WebRTC Gateway Server, and the WebRTC Gateway Server working with the Signaling Server to generate a peer-to-peer connection using the private and public IP addresses of the sender and receiver.

The sender may apply DRM permissions to the streamed video or audio content in the peer-to-peer connection and the app uses an encryption key that is integrated into and required for the playback CODEC to process the content and where a DRM violation results in revocation of the encryption key. Multi-party video and audio conferences may be broadcast using insertable streams for insertion of user defined processing steps for encoding/decoding of WebRTC media stream tracks and for end-to-end encryption of the encoded data.

### QUIC Transport Layer Network Protocol

QUIC is a general-purpose transport layer network protocol designed to improve connectivity, reliability, and speed for real time communications services on WebRTC peer-to-peer platform. QUIC is used by more than half of all connections from the Chrome web browser to Google's servers. Microsoft Edge and Firefox support it. Safari implements the protocol; however, it is not enabled by default.

QUIC improves the performance of connection-oriented web applications that are currently using TCP. It does this by establishing several multiplexed connections between two endpoints using User Datagram Protocol (UDP) and is designed to obsolete TCP at the transport layer for many applications, thus earning the protocol nickname “TCP/2”. QUIC works together with HTTP/2's multiplexed connections, allowing multiple streams of data to reach all the endpoints independently, and hence independent of packet losses involving other streams. In contrast, HTTP/2 hosted on Transmission Control Protocol (TCP) can suffer head-of-line-blocking delays of all multiplexed streams if any of the TCP packets are delayed or lost.

QUIC's secondary goals include reduced connection and transport latency, and bandwidth estimation in each direction to avoid congestion. It also moves congestion control algorithms into the user space at both endpoints, rather than the kernel space, which will allow these algorithms to improve more rapidly. Additionally, the protocol can be extended with forward error correction (FEC) to further improve performance when errors are expected.

Transmission Control Protocol, or TCP, aims to provide an interface for sending streams of data between two endpoints. Data is handed to the TCP system, which ensures the data makes it to the other end in the same form, or the connection will indicate that an error condition exists.

To do this, TCP breaks up the data into network packets and adds small amounts of data to each packet. This additional data includes a sequence number that is used to detect packets that are lost or arrive out of order, and a checksum that allows the errors within packet data to be detected. When either problem occurs, TCP uses automatic repeat request (ARQ) to tell the sender to re-send the lost or damaged packet.

In most implementations, TCP will see any error on a connection as a blocking operation, stopping further transfers until the error is resolved or the connection is considered failed. If a single connection is being used to send multiple streams of data, as is the case in the HTTP/2 protocol, all of these streams are blocked although only one of them might have a problem. For instance, if a single error occurs while downloading a GIF image, the entire rest of the page will wait while that problem is resolved.

As the TCP system is designed to look like a “data pipe”, or stream, it deliberately contains little understanding of the data it transmits. If that data has additional requirements, like encryption using TLS, this must be set up by systems running on top of TCP, using TCP to communicate with similar software on the other end of the connection. Each of these sorts of setup tasks requires its own handshake process. This often requires several roundtrips of requests and responses until the connection is established. Due to the inherent latency of long-distance communications, this can add significant overhead to the overall transmission.

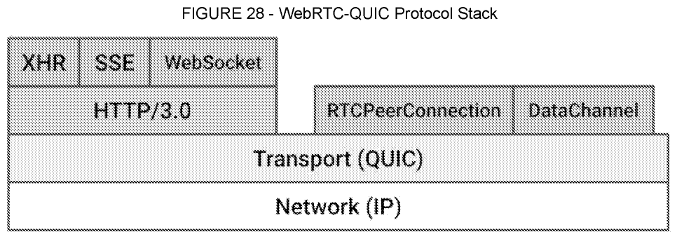

### FIG. 28

Referring now to FIG. 28, FIG. 28 is a diagram illustrating the WebRTC-QUIC HTTP/3 Protocol Stack.

QUIC+UDP versus TCP+TLS

QUIC aims to be nearly equivalent to a TCP connection but with much-reduced latency. It does this primarily through two changes that rely on the understanding of the behavior of HTTP traffic.

The first change is to greatly reduce overhead during connection setup. As most HTTP connections will demand TLS, QUIC makes the exchange of setup keys and supported protocols part of the initial handshake process. When a client opens a connection, the response packet includes the data needed for future packets to use encryption. This eliminates the need to set up the TCP connection and then negotiate the security protocol via additional packets. Other protocols can be serviced in the same way, combining multiple steps into a single request-response. This data can then be used both for following requests in the initial setup, as well as future requests that would otherwise be negotiated as separate connections.

The second change is to use UDP rather than TCP as its basis, which does not include loss recovery. Instead, each QUIC stream is separately flow controlled and lost data retransmitted at the level of QUIC, not UDP. This means that if an error occurs in one stream, the protocol stack can continue servicing other streams independently. This can be very useful in improving performance on error-prone links, as in most cases considerable additional data may be received before TCP notices a packet is missing or broken, and all this data is blocked or even flushed while the error is corrected. In QUIC, this data is free to be processed while the single multiplexed stream is repaired.

QUIC includes several other changes that also improve overall latency and throughput. For instance, the packets are encrypted individually, so that they do not result in the encrypted data waiting for partial packets. This is not generally possible under TCP, where the encryption records are in a byte stream and the protocol stack is unaware of higher-layer boundaries within this stream. These can be negotiated by the layers running on top, but QUIC aims to do all of this in a single handshake process.

Another goal of the QUIC system is to improve performance during network-switch events, like what happens when a user of a mobile device moves from a local WiFi hotspot to a mobile network. When this occurs on TCP, a lengthy process starts where every existing connection times out one-by-one and is then re-established on demand. To solve this problem, QUIC includes a connection identifier which uniquely identifies the connection to the server regardless of source. This allows the connection to be re-established simply by sending a packet, which always contains this ID, as the original connection ID will still be valid even if the user's IP address changes.

QUIC can be implemented in the application space, as opposed to being in the operating system kernel. This generally invokes additional overhead due to context switches as data is moved between applications. However, in the case of QUIC, the protocol stack is intended to be used by a single application, with each application using QUIC having its own connections hosted on UDP. Ultimately the difference could be very small because much of the overall HTTP/2 stack is already in the applications (or their libraries, more commonly). Placing the remaining parts in those libraries, essentially the error correction, has little effect on the HTTP/2 stack's size or overall complexity.

QUIC allows future changes to be made more easily as it does not require changes to the kernel for updates. One of QUIC's longer-term goals is to add new systems for forward error correction (FEC) and improved congestion control.

One concern about the move from TCP to UDP is that TCP is widely adopted and many of the “middle-boxes” in the internet infrastructure are tuned for TCP and rate-limit or even block UDP. Google carried out several exploratory experiments to characterize this and found that only a small number of connections were blocked in this manner. This led to the use of a rapid fallback-to-TCP system; Chromium's network stack opens both a QUIC and traditional TCP connection at the same time, which allows it to fallback with negligible latency.

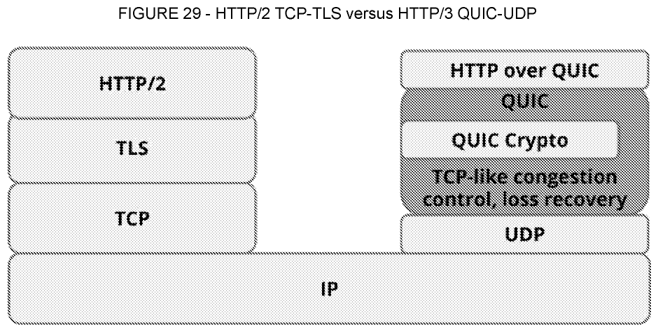

### FIG. 29

Referring now to FIG. 29, FIG. 29 is a diagram illustrating a Comparison of HTTP/2—TLS with HTTP/3 UDP-QUIC.

### QUIC Reduces Latency

QUIC is focused on reducing the number of roundtrips to establish a new connection. This includes the handshake step, encryption step, and initial data requests. QUIC drastically reduces latency through a few methods.

### Improved Multiplexing Support

HTTP/2 over TCP multiplexes and pipelines requests over one connection. This means that a single packet loss and retransmission packet causes head-of-line blocking (HOLB) for all the resources that are downloaded in parallel—the entire set of streams. The first packet holds up the rest of the line. QUIC overcomes the shortcomings of multiplexed streams by removing HOL blocking.

### Fewer Roundtrips

QUIC is focused on reducing the number of roundtrips to establish a new connection. This includes the handshake step, encryption step, and initial data requests. For example:
QUIC clients can include session negotiation information in the initial packet instead of in a separate packet.
QUIC servers publish a static configuration record that can be consistently referenced.
QUIC clients store a synchronization cookie, so they can connect to the server again easily and with no overhead.

### Improved Packet Loss Handling

QUIC can handle packet loss effectively due to several modern techniques. This may depend on what the developers choose to implement in QUIC, but since it is very flexible, it is possible the default version will include the techniques mentioned here.

QUIC may align cryptographic block boundaries and packet boundaries to reduce packet loss.

QUIC may use improved congestion control, including packet pacing based on ongoing bandwidth estimation.

QUIC may send duplicates of the most critical packets, also known as proactive speculative retransmission.

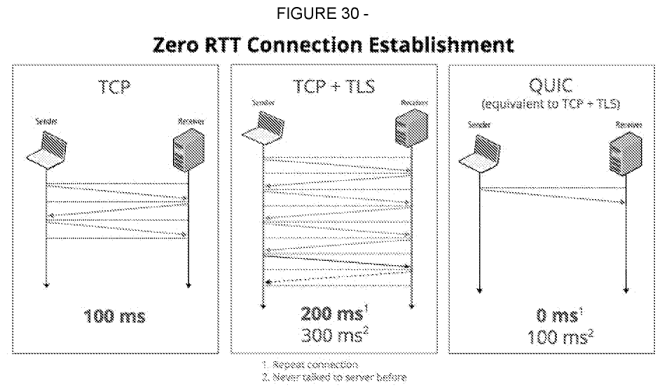

### FIG. 30

Referring now to FIG. 30, FIG. 30 is a diagram illustrating UDP-QUIC versus TCP for RTT Connection Establishment for Video Streams. FIG. 30 shows a 100 ms connection for TCP, a 200 ms (repeat)-300 ms (new) connection period for TCP+TLS, and a 0 ms (repeat)-100 ms (new) connection period for QUIC.

WebRTC—MPQUIC, Media Channel and Data Channels over QUIC

### Multipath QUIC (MPQUIC) for 4G/5G and WiFi Communications

Multipath QUIC is an extension to the QUIC protocol that enables hosts to exchange data over multiple networks over a single connection. QUIC is emerging as the premier transport layer protocol, providing encrypted, stream-multiplexed, low latency video and data transfer. Here we describe a multipath—enabled QUIC (MP QUIC) to leverage multiple telecom network interfaces, including WiFi, 4G LTE and 5G networks. MPQUIC design conceptually evolves beyond existing multipathing protocols such as MPTCP, as it provides advanced stream-to-path scheduling, reduced head-of-line blocking and faster connection time establishment with roundtrip connection times (O-RTT) in the range of 0-50 ms.

In contrast to transport protocols such as multipath TCP (MPTC) and the Stream Control Transmission Protocol (SCTP) currently deployed in WebRTC, QUIC does not require changes to the operating system, making it easily deployable within most applications in the Internet. Unlike TCP and MTCP, QUIC naturally multiplexes application streams, (real time video streams and data analytics) on a single connection as shown. This supersedes multiplexing HTTP/2 streams on a single TCP stream.

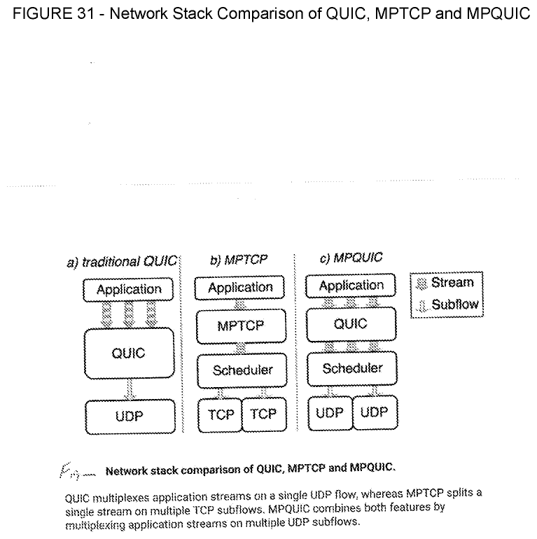

### FIG. 31

FIG. 31 illustrates a Network stack comparison of a) traditional QUIC, b) MPTCP, and c) MPQUIC.

QUIC multiplexes application streams on a single UDP flow, whereas MPTCP splits a single stream on multiple TCP subflows. MPQUIC combines both features by multiplexing application streams on multiple UDP subflows.

Many of today's communications devices possess multiple communications network interfaces, e.g. WiFi, 4G LTE and the recent launch of 5G. A multipath-enabled QUIC would be able to leverage multiple interfaces and become the universal stream transport protocol. Today's de facto multipathing transport protocol MPTCP already demonstrates the ability to use multiple paths for mobile devices and in data centers. But MPTCP must remain compatible with changing TCP enhancements and to reduce middlebox interference, MPTCP uses a complex set of TCP options, including a second sequence number space and additional check sums to detect errors that may be introduced during its transmission and storage. Also, as extensions to TCP, which is typically implemented in the OS, MPTCP requires operating system support in many different configurations. Lastly, out-of-order data arrival that is caused by heterogeneous network paths interferes with the strict-in-order delivery of MPTCP, blocking already received packets at the receiver from being processed.

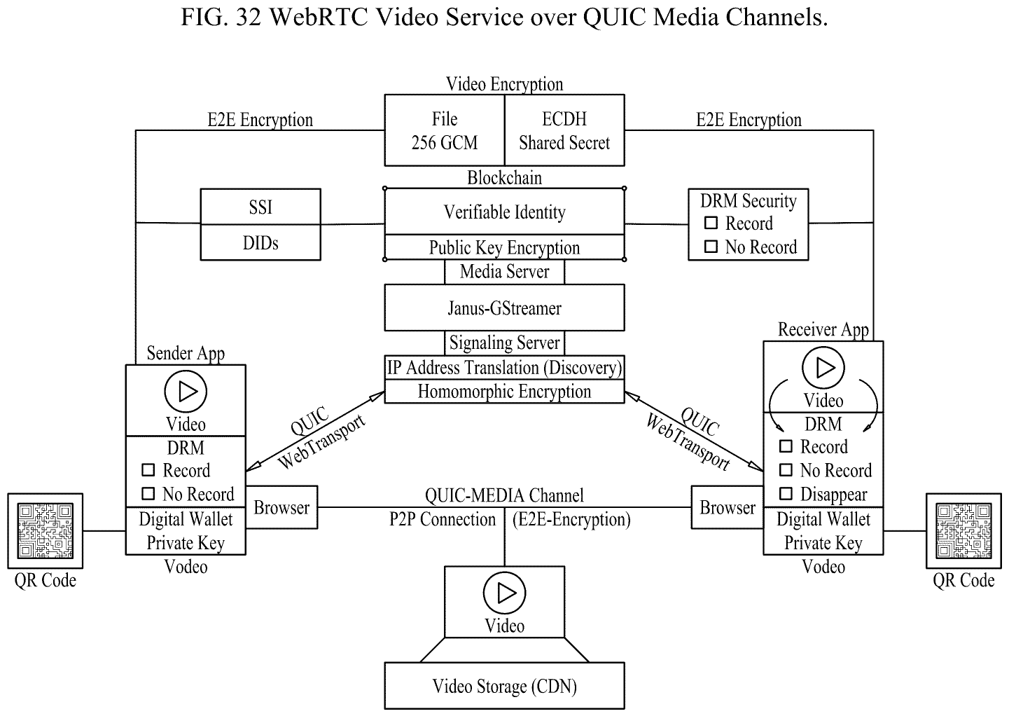

### FIG. 32

FIG. 32 summarizes the WebRTC video streaming over QUIC media channel.

### WebRTC—Media Channel Over QUIC for Advanced Video Streaming Services

There are several open source WebRTC media servers that provide enhanced video features including latency, connection time video format conversion, video conferencing and video playback and editing.

After careful review, analysis, and media server prototyping, Janus-WebRTC coupled with GStreamer was selected as the enhanced WebRTC media server to support the WebRTC media channel transport over QUIC for video streaming.

FIG. 32 shows WebRTC Video Service over QUIC Media Channels using the following modules: Video Encryption, 256 GCM, ECDH Shared Private, Blockchain Verifiable Identity, Public Key Encryption, Media server, Janus-GStreamer, Signaling Server, IP Address Translation (Discovery), Homomorphic Encryption, QUIC-MEDIA Channel, P2P Connection (E2E-Encryption), Video, Video Storage (CDN), E2E Encryption, SSI, DIDs, Sender App, Video, QUIC WebTransport, DRM, Record, No Record, Digital Wallet, Private Key, QR Code, Vodeo, DRM Security, Record/No Record, Receiver App, Video Record/No Record, Disappear, and a Digital Wallet Private Key.

FIG. 32 also shows a Janus-WebRTC Media Server.

The Janus WebRTC Server has been developed as a general-purpose server. As such, it doesn't provide any functionality per se other than implementing the means to set up a WebRTC media communication with a browser, exchanging JSON messages with it, and relaying RTP/RTCP and messages between browsers and the application logic they're attached to. Any specific feature/application needs to be implemented in server-side plugins, that browsers can then contact via the Janus core to take advantage of the functionality they provide. Examples of such plugins can be implementations of applications like echo tests, conference bridges, media recorders, SIP gateways and enhanced video streaming.

Janus was designed with a case handling the high-level communication with users (sessions, management, WebRTC protocols) and plugins to provide specific functionality that is transparent to WebRTC and independent from the application.

An overview of the architecture and related interactions is depicted in Figures. The core is mostly responsible for three things:
Managing application sessions with users through a REST-ful API;
Implementing the WebRTC communication with the same users, by taking care of the whole WebRTC lifecycle (negotiation, establishment, and management of PeerConnections);
Attaching users to plugins, in order to allow them to exchange messages (based on a per-plugin ad-hoc protocol) and more importantly media (relaying plain RTP/RTCP). This allows plugins to easily communicate with WebRTC users, as most hassles associated with the WebRTC stack are masked by the gateway core. Janus plugins just need to implement the related plugin API to set up a specific session with users that want to take advantage of their features and get prepared to receive and/or send RTP packets and related RTCP messages, in case of need.

Additional functionality and features include:
The core only implements the WebRTC stack

Jsep/SDP, ICE, DTLS-SRTP, Data channels
Plug-ins expose Janus APO over different “Transports”

HTTP/Web Sockets/RabbitMQ/UnixSockets/MQTT
Application Logic implemented in Plug-ins

Plugins route/manipulate the media/data
Plugins can be combined on the client side for video streaming

Video SFU, Audio MCU, SiP Gaterwaying, broadcasting, remote IP surveillance cameras

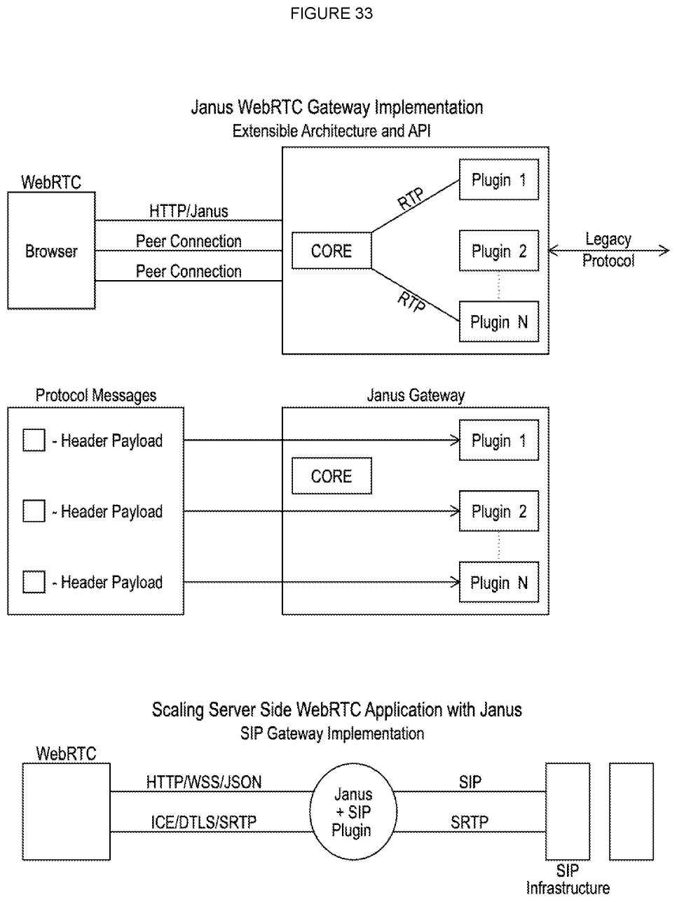

### FIG. 33

FIG. 33 is a diagram illustrating Janus WebRTC Gateway Implementation Extensible Architecture and API. FIG. 33 shows WebRTC using a browser and HTTP/Janus with peer connections to connect to the Core. Protocol messages can be sent to the Janus Gateway Core, which may also connect via legacy protocols such as SIP to an SIP infrastructure.

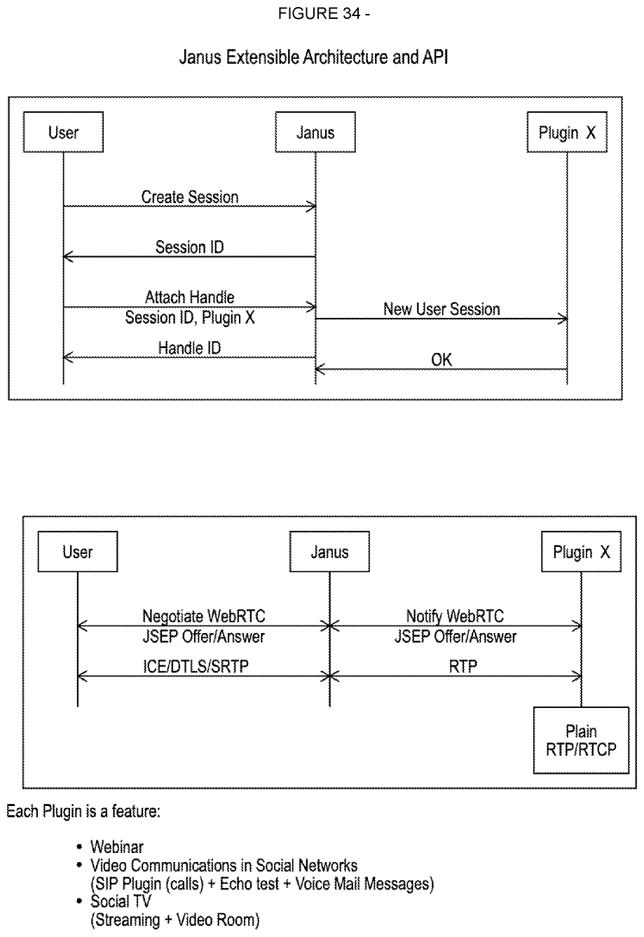

### FIG. 34

FIG. 34 illustrates Janus Extensible Architecture and API. FIG. 34 shows how are users can interact with a Janus server to provision a user connection session.

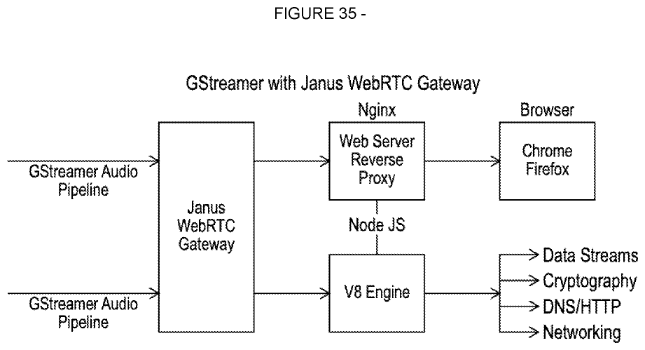

### FIG. 35

FIG. 35 illustrates GStreamer and WebRTC Media Channel over QUIC.

GStreamer is a pipeline-based multimedia framework that links together a wide variety of media processing systems to complete complex workflows. GStreamer is used to build a system that reads files in one format, processes them, and exports them in another. The formats and processes can be changed in a plug and play fashion.

GStreamer supports a wide variety of media-handling components, including simple audio playback, audio and video playback, recording, streaming and editing. The pipeline design serves as a base to create many types of multimedia applications such as video editors, transcoders, streaming media broadcasters and media players. GStreamer provides a flexible way to implement any application that needs to play, record, or transform media-like data across a diverse scale of devices and products, including embedded IoT devices, desktop (video/music players), video recording, video conferencing, VoIP clients, WebRTC browsers servers (encode/transcode farms). GStreamer is free and open-source software. It was designed to work on a variety of operating systems, e.g., Linux kernel-based operating systems, and supports Android, macOS, iOS, and Windows.

GStreamer WebRTC is a flexible solution to web-based media. The GStreamer's WebRTC implementation eliminates some of the shortcomings of using WebRTC in native apps, server applications, and IoT devices. One key application is to convert various audio (including WAV, MP3, and or Media audio) and video formats (including MPEG, MOV & AUI) to be compatible with WebRTC specified video codecs (V8/V9) and audio codecs (iSAC and iLBC) for VoIP. GStream can be integrated with Raspberry Pi 4 and Ubuntu servers and many IoT device formats.

### 2) Janus WebRTC Plugins for QUIC Media Channel

Janus plugins are used as “bricks” to compose a specific value-added application

Streaming—video room for social TV

Webinar—video room+audio bridge+text room

Here is a summary of Janus WebRTC Plugins:

Video Call Plugin

This is a simple video call plugin for Janus, allowing two WebRTC peers to call each other through the Janus core. The idea is to provide a similar service as the well known AppRTC demo (https://apprtc.appspot.com (https://apprtc.appspot.com)), but with the media flowing through a server rather than being peer-to-peer.

The plugin provides a simple fake registration mechanism. A peer attached to the plugin needs to specify a username, which acts as a “phone number”: if the username is free, it is associated with the peer, which means he/she can be “called” using that username by another peer. Peers can either “call” another peer, by specifying their username, or wait for a call. The approach used by this plugin is similar to the one employed by the echo test one: all frames (RTP/RTCP) coming from one peer are relayed to the other

### Streaming Plugin (Video Streaming)

This is a streaming plugin for Janus, allowing WebRTC peers to watch/listen to pre-recorded files or media generated by another tool. Specifically, the plugin currently supports three different types of streams:
On-demand streaming of pre-recorded media files (different streaming context for each peer);
Live streaming of pre-recorded media files (shared streaming context for all peers attached to the stream);
Live streaming of media generated by another tool (shared streaming context for all peers attached to the stream).

### SIP Plugin

This is a simple SIP plugin for Janus, allowing WebRTC peers to register at a SIP server (e.g., Asterisk) and call SIP user agents through a Janus instance. Specifically, when attaching to the plugin peers are requested to provide their SIP server credentials, i.e., the address of the SIP server and their username/private. This results in the plugin registered at the SIP server and acting as a SIP client on behalf of the web peer. Most of the SIP states and lifetime are masked by the plugin, and only the relevant events (e.g., INVITEs and BYEs) and functionality (call, hangup) are made available to the web peer: peers can call extensions at the SIP server or wait for incoming INVITEs, and during a call they can send DTMF tones. Calls can do plain RTP or SDES-SRTP.

The concept behind this plugin is to allow different web pages associated to the same peer, and hence the same SIP user, to attach to the plugin at the same time and yet just do a SIP REGISTER once. The same should apply for calls: while an incoming call would be notified to all the web UIs associated to the peer, only one would be able to pick up and answer, in pretty much the same way as SIP forking works but without the need to fork in the same place.

### AudioBridge Plugin

This is a plugin implementing an audio conference bridge for Janus, specifically mixing Opus streams. This means that it replies by providing in the SDP only support for Opus and disabling video. Opus encoding and decoding is implemented using libopus. The plugin provides an API to allow peers to join and leave conference rooms. Peers can then mute/unmute themselves by sending specific messages to the plugin: any way a peer mutes/unmutes, an event is triggered to the other participants, so that it can be rendered in the UI accordingly.

### VideoRoom Plugin

This is a plug in implementing a videoconferencing SFU (Selective Forwarding Unit) for Janus, that is an audio/video router. This means that the plugin implements a virtual conferencing room peers can join and leave at any time. This room is based on a Publish/Subscribe pattern. Each peer can publish his/her own live audio/video feeds: this feed becomes an available stream in the room the other participants can attach to. This means that this plugin allows the realization of several different scenarios, ranging from a simple webinar (one speaker, several watchers) to a fully meshed video conference (each peer sending and receiving to and from all the others).

Considering that this plugin allows for several different WebRTC PeerConnections to be on at the same time for the same peer (specifically, each peer potentially has 1 PeerConnection on for publishing and N on for subscriptions from other peers), each peer may need to attach several times to the same plugin for every stream: this means that each peer needs to have at least one handle active for managing its relation with the plugin (joining a room, leaving a room, muting/unmuting, publishing, receiving events), and needs to open a new one each time he/she wants to subscribe to a feed from another publisher participant. The handle used for a subscription, however, would be logically a “slave” to the master one used for managing the room: this means that it cannot be used, for instance, to unmute in the room, as its only purpose would be to provide a context in which creating the only PeerConnection for the subscription to an active publisher participant.

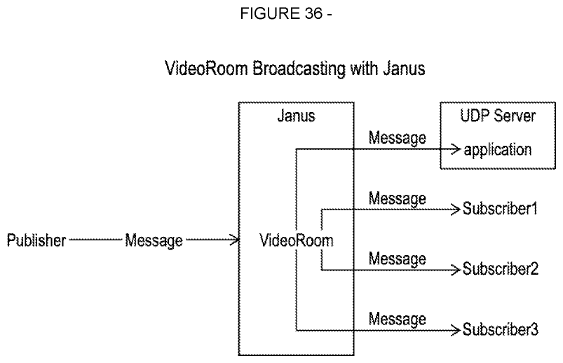

### FIG. 36

FIG. 36 shows QUIC-Media Channel Broadcasting with Janus.

### WebRTC-Data Channel Over QUIC for Real-Time Data Analytics and Content Messaging

WebRTC QUIC-based Data Channels represent a new and novel alternative to the current SCTP-based transport. The implementation of QUIC in WebRTC browsers enables the development of a fully featured messaging and content transfer capability on WebRTC which includes messages, Word docs, PDF, photos, and images.

For WebRTC, the QUIC protocol provides a vastly improved alternative to SCTP as a transport for Data Channel. The current implementation is trying to avoid using the RTC Peer Connection API (and SDP), using a standalone version of ICE transport. This represents a virtual connection that adds security to NAT traversal.

### WebRTC-QUIC

There are two places where QUIC fits in WebRTC:
In the signaling, which is out of scope of WebRTC, but interesting, as it enables faster connection of the initial call
In the data channel, by replacing SCTP with QUIC wholesale

A powerful low level data transport API can enable applications (like real time communications) to provide faster video and data communications with significantly lower latency. You can build on top of the API, creating your own solutions, pushing the limits of what can be done with WebRTC peer to peer connections, including a messaging service that provides text messages, word and PDF documents, photos, and real-time date analytics.

The QUIC protocol is desirable for real time communications. It is built on top of UDP, has built in encryption, congestion control and is multiplexed without head of line blocking.

This is about providing significant performance enhancements for real time communications on top of UDP and the ability to add low level APIs. Today, for voice and video, WebRTC uses SRTP in the media and data channels.

QUIC is about having a single, modern, common transport protocol for the web. Here's what we do today with WebRTC in terms of transport protocols:
HTTPS, HTTP/2 or WebSocket for signaling, which runs over TCP/TLS
SRTP for media, which runs over UDP
SCTP for data channels

Here's what WebRTC will look like with WUIC Protocol:
QUIC is being implemented on HTTP/3, so it can be used for WebRTC signaling and moving forward (replacing both WebSocket and HTTP/2)
QUIC is looked as an SRTP replacement, which means sending real time audio and video can take place on top of it with improved performance and significantly lower latency, in the range of 0-100 ms.

QUIC can replace SCTP for the data channels (that was the obvious use of QUIC in WebRTC to begin with) since the current implementation of the WebRTC data channel limits message and data transport sizes to 16 KB maximum which is used primarily to exchange JSON messages and text messages.

With QUIC, WebRTC can multiplex signaling, voice, video, and low latency data in a single QUIC connection. The QUIC protocol is desirable for real time communications. It is built on top of UDP, has built in encryption, congestion control and is multiplexed without head of line blocking.”

With QUIC, users can now tunnel or proxy all that WebRTC traffic with a lot less logic, boxes and code in our servers

For smaller deployments, WebRTC might not even need multiple servers—just the one that handles it all

It makes developing web servers that handle media and data channels simpler, as they need to support only one transport—QUIC, instead of having to implement multiple transports.

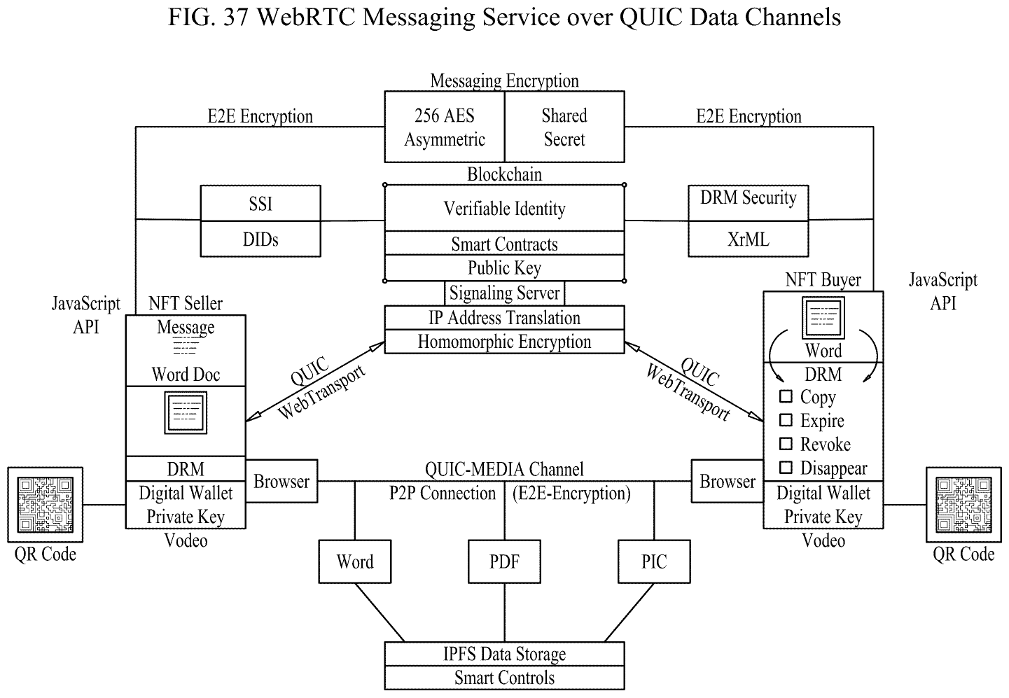

### FIG. 37

FIG. 37 illustrates the WebRTC Messaging Service over QUIC Data Channels including document messaging (ward, PDF, PICS) and smart contract and/or Ricardian contracts.

FIG. 37 shows the systems and methods use modules to achieve WebRTC Messaging Service over QUIC Data Channels, including: Messaging Encryption, 256 AES Asymmetric, Shared Private, Blockchain, Verifiable Identity, Smart contract and/or Ricardian contracts, Public Key, Signaling Server, IP Address Translation, Homomorphic Encryption, E2E Encryption, SSI, DIDs, JavaScript API, NFT Seller, Message Word Doc, QUIC Web Transport, DRM, Digital Wallet Private Key, and QR Code.

The QUIC—Data Channel includes P2P Connection (E2E Encryption), Word PDF PIC, IPFS Data Storage, Smart contract and/or Ricardian contracts, E2E Encryption, DRM Security, X-ML, and an NFT Buyer module.

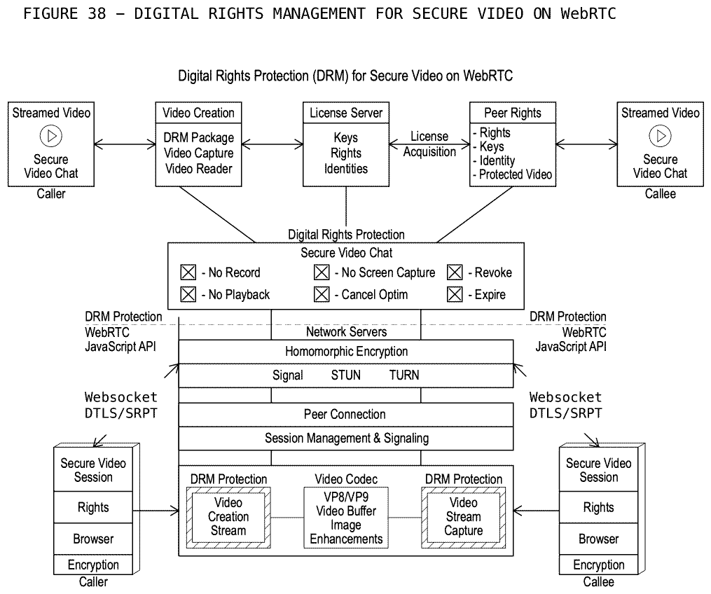

### FIG. 38

FIG. 38 is a flowchart illustrating a non-limiting preferred embodiment of the Digital Rights Protection (DRM) for Secure Video on WebRTC. FIG. 38 shows Digital Rights Protection (DRM) for Secure Video on WebRTC comprising Streamed Video such as Secure Video Chat from a Caller to a Callee, going through steps of Video Creation, License Server, Peer Rights to offer Streamed Video. Video Creation comprises DRM Package Video Capture and Video Render. Licensing the Server comprises exchange of Keys, Rights, Identities, and License Acquisition. Processing the Peer Rights includes implementing the Rights, checking the Keys, verifying the Identity, to provide Protected Video.

FIG. 38 shows Digital Rights Protection for Secure Video Chat having selections of No Record, No Playback, No Screen capture, Cancel Option, Revoke, and Expire. The WebRTC JavaScript API domain provides the Network Servers, the Homomorphic Encryption, the Signaling e.g., STUN, TURN, the Peer Connection, and the Session Management & Signaling.

FIG. 38 shows the Caller and Callee using WebSocket and DTLS/SRPT to communicate between the App and the Platform(s). The App then provides the Secure Video Session along with the Rights, using a browser, and Encryption.

Within the processing, the App and Platform cooperate to provide DRM Protection of the Video Creation Stream, provide Video Codec such as VP8/VP9, Video Buffer, Image Enhancements, and DRM Protection of the Video Stream Capture.

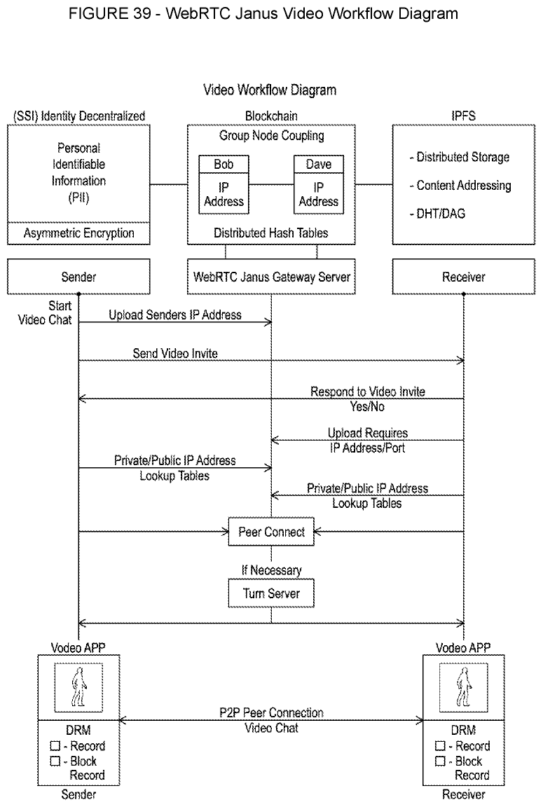

### FIG. 39

FIG. 39 is a diagram illustrating WebRTC Videochat Flow Diagram with QUIC DRM Protection. FIG. 39 shows an SSI identity decentralized module holds the personal identifiable information and uses a symmetric encryption to connect a sender to a receiver. A Blockchain module uses group node coupling to identify the IP address of the sender and receiver in distributed hash tables. The Blockchain module is also in communication with an IPFS module for distributed storage, content, addressing, and DHT/DAG. A web RTC, Janice gateway server, then provisions, the connection between the sender and the receiver by uploading the sender's IP address and sending a video invite. The receiver can then respond to the video invite yes or no and if yes, upload the required IP address/port. The sender and receiver then upload the private/public IP address and look up tables and a peer-to-peer connection would be established. They turn the server and may be used in this process if necessary.

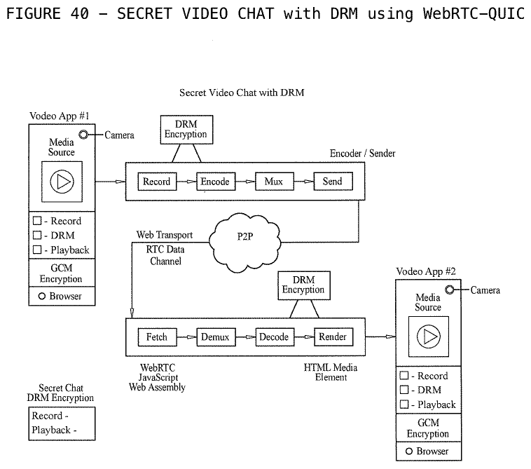

### FIG. 40

FIG. 40 is a diagram illustrating a Private Video Chat with DRM using WebRTC-QUIC. FIG. 40 shows how a video application on a sender's user device/smart device can obtain media source using its native camera and have DRM restrictions selected from a menu, such as record, playback, or other DRM restrictions. I use her device that may include GCM encryption and may be available through a browser extension. The sender's user device, then uploads to a DRM platform using encrypted communication. A P2P connection is made between a sending user's device and a receiving users device using web transport RTC data channel.

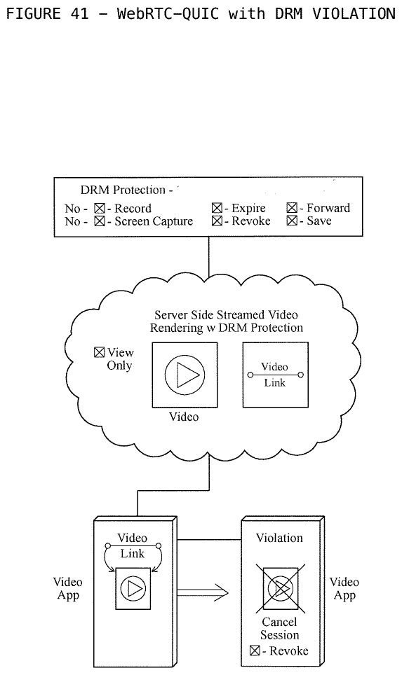

### FIG. 41

FIG. 41 is a diagram illustrating WebRTC-QUIC with DRM-Violation. FIG. 41 shows how a DRM protection menu at a user's device can select from the DRM options of record, screen, capture, expire, revoke, forward, and save. When are use your device is in communication with a DRM platform, a server-side streamed video rendering with DRM protection is created and a link is also created. The video link is all that is shared with a receiver's user device. That's when the receiver of the video plays the video, they are linking to the video link in the DRM platform. When a DRM violation is detected, the link to the video in the platform is disabled for the receivers, smart device.

### VIII Screen Capture Disablement of Private NFT Images (Pictures, Photos) Using Pixel Interlacing and DRM

This section describes a method and system to implement screen capture disablement of pictures using all of the following methods to give users (senders) the option to disable the recipients (Receivers) ability to execute a screenshot of the original picture and to save the picture (and any other attached content such as word, PDFs etc. on the receiver's smartphone:

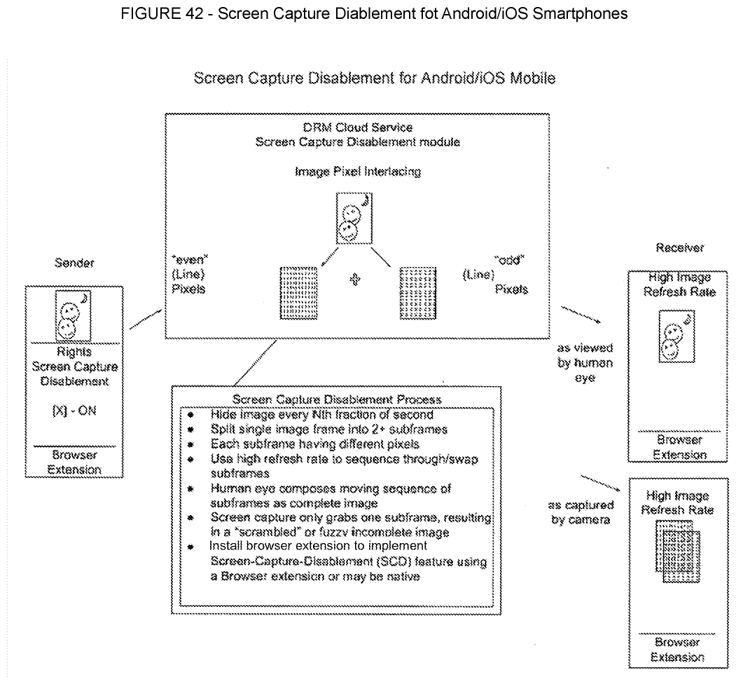

### FIG. 42

FIG. 42 is a diagram illustrating screen capture disablement for android/iOS mobile devices. A DRM platform, service screen capture, disablement module provides image, pixel, interlacing. When a sender, smart device chooses the screen capture disablement feature and sends an image through the DRM platform service to a receiver the image is split into horizontal and vertical pixels, e.g., even lines and odd lines. The screen capture disablement process hides the image every nth fraction of a second, splits the single image frame into 2+ subframes, where each sub frame, having different pixels, use higher refresh rate to sequence through/swap sub frames. The human eye composes the moving sequence of subframes as a complete image. However, screen capture only grabs one sub frame resulting in a scrambled or fuzzy incomplete image. When a browser extension is installed to implement this screen capture disablement feature, or it may be native.

This section disables Image Pixel Splitting Technology which is used to split the pixels which constitute an image into even pixels and odd pixels using NumPy (Numerical Python).

NumPy is an open-source Python library that contains multidimensional array and matrix structures that provides ndarray, a homogeneous n-dimensional array object, with an assortment of routines for fast operations on arrays, including mathematical, logical, shape manipulation, sorting and selecting.

At the core of the NumPy package, is the ndarray object. This encapsulates n-dimensional arrays of homogeneous data types, with many operations being performed in compiled code for performance. There are several important differences between NumPy arrays and the standard Python sequences:

NumPy arrays have a fixed size at creation, unlike Python lists (which can grow dynamically). Changing the size of a ndarray will create a new array and delete the original.

The elements in a NumPy array are all required to be of the same data type, and thus will be the same size in memory. The exception: one can have arrays of (Python, including NumPy) objects, thereby allowing for arrays of different sized elements.

NumPy arrays facilitate advanced mathematical and other types of operations on large numbers of data. Typically, such operations are executed more efficiently and with less code than is possible using Python's built-in sequences.

Splitting a 2D NumPy Image Array into Tiles or Pixels

A 2D image represented as a NumPy array will have shape (m,n), where m would indicate the image height in pixels, while n would indicate the image width in pixels. As an example, let's take a 6 by 4, 8-bit grayscale image array and aim to divide it in 2 by 2 tiles by creating a new memory viewing using strides. The elements must be of equal length, hence, both array dimensions must be divisible by 2.

The image can then be thought of as being organized in 6 rows of elements of 4. The visualization of our example would look something like the following:

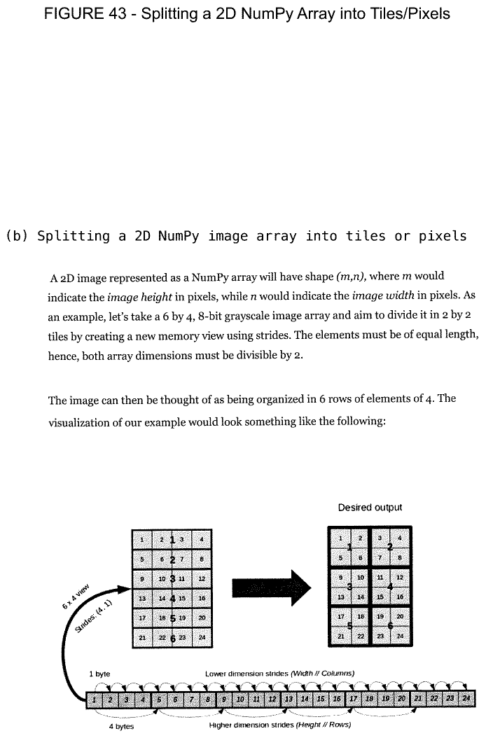

### FIG. 43

FIG. 43 is a diagram illustrating image splitting. Let's take it one step at a time. Seeing that we need 6 tiles all together, organized in 3 rows and 2 columns, let's first try to split our current rows in 2 columns. Our current shape is (6,4), thus, we need to halve the last dimension and add a higher dimension of 2, representing the columns that we want to form. Our target 3-dimensional shape for this step, then, is (2,6,2): 2 columns by 6 rows by 2 array elements in each row. Now that we know the shape we need. We can go ahead to figure out the strides.

Let's observe the image below. The strides for our 2D image were (4,1). Stride 1 of the lowest dimension must remain intact, as messing with it would make us lose the spatial relationship at the pixel level (e.g., increasing it would mean skipping pixels). Stride 4 of the rows dimension will also stay constant, since the number of desired rows remain 6. If you changed any of those two strides, you would end up distorting the image. Then, all we need to do is figure out the stride for our highest dimension of size 2, which represents the new higher-level columns we are defining. Bearing in mind that we split our original 4 per row elements in half so they can be included in separate columns, gives us a hint.

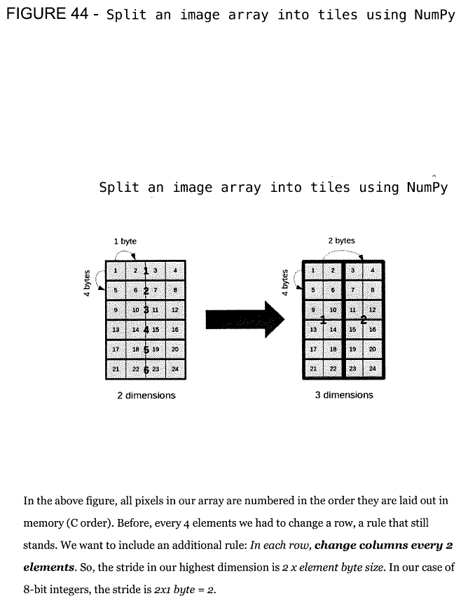

### FIG. 44

FIG. 44 Split an image array into tiles using NumPy: 1 byte, 2 bytes, 4 bytes and so forth. The split can also be 2 dimensions or 3 dimensions.

In FIG. 44, all pixels in our array are numbered in the order they are laid out in memory (C order). Before, every 4 elements we had to change a row, a rule that still stands. We want to include an additional rule: In each row, change columns every 2 elements. So, the stride in our highest dimension is 2×element byte size. In our case of 8-bit integers, the stride is 2×1 byte=2.

### Applying NumPy to Image Pixel Splitting

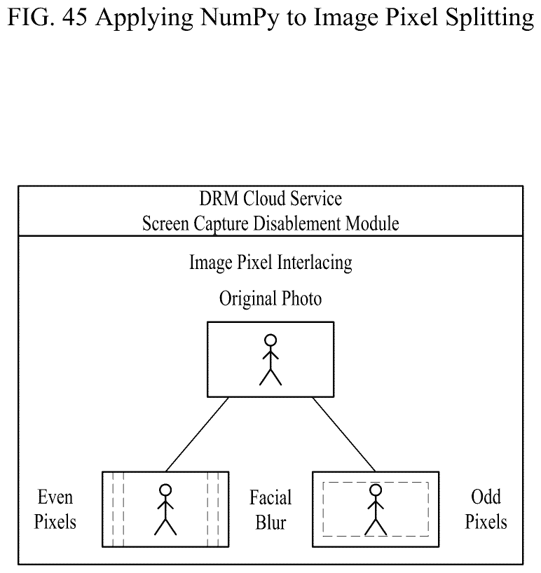

FIG. 45 illustrates the application of image pixel splitting and interlacing to transform the original picture (photo-JPEG) into (1) a picture containing only even numbered pixels and (2) a picture containing only even numbered pixels (2) a second picture containing only odd numbered pixels to facilitate screen capture disablement of the original picture.

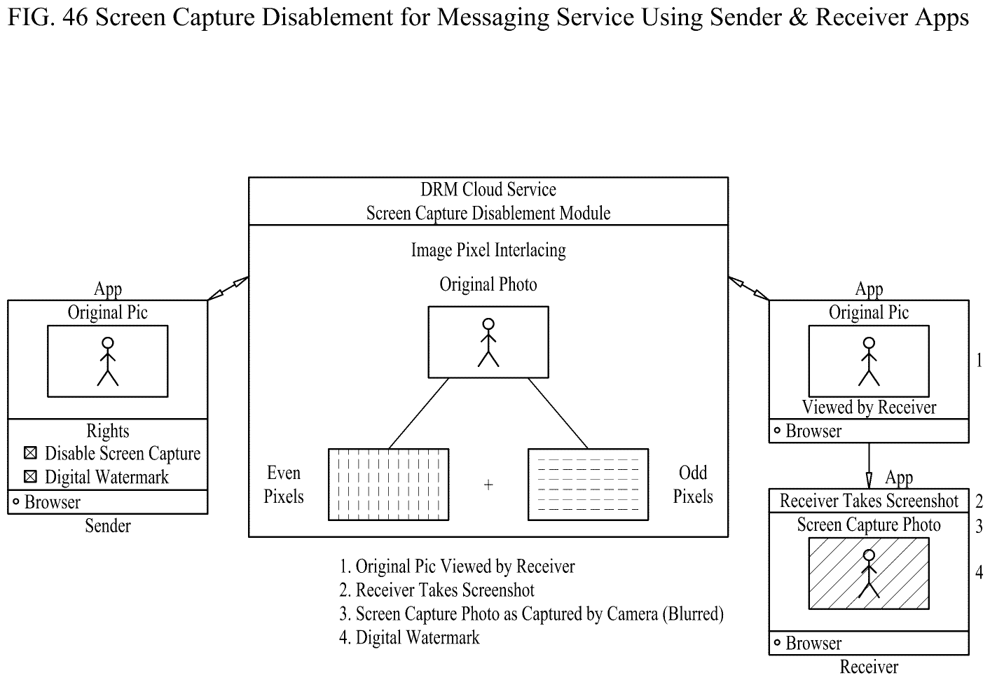

### FIG. 46

FIG. 46 is a diagram illustrating a summary of Screen Capture Disablement for Messaging Service using sender and receiver Apps. FIG. 46 shows a DRM platform service module, having a screen capture, disablement module, image, pixel, interlacing for splitting the image into even and odd line pixels. An application at the sender's smart device that contains an original picture. May have the rights applied to provide a screen capture, disablement and digital water marking. The browser extension in the application may facilitate ease of use. A media application on the receiver's smart device can receive the original picture from the DRM platform service. However, if the receiver attempts to take a screenshot, the photo will be blurred and a digital watermark will be presented, and the image viewed on the receiver's device.

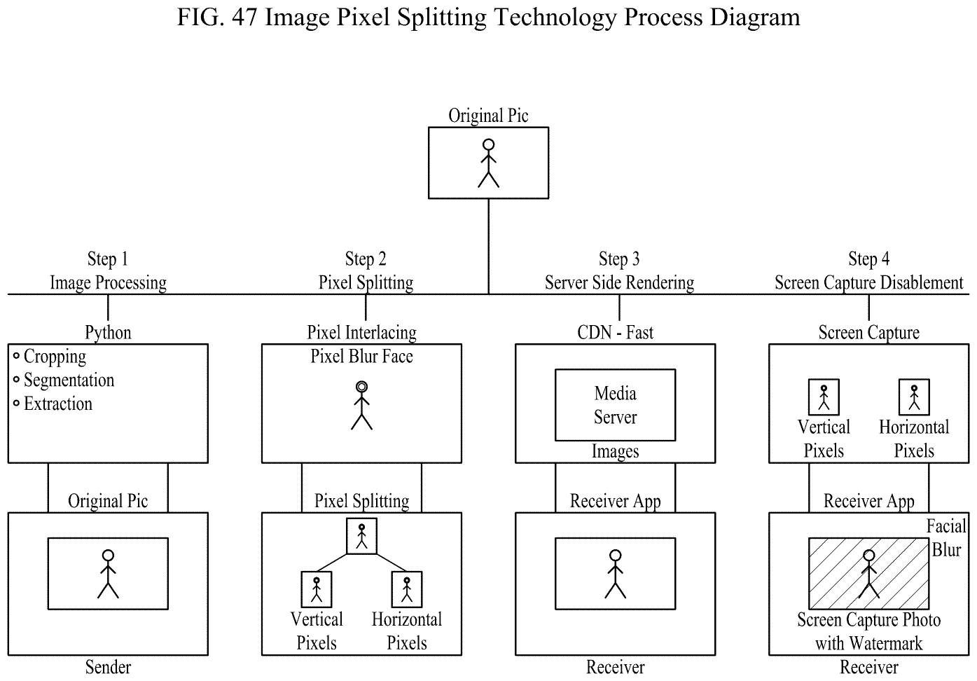

### FIG. 47

FIG. 47 is a diagram illustrating Image Pixel Splitting Technology Process Diagram. FIG. 47 shows a fourth step process, applied to an original picture. The first step is image processing and uses a python component for cropping, segmentation, and extraction. The original picture may also have screen capture, disablement, and watermarking functions added by the sender. And step two the image is subjected to pixel, splitting by pixel interlacing to provide a pixel face blur. The pixel splitting splits the image into horizontal pixels and vertical pixels. In step three, server, side, rendering, a CDN fast server provides media server functions for the images and is in communication with the application on the smart phone of the receiver. In step four, screen, capture, disablement, if the receiver attempts to capture the screen, the image is split between the horizontal pixels and the vertical pixels resulting in a blurred image that is captured along with a watermark at the receiver's device.

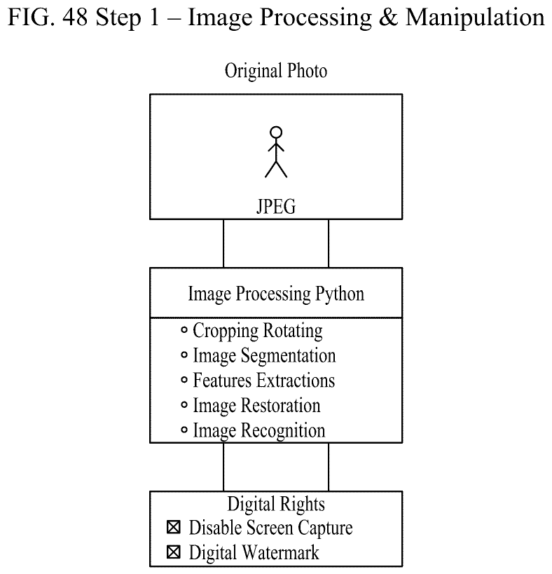

### FIG. 48

FIG. 48 is a diagram illustrating Step 1—Image Processing & Manipulation. FIG. 48 shows an original picture in a JPEG format being processed using an image processing component in python for cropping rotating, image, segmentation, features, extractions, image, restoration, and image recognition. A digital rights module can also toggle on or off the disable screen-capture function, and the digital watermark function.

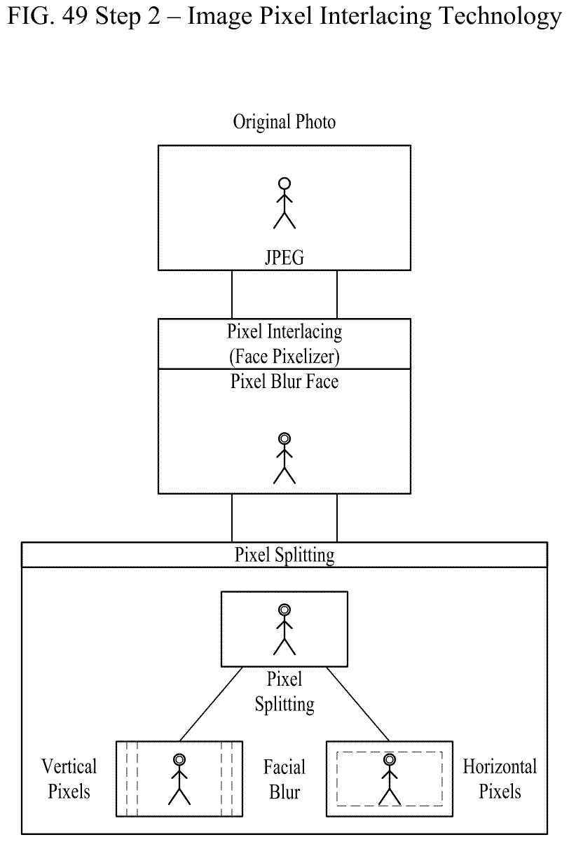

### FIG. 49

FIG. 49 is a diagram illustrating Step 2—Image Pixel Interlacing Technology. FIG. 49 shows the original picture that is modified with pixel interfacing and or a face pics Elizer to provide blurring of the face area. Using pixel splitting to split pixels from the original picture into vertical pixels and horizontal pixels.

### Step 3—File Rendering—Fast Refresh Frame Rates

The fast refresh frame rate for an image (picture) display on the Receivers Poof App using server-side rendering refers to how many times per second the media server is able to refresh or draw a new, updated version of the image. This is measured in Hertz (H3).

For example, if the server has a refresh rate of 144 Hz, it is refreshing the image 144 times per second. A higher refresh rate refers to the frequency that the smartphone display updates the on-screen image. The time between these uptakes is measured in milliseconds (ms), which the refresh rate of the display is measured in Hz.

On the Receivers Poof App, the high image refresh rate allows the receiver to view the original picture without any pixel blurring of the face or other parts of the picture. To the Receiver, the picture is the same as the picture sent by the Sender.

The following figures show the implementation of file image rendering using fast frame refresh media server

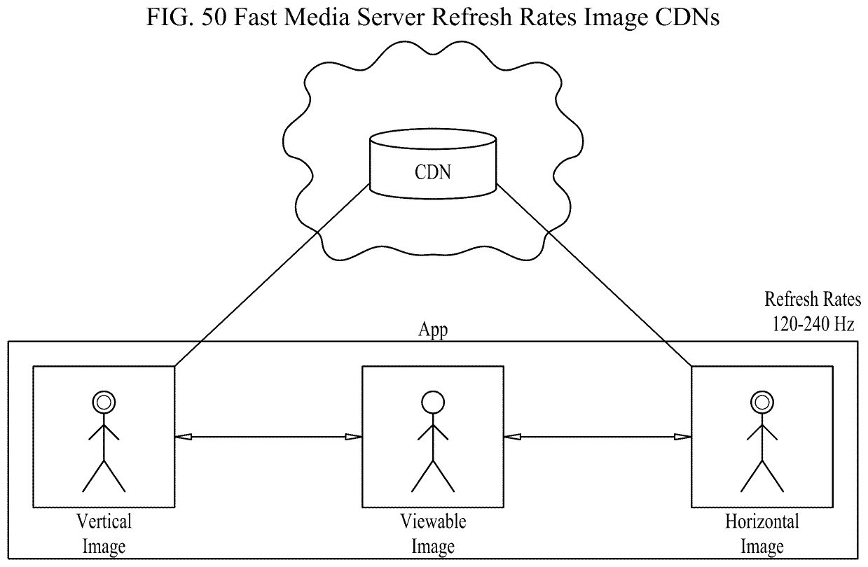

### FIG. 50

FIG. 50 is a diagram illustrating Fast Media Server Refresh Rates Image CDN's. FIG. 50 shows a CDN platform that is in communication with an application located on a smart device.

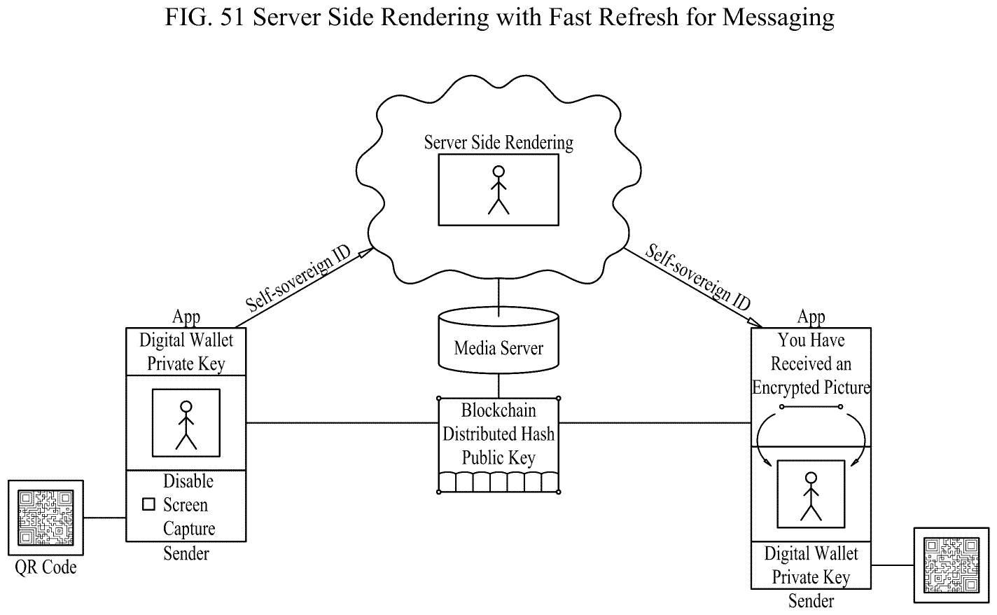

### FIG. 51

FIG. 51 is a diagram illustrating Rendering with Fast Refresh for Messaging. FIG. 51 shows the rendering platform, communication with an application found on each user, smart device. Self-sovereign ID is used to authenticate communications between the smart device and the platform. The application on the smart device includes a digital wallet with a private key and a menu for disabling screen capture and using a QR code. The file rendering platform is in communication with a media server that is in further communication with a Blockchain distributed hash module having a public key. In a preferred embodiment media server refresh frame rates from 120 to 240 Hz to implement the screen capture disablement are available.

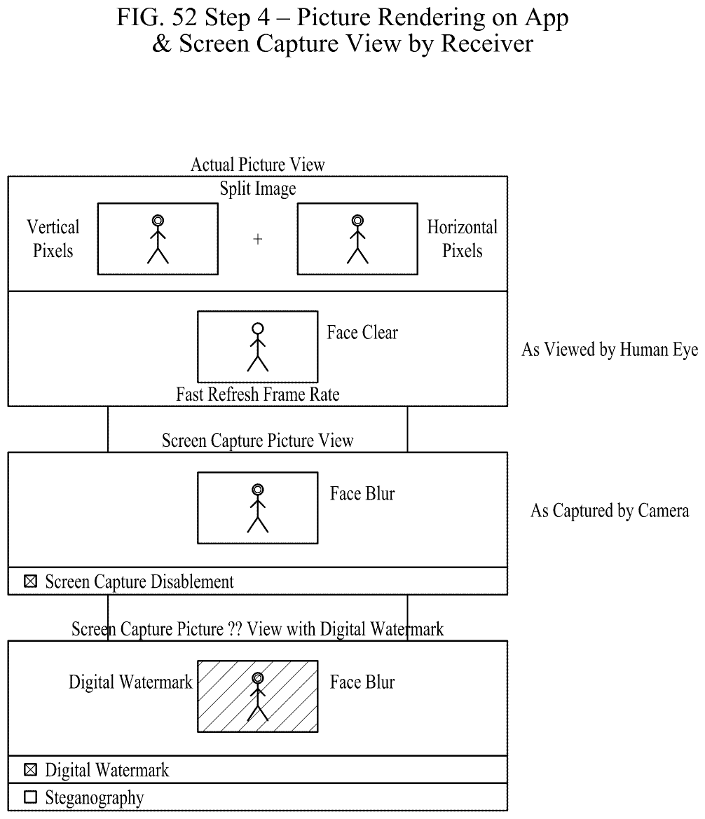

### FIG. 52

FIG. 52 is a diagram illustrating Step 4—Picture Rendering on Poof App and Screen Capture View by Receiver. FIG. 52 shows an actual picture of you at top with a split image, having vertical pixels separated from horizontal pixels. When viewed by the human eye at a fast, refreshing frame rate, the vertical and horizontal pixels are seen as a clear image. When screen capture disablement is enabled, an image captured by a camera is blurred. Additionally, when a screen capture picture is attempted, a digital watermark will also blur the image when the digital watermark selection is chosen.

### IX. Scalable Cross-Chain Interoperability

Cross-chain communications refer to the transferring of information between one or more blockchains. Cross chain communications are motivated by two requirements common in distributed systems: accessing data and accessing functionality which is available in other Blockchain or decentralized storage systems. Cross-chain communication provides a single-messaging interface for all cross-chain communication. It enables easy integration into any smart contract and/or Ricardian contract application with only a few lines of code, ensuring developers don't waste effort in writing custom code to integrate separately with each chain.

Cross-Chain Communications Protocol is an open-sourced standard for developers to easily build secure cross-chain services and applications. With a universal messaging interface, smart contract and/or Ricardian contracts can communicate across multiple blockchain networks, eliminating the need for developers to write custom code for building chain-specific integrations. It opens a new category of DeFi applications that can be built by developers for multi-chain ecosystems.

Off-Chain Consensus—Efficient off-chain consensus that provides enhanced off-chain computation protocol that reduces gas costs for users by efficiently aggregating oracle attestations from hundreds of off-chain nodes, securely validating cross-chain transactions in a tamper-proof way.

Universal interface- to build cross-chain apps using standardized interface for smart contract and/or Ricardian contracts to send messages to any blockchain network. With a single method call, developers can communicate across any chain linked blockchain. Data sent across blockchain networks can be encoded and decoded in any manner, providing developers a large degree of flexibility while eliminating the complexity in building chain-specific integrations.

Libp2p Cross-Platform Network—uses libp2p, a flexible cross-platform network framework for peer-to-peer applications. Positioned to be the standard for future decentralized applications, libp2p handles peer discovery and communication in the cross-chain communications system in conjunction with IPFS p2p decentralized storage and WebRTC p2p multimedia communications.

Cross-Chain interoperability—protocols work in conjunction with a smart contract and/or Ricardian contract from the source chain that invokes an HTTP/3 Web Transport Messaging Protocol, which will securely send the message to the destination chain, where another Web Transport Messaging Protocol validates it and sends it to the destination smart contract and/or Ricardian contract.

Programmable and Secure Token Bridge—Decentralized and trust-minimized—powered by an enhanced off-chain reporting protocol, hundreds of independent oracle nodes from node providers will cryptographically sign and validate all cross-chain token transactions, mitigating any single point of failure. Computer-enabled—allows developers to build applications (e.g., SSI digital wallets) that can transfer tokens and initiate programmable actions on the destination chain, allowing development of new types of cross-chain token-based applications. Programmable Token Bridge supports both minting and burning and locking and unlocking of ERC-721 tokens.

Highly Secure with Anti-Fraud Network—Secured through an independent anti-fraud Zero Trust Security Network that proactively monitors the blockchain networks to detect issues (e.g., incorrect, or excessive funds transfer) and take preventive measures when a malicious activity is detected (e.g., halt transfer of funds) in a trust-minimized way. The Zero Trust Security Network monitors the cross-chain network for nefarious cross-chain activity and automatically pauses its services to protect users when malicious activity is detected.

Universal and chain-agnostic—A universal interface that provides the ability to transfer tokens to any integrated blockchain network across EVM and non-EVM chains, eliminating the need for developers to build separate bridges for inter-connectivity between individual chains.

Multi-Chain ecosystem—Providing developers a standardized solution for building cross-chain applications, helping expand the multi-chain ecosystem in a secure manner, thereby dramatically increasing the utility of user tokens and ability to seamlessly transfer tokens between different blockchain environments.

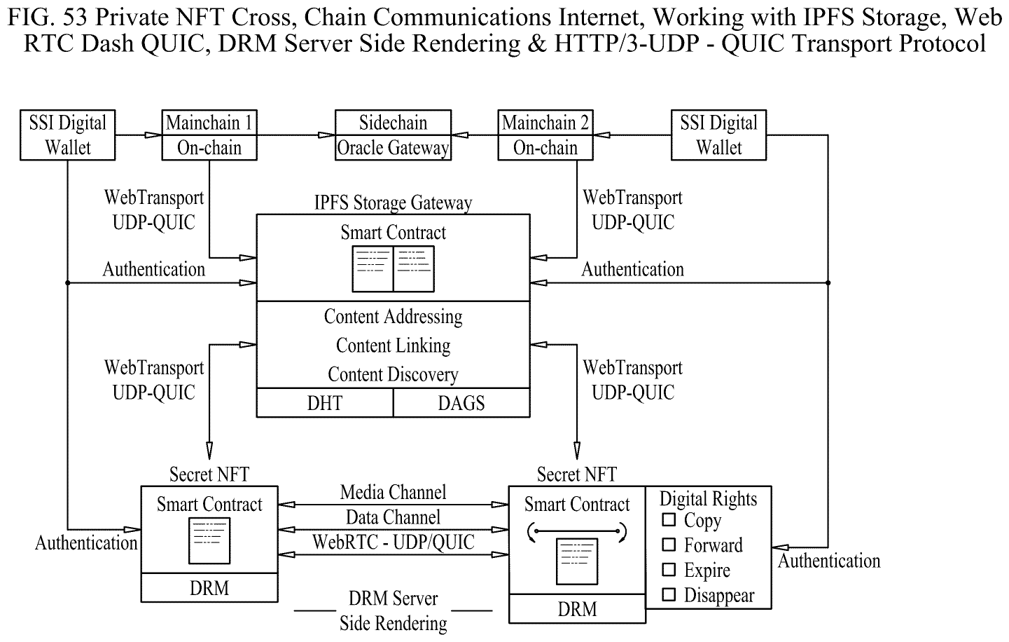

### FIG. 53

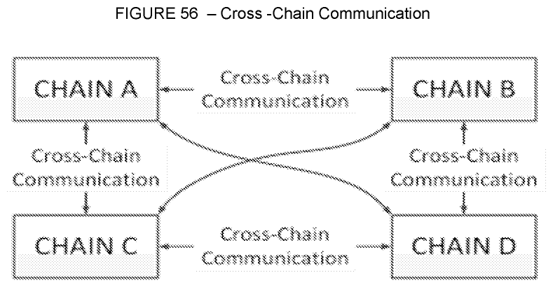

FIG. 53 is a diagram illustrating a private NFT cross, chain communications Internet, working with IPFS storage, web RTC Dash QUIC, DRM server-side rendering, and HTTP/3-UDP-QUIC transport protocol. FIG. 56 shows how a buyer and seller having SSI digital wallets can communicate with an Oracle gateway having an IPFS storage gateway and private NFT modules. The side chain/Oracle gateway is connected to a main chain one on chain and a main chain to unchain. Maintain one and maintain two are in communication with the SSI digital wallets of the users. The main chains use web transport UDP-QUIC to communicate with the IPFS storage gateway module. The IPFS storage gateway module has a smart contract and/or Ricardian contract, content addressing, content linking, and content discovery components. The IPFS storage gateway module. Also includes DHT and DAG. The IPFS storage gateway module is also in communication with the private NFT module of the buyer and the seller using web transport UDP-QUIC, the SSI digital wallet, insure authenticated communications with the IPFS storage gateway module and with the private NFT modules. The private NFT modules are in duplex communication across a media channel, a data channel and use web RTC-UDP/QUIC protocols. The private NFT modules also include a DRM functionality to be in communication with a DRM server for server-side rendering.

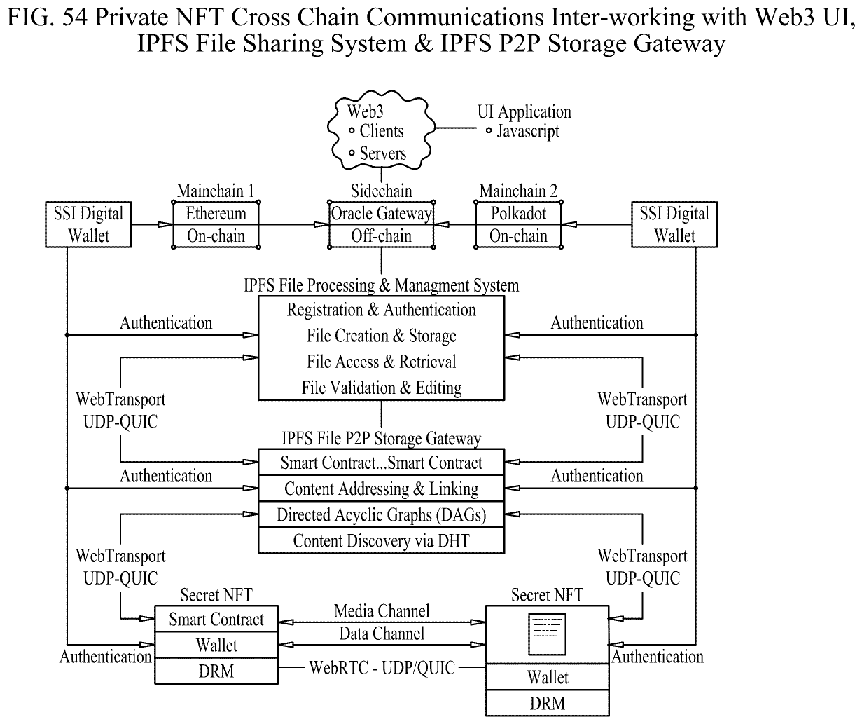

### FIG. 54

FIG. 54 is a diagram illustrating a private NFT cross chain communications inter-working with Web3 UI, I PFS file sharing system, and IPFS P2P storage gateway. FIG. 54 shows a Web3 client and Platform having a UI application in JavaScript. The Web3 platform is connected to a platform having a side chain Oracle gateway with off chain component receiving inputs from a main chain, one having Ethereum unchain and a main chain to having Polkadot on chain. An SSI digital wallet inputs into both main chain one and a separate SSI, digital wallet, inputs in to mention to the oracle gateway module is in communication with an IPFS file processing and management system module. The IPFS file processing and management system. Modules include registration and authentication functions, file, creation, and storage functions, file access and retrieval functions, and file, validation and editing functions. The SSI digital wallets are in communication with the IPFS file processing and management system to authenticate the communications. An IPFSP to P storage gateway module uses web transport UDP Dash QUIC protocols to communicate with the IPFS file processing and management system. The IPFS P2P storage gateway module includes smart contract and/or Ricardian contracts, content, addressing and linking, directed acyclic graphs, (DAG), and Content discovery, via DHT. The SSI digital wallet is also in authenticated communication with the IPFS P2P storage gateway module. A private NFT module, having a smart contract and/or Ricardian contract, a wallet, and DRM functions uses web transport UDP Dash QUIC communications protocol to communicate with the IPFSP to P storage gateway. The buyer private NFT module, and the seller private NFT module are in duplex communication across a media channel, a separate data channel, and use the web RTC Dash UDP/QUIC protocols.

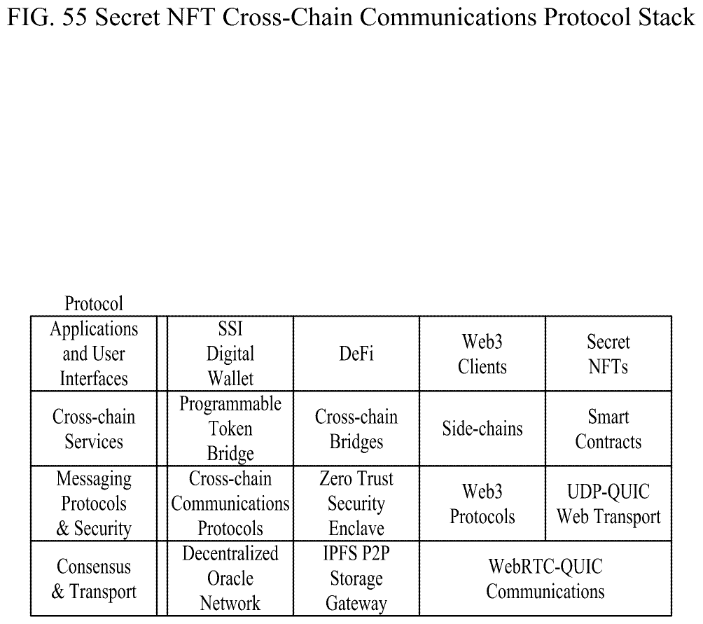

### FIG. 55

FIG. 55 is a diagram illustrating a private NFT cross chain communications protocol stock. FIG. 55 shows in protocol column applications and user interfaces, price, change, services, messaging, protocols and security, and consensus and transport. The applications and user interface are row include SSI, digital wallet, defy, Web3, clients, and private NFT's. The cross-chain services row includes a programmable, token bridge, cross, chain, bridges, side, chains, and smart contract and/or Ricardian contracts. The messaging protocols and security row includes across train, communication, protocols, zero trust security enclave, Web three protocols, and UDP Dash QUIC web transport. The consensus and transport row includes decentralized, Oracle, Network, IPFS, P2P, storage gateway, and web RTC Dash QUIC communications. Communications.

Solving for integration between Blockchain platforms may seem simple. One platform needs only to communicate with another the status of a particular data object and/or pass control. But that apparently simple suggestion reintroduces the need for messaging and data reconciliation—the very thing that blockchain so valuably eliminates. It is possible for leading Blockchain platforms to work together to develop a common standard against which each platform's engineers could design and code compatible components. However, early interest in resolving this problem collaboratively between platform providers have been stymied by two primary challenges:

First, the competitive dynamic of the respective DLT platform providers and their focus on getting to or moving beyond the first versions of their platforms makes their imminent productive collaboration unlikely.

Second, even if that collaboration were to happen, the resulting harmonization could limit further innovation.

### FIG. 56

FIG. 56 shows Cross-Chain Communication. Chain A is connected to and communicates with Chain B, Chain C, and Chain D.

The basis of the invention's Cross Chain Interoperability solution is to establish a trusted “interoperability node” that sits between the target DLT Blockchain systems. This interoperability node is given the appropriate identity and access control capabilities using “Zero Trust Security” cryptography using SSI Identity Management and UDP-QUIC Web Transport protocols.

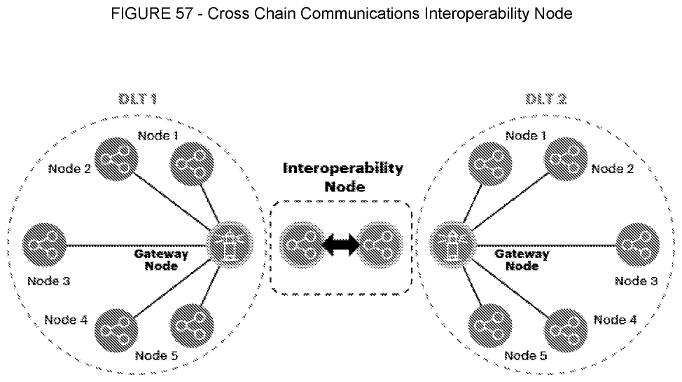

### FIG. 57

FIG. 57 shows Cross-Chain Communication using a Zero Trust Security Interoperability Gateway Nodes to Enable Secure Smart contract and/or Ricardian contract Communications among different Blockchains.

DLT1 has Nodes 1-5 connected to DLT 1 Gateway Node and connected via Interoperability Node to DLT2 that has Nodes 1-5 connected to a DLT2 Gateway Node.

### Scalable Heterogeneous Multi-Chain

Scalable multi-chain means that unlike previous blockchain implementations which have focused on providing a single chain of varying degrees of generality over potential applications, it is designed to provide no inherent Blockchain application functionality at all. Rather, it is designed to provide the bedrock “relay-chain” upon which many validatable, globally coherent dynamic data-structures may be hosted side-by-side and are referred to as “parallelized” chains or parachains, though there is no specific need for them to be blockchain in nature. In other words, a scalable multi-chain may be considered equivalent to a set of independent chains (e.g., the set containing Ethereum, Cardano, Solana, and Bitcoin) except for two very important points: pooled security, and trust-free interchain transactability.

These points are why the multi-chain communications system is considered “scalable”. In principle, however, if many nodes are deployed on the multi-chain, it may be substantially parallelized-scaled out-over many parachains. Since all aspects of each parachain may be conducted in parallel by a different segment of the network, the system has some ability to scale. The multi-chain provides a rather bare-bones piece of infrastructure leaving much of the complexity to be addressed at the middleware level. This was a conscious decision intended to reduce development risk, enabling the requisite software to be developed within a short time span and with a good level of confidence in its security and robustness.

### Libp2p Network

Libp2p is a network framework that allows you to write decentralized peer-to-peer applications. Originally the networking protocol of IPFS, it has since been extracted to become its own first-class project. The project was created with the goal of developing an entirely decentralized stack. Additionally, Libp2p is the base for IPFS and a networking library collection that includes:
QUIC-UDP and Web Transport protocols,
The IPFS and Ethereum blockchains serve as the foundation for the network core

A modular and extendable abstraction layer for several networks means of transport, including UDP, Web Transport, and MQTT protocols.

Transport—At the foundation of libp2p is the transport layer, which is responsible for the actual transmission and receipt of data from one peer to another. There are many ways to send data across networks in use today, with more in development and still more yet to be designed. libp2p provides a simple interface that can be adapted to support existing and future protocols, allowing libp2p applications to operate in many different runtime and networking environments.

Identity—In a world with billions of networked devices, knowing who you're talking to is the key to secure and reliable communication. libp2p uses public key cryptography as the basis of peer identity, which serves two complementary purposes. First, it gives each peer a globally unique “name”, in the form of a PeerId. Second, PeerId allows anyone to retrieve the public key for the identified peer, which enables secure communication between peers.

Security—It's essential that we can send and receive data between peers securely, meaning that we can trust the identity of the peer we're communicating with and that no third-party can read our conversation or alter it in-flight. libp2p supports “upgrading” a connection provided by a transport into a securely encrypted channel. The process is flexible and can support multiple methods of encrypting communication. libp2p currently supports TLS 1.3 and Noise, though not every language implementation of libp2p supports both.

Peer Routing—When you want to send a message to another peer, you need two key pieces of information: their PeerId, and a way to locate them on the network to open a connection. There are many cases where we only have the PeerId for the peer we want to contact, and we need a way to discover their network address. Peer routing is the process of discovering peer addresses by leveraging the knowledge of other peers. In a peer routing system, a peer can either give us the address we need if they have it, or else send our inquiry to another peer who's more likely to have the answer. As we contact more and more peers, we not only increase our chances of finding the peer we're looking for, but we also build a more complete view of the network in our own routing tables, which enables us to answer routing queries from others. The current stable implementation of peer routing in libp2p uses a distributed hash table to iteratively route requests closer to the desired PeerId using the Kademlia routing algorithm.

Content Discovery—In some systems, we care less about who we're speaking with than we do about what they can offer us. For example, we may want some specific piece of data, but we don't care who we get it from since we're able to verify its integrity. libp2p provides a content routing interface for this purpose, with the primary stable implementation using the same Kademlia-based DHT as used in peer routing.

Messaging/PubSub—Sending messages to other peers is at the heart of most peer-to-peer systems, and pubsub (short for publish/subscribe) is a very useful pattern for sending a message to groups of interested receivers. libp2p defines a pubsub interface for sending messages to all peers subscribed to a given “topic”. The interface currently has two stable implementations; floodsub uses a very simple but inefficient “network flooding” strategy, and gossipsub defines an extensible gossip protocol. There is also active development in progress on episub, an extended gossipsub that is optimized for single source multicast and scenarios with a few fixed sources broadcasting to a large number of clients in a topic.

### QUIC Web Transport Protocol

The critical final ingredient of a scalable multi-chain is interchain communication. Since parachains can have some sort of information channel between them, the multi-chain communications system is designed to exchange information (i.e., documents, messages, smart contract and/or Ricardian contracts, videos, etc.) using WebRTC-QUIC communications where the communication among parties is as simple as a transaction executing in a parachain are able to affect the dispatch of a transaction into a second parachain or, potentially, the relay-chain. Like external transactions on production blockchains, they are fully asynchronous and there is no intrinsic ability for them to return any kind of information back to its origin. The transport protocol used in a WebRTC communications channel is based on HTTP/3-UDP-QUIC protocol and referred to as Web Transport protocol (which replaces Web Sockets).

Blockchain Oracles Integrated with IPFS P2P Storage System

Blockchain oracles are entities that connect Blockchain to external systems, thereby enabling smart contract and/or Ricardian contracts to execute based upon inputs and outputs from the real world. Oracles provide a way for the decentralized Web3 ecosystem to access existing data sources, legacy systems, and advanced computations. Decentralized oracle networks enable the creation of hybrid smart contract and/or Ricardian contracts, where on-chain code and off-chain infrastructure are combined to support advanced decentralized applications (DApps) that react to real-world events and interoperate with traditional systems.

### Oracle Problem

The blockchain oracle problem outlines a fundamental limitation of smart contract and/or Ricardian contracts—they cannot inherently interact with data and systems existing outside their native blockchain environment. Resources external to the blockchain are considered “off-chain,” while data already stored on the blockchain is considered on-chain. By being purposely isolated from external systems, blockchains obtain their most valuable properties like strong consensus on the validity of user transactions, prevention of double-spending attacks, and mitigation of network downtime. Securely interoperating with off-chain systems from a blockchain requires an additional piece of infrastructure known as an “oracle” to bridge the two environments.

Solving the oracle problem is of the utmost importance because the vast majority of smart contract and/or Ricardian contract use-cases like DeFi require knowledge of real-world data and events happening off-chain. Thus, oracles expand the types of digital agreements that blockchains can support by offering a universal gateway to off-chain resources while still upholding the valuable security properties of blockchains. Because the data delivered by oracles to blockchains directly determines the outcomes of smart contract and/or Ricardian contracts, it is critically important that the oracle mechanism is correct if the agreement is to execute exactly as expected.

### Decentralized Oracles

Blockchain oracle mechanisms using a centralized entity to deliver data to a smart contract and/or Ricardian contract introduce a single point of failure, defeating the entire purpose of a decentralized blockchain application. If the single oracle goes offline, then the smart contract and/or Ricardian contract will not have access to the data required for execution or will execute improperly based on stale data. Even worse, if the single oracle is corrupted, then the data being delivered on-chain may be highly incorrect and lead to smart contract and/or Ricardian contracts executing very wrong outcomes. This is commonly referred to as the “garbage in, garbage out” problem where bad inputs lead to bad outputs. Additionally, because blockchain transactions are automated and immutable, a smart contract and/or Ricardian contract outcome based on faulty data cannot be reversed, meaning user funds can be permanently lost. Therefore, centralized oracles are a non-starter for smart contract and/or Ricardian contract applications.

To overcome the oracle problem necessitates decentralized oracles to prevent data manipulation, inaccuracy, and downtime. A Decentralized Oracle Network, or DON for short, combines multiple independent oracle node operators and multiple reliable data sources to establish end-to-end decentralization. Even more, many DONs incorporate three layers of decentralization—at the data source, individual node operator, and oracle network levels—to eliminate any single point of failure. The Private NFT architecture deploys a multi-layered decentralization approach, ensuring smart contract and/or Ricardian contracts can safely rely on data inputs during their execution.

### Types of Blockchain Oracles

Given the extensive range of off-chain resources, blockchain oracles come in many shapes and sizes. Not only do hybrid smart contract and/or Ricardian contracts need various types of external data and computation, but they require various mechanisms for delivery and different levels of security. Generally, each type of oracle involves some combination of fetching, validating, computing upon, and delivering data to a destination.

### Input Oracles

The most widely recognized type of oracle today is known as an “input oracle,” which fetches data from the real-world (off-chain) and delivers it onto a blockchain network for smart contract and/or Ricardian contract consumption. These types of oracles are used to power Private NFTs by providing smart contract and/or Ricardian contracts with on-chain access to smart contract and/or Ricardian contract data.

### Output Oracles

The opposite of input oracles is “output oracles,” which allow smart contract and/or Ricardian contracts to send commands to off-chain systems that trigger them to execute certain actions. This can include telling an IPFS storage system to store the supplied data.

### Cross-Chain Oracles

Another type of oracle are cross-chain oracles that can read and write information between different blockchains. Cross-chain oracles enable interoperability for moving both data and assets between blockchains, such as using data on one blockchain to trigger an action on another or bridging assets cross-chain so they can be used outside the native blockchain they were issued on.

### Compute-Enabled Oracles

A new type of oracle becoming more widely used by smart contract and/or Ricardian contract applications are “compute-enabled oracles,” which use secure off-chain computation to provide decentralized services that are impractical to do on-chain due to technical, legal, or financial constraints. This can include using Keepers to automate the running of smart contract and/or Ricardian contracts when predefined events take place, computing zero-knowledge proofs to generate data privacy, or running a verifiable randomness function to provide a tamper-proof and provably fair source of randomness to smart contract and/or Ricardian contracts.

Private NFTs with Smart Contract and/or Ricardian Contracts

Oracles enable non-financial use cases for smart contract and/or Ricardian contracts such as Private NFTs-Non-Fungible Tokens that can change in appearance, value, or distribution based on external events. Additionally, compute oracles are used to generate verifiable randomness that projects then use to assign randomized traits to NFTs or to select random lucky winners in high-demand NFT drops.

### Sidechains

Sidechains are subchains that run parallel to the mainchain. Sidechains do not contain independent nodes but instead work by connecting their nodes to the existing mainchain. Blockchain technology has scalability issues. In the case of Ethereum, only 15 transactions can be processed per second. Sidechain technology offers a solution to these issues and has already been widely used. Sidechains' greatest strength is increasing the speed of transactions. Since operations are distributed on each sidechain, processing efficiency increases, and depending on the desired use case, the necessary functions (such as speed and computational ability) are readily available. Due to these characteristics, sidechain technology is being used in a variety of commercial fields. Sidechains use consensus algorithms like PoA, PoS, DPOS, and BFT. They can easily overcome the limitations of the mainchain since they have lower fees and a faster transaction processing time. Sidechains also act as a bridge between different cryptocurrencies. The performance of various cryptocurrencies can be upgraded if sidechains are used effectively.

One of the main uses for sidechains is to exchange different blockchain tokens. There have been many attempts to connect different blockchains, such as Bitcoin and Ethereum, but creating bridges between cryptocurrencies has been the most successful thus far. Perhaps the most obvious way to connect cryptocurrencies is to modify the code of Bitcoin or Ethereum itself. However, since it is practically impossible to modify the entire code of another company's blockchain, sidechains are used.

### Sidechain Security

The sidechain construction allows the deployment of an arbitrary number of sidechains on top of existing Bitcoin-based blockchains with a single one-off change to the mainchain protocol. The design is based on an asymmetric peg between the mainchain and its sidechains. The sidechains monitor events on the mainchain, but the main blockchain is agnostic to its sidechains.

Forward transfers from mainchain to sidechain are simpler to construct than backward transfers that return assets to the mainchain. Here, the receiving chain (mainchain) cannot verify incoming backward transfers easily. The design introduces a SNARK-based proving system, where sidechains generate a proof for each given period, or Epoch, that is submitted to the mainchain together with that epoch's backward transfers. The backward transfers and the proof are grouped into a special container that structures communication with the mainchain.

The cryptographic proofs allow the mainchain to verify state transitions of the sidechain without monitoring it directly. Some modifications to the mainchain needed to enable this sidechain design are the following:

### Sidechain Transactions Commitment

A new data field called Sidechain Transactions Commitment is added to the mainchain block header. It is the root of a Merkle tree whose leaves are made up of sidechain relevant transactions contained in that specific block. Including this data in the block header allows sidechain nodes to easily synchronize and verify incoming transactions without needing to know the entire mainchain block.

### Sidechain Deployment

A special type of bootstrapping transaction is introduced in which several important parameters of the new sidechain are defined. The sidechain identifier ledger Id is set, as well as the verifying key to validate incoming withdrawal certificates. This bootstrapping transaction also describes how proof data will be provided from sidechain to mainchain with regards to the number and types of included data elements. Additionally, the length of a withdrawal epoch is defined in the bootstrapping transaction.

### Forward Transfers

A forward transfer moves assets from the mainchain to one of its sidechains. These transactions, more specifically the transaction outputs, are unspendable on the mainchain, but include some metadata so they are redeemable on one of the sidechains. It is the responsibility of sidechain nodes to monitor the mainchain for incoming transactions and include them in a sidechain block.

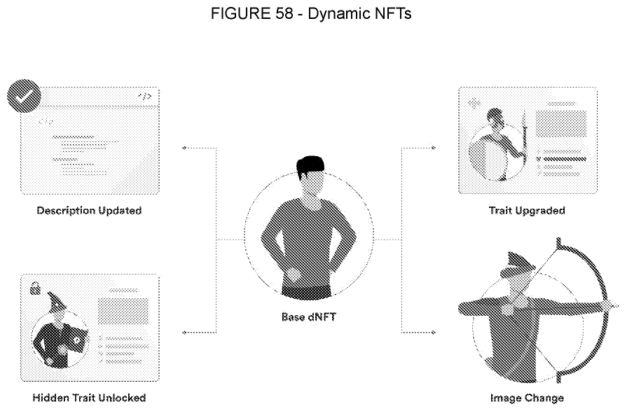

### FIG. 58

FIG. 58 is a diagram showing Dynamic NFTs. FIG. 58 illustrates how NFTs are unique digital objects that exist on a blockchain. Every NFT can be differentiated from another through a 1-of-1 tokenID and its unique contract address. Metadata such as images, video files, or other data can be attached, meaning that it's possible to own a token that represents a unique digital object.

The most common NFT use case is currently digital art; an artist mints a token representing a digital artwork and a collector can purchase that token, marking their ownership. Once NFTs are minted, their tokenIDs don't change. Keep in mind that ascribing metadata, which incorporates an NFT's description, image, and more is completely optional. In its most bare-bones form, an NFT is simply a transferable token that has a unique tokenID.

Registering unique assets and freely trading them on a common decentralized platform (blockchain) has standalone value. The limitation is that the blockchain creates its value of decentralized security by disconnecting from all other systems, meaning NFT-based assets do not interface with data and systems outside the blockchain (static). Oracles can resolve this connectivity problem by allowing NFTs to interact with the outside world. The next evolution in NFTs is moving from static NFTs to dynamic NFTs—perpetual smart contract and/or Ricardian contracts that use oracles to communicate with and react to external data and systems. The oracle allows the NFT to use external data/systems as a mechanism for minting/burning NFTs, trading peer-to-peer, and checking state.

Static NFTs are currently the most common type of NFT, used for the most part by NFT art projects and play-to-earn game projects and as digital collectibles. Beyond these use cases, they also offer a unique value proposition for digitizing items in the real world, such as real estate deeds, patents, and other unique identifiers.

However, this model is limited by the permanence of static NFTs, because the metadata attached to them is fixed once they're minted on a blockchain. Use cases such as tokenizing real-world assets, building progression-based video games, or creating blockchain-based fantasy sports leagues often require data to be updated. dNFTs offer a best-of-both-worlds approach, with NFTs retaining their unique identifiers while able to update aspects of their metadata. Put simply, a dynamic NFT is an NFT that can change based on external conditions. Change in a dynamic NFT often refers to changes in the NFT's metadata triggered by a smart contract and/or Ricardian contract. This is done by encoding automatic changes within the NFT smart contract and/or Ricardian contract, which provides instructions to the underlying NFT regarding when and how its metadata should change.

An often-overlooked component of dynamic NFT (dNFT) design is how to reliably source the information and functionality needed to build a secure, fair, and automated dNFT process. Dynamic NFT metadata changes can be triggered in numerous ways based on external conditions. These conditions can exist both on and off-chain. However, blockchains are inherently unable to access off-chain data and computation.

The Private NFT P2p network design enables these limitations to be overcome by providing various off-chain data and computation services that can be used as inputs to trigger dNFT updates. As the dNFT ecosystem expands and NFTs become more heavily integrated with the real world, the dynamic NFT design acts as a bridge between the two disconnected worlds, enabling automated, decentralized, and engaging dNFT processes to be built.

Referring now to FIG. 58, a Description is updated and a Hidden Trait is unlocked connected to a Base dNFT. Leads to an Upgraded Trait and an Image Change.

Cross-Chain Smart Contract and/or Ricardian Contract Protocols

Cross-chain smart contract and/or Ricardian contracts are decentralized applications that are composed of multiple different smart contracts and/or Ricardian contracts deployed across multiple different blockchain networks that interoperate to create a single unified application. This new design paradigm is a key step in the evolution of the multi-chain ecosystem and has the potential to create entirely new categories of smart contract and/or Ricardian contract use cases that leverage the unique benefits of different blockchains, sidechains, and layer-2 networks.

Historically, the adoption of smart contract and/or Ricardian contracts has largely taken place on the Ethereum mainnet due to it being the first blockchain network to support fully programmable smart contract and/or Ricardian contracts. Alongside its first-mover advantage, additional factors have also contributed to Ethereum's adoption, such as its growing network effect, decentralized architecture, time-tested tooling, and an extensive community of Solidity developers. However, rising demand for Ethereum smart contract and/or Ricardian contracts has led to an increase in network transaction fees over time, as demand for Ethereum's blockspace (computing resources) exceeds supply. While the Ethereum mainnet continues to provide one of the most secure networks for smart contract and/or Ricardian contract execution, many end-users have begun to seek lower-cost alternatives.

In response, the adoption of smart contract and/or Ricardian contracts on alternative layer-1 blockchains, sidechains, and layer-2 rollups has rapidly increased in the past year to meet the needs of users and developers. The availability of new on-chain environments has increased the total aggregate throughput of the smart contract and/or Ricardian contract economy, leading to the onboarding of more users who are able to transact at a lower cost. Furthermore, each blockchain, sidechain, and layer-2 network offers its own approach to scalability, decentralization, mechanism design, consensus, execution, data availability, privacy, and more. In the multi-chain ecosystem, all these different approaches can be implemented and battle-tested in parallel to push forward the ecosystem's development.

The Ethereum community has embraced the multi-chain approach, as evidenced by the adoption of a rollup-centric roadmap for scaling the throughput of the Ethereum ecosystem via the deployment of various layer-2 scaling solutions. Layer-2 networks increase the transaction throughput of Ethereum-based smart contract and/or Ricardian contracts, resulting in lower fees per transaction while retaining the security properties of the Ethereum mainnet. This is achieved by verifying off-chain computations on the Ethereum baselayer blockchain using fraud proofs or validity proofs, and in the future, also leveraging data sharding to expand capacity for rollup calldata.

To take advantage of the multi-chain ecosystem, many developers are now increasingly deploying their existing smart contract and/or Ricardian contract codebase across multiple networks rather than on just one blockchain. By developing multi-chain smart contracts and/or Ricardian contracts, projects have been able to both expand their user base and experiment with new features on lower-cost networks that would otherwise be too cost-prohibitive. The multi-chain approach has become increasingly commonplace across numerous DeFi verticals.

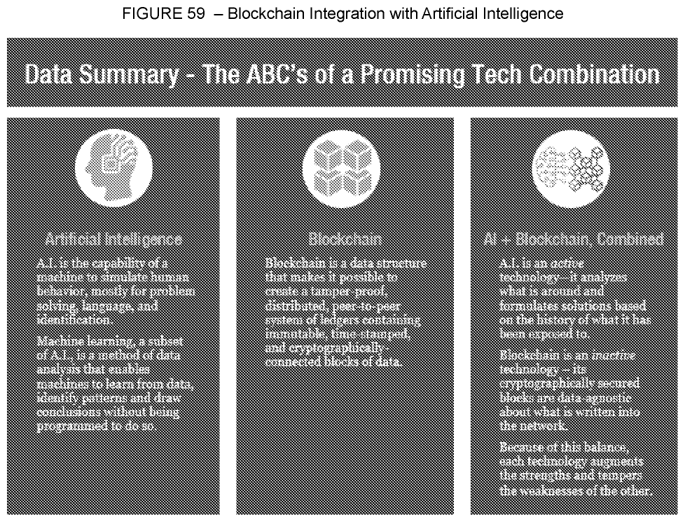

### FIG. 59

FIG. 59 is a diagram illustrating Blockchain Integration with Artificial Intelligence.

FIG. 59 shows how AI can enhance and improve the performance and feature set of the Blockchain Web3 communications platform. The convergence of these technologies could lead to the foundation of new business models for Private NFT deployments.

### Blockchain and Artificial Intelligence (AI)

Blockchain is a distributed digital ledger shared across peers in the network. The peers or nodes agree on transactions that you must add to the blockchain network. The transactions on the network are stored on blocks that have unique hash values alongside time stamps for verifying integrity. The connection of blocks to each other in the form of a chain gives the reason for the term ‘blockchain’. The chain of connected peer-to-peer networks is practically immutable and offers the desired security from data modification.

Artificial intelligence is the ability to simulate human intelligence using machines. The blockchain artificial intelligence equation largely depends on the capabilities of AI for enabling technological solutions with cognitive traits. The primary goal of artificial intelligence focuses on reducing human errors while ensuring faster operations. Therefore, AI and blockchain aim to make processes faster. Using both together definitely presents some interesting prospects for expanding the applications of blockchain across the Web 3.0 communications sectors.

Existing trends of applying AI in the blockchain would improve blockchain by introducing the following functionalities,
Data protection
Smart computing power
Data monetization
Creation of diverse data sets

Blockchain could also provide a better platform for understanding AI. It can help in tracing the decision-making processes in machine learning. Blockchain could help in accurate documentation of each data and variable involved in the decision-making of AI algorithms. Furthermore, blockchain AI convergence is also favorable on the grounds of assured improvements in blockchain efficiency. For example, Artificial Intelligence could help in automating various aspects of blockchain management, such as audit trail monitoring.

AI and Blockchain are different technologies that have unique traits when working independently. However, combining the best of both for the larger good is perfectly evident in a blockchain and AI combo. Here are some of the notable advantages of combining AI with blockchain.

### Encryption Advantages

AI and blockchain could provide a substantial boost for improvements in encryption. First, AI has formidable potential with respect to security. Recent developments in AI have been focused on developing algorithms capable of working with data in an encrypted state. This is obviously a security risk while blockchain security algorithms can make a supportive intervention with information stored in encrypted form. Blockchain AI applications could offer the benefit of storing highly sensitive personal data. With the ideal and smart processing approaches, the data could help in unlocking convenience and value. For example, smart healthcare systems could ensure precise healthcare routines by scanning medical records with assured security.

### Ease of Blockchain Management

The benefit of better management is an obvious reason for which it is important to consider AI and blockchain combinations. We have always had fast computers, although without any clue what to do until provided with specific instructions. Therefore, utilizing blockchain on computers could imply the need for large amounts of processing power. Hashing algorithms for mining blocks follow a brute force approach by trying different combinations of characters for finding the suitable alternative for verifying a specific transaction. So, it is clearly visible that dealing with blockchain takes a lot of processing power to carry out each process. Now, the blockchain and AI combination could work as a reliable solution for addressing this issue.

### Tracking, Understanding, and Explaining AI Decisions

Blockchain is popular for its decentralization and transparency. Therefore, it gives the perfect instrument for peeling the layers of complex AI algorithms to understand their decision-making processes. The decisions by AIs could be difficult for humans to understand. However, there are situations where AI-based decisions will have to be brought to audit, primarily for verifying accuracy. The blockchain and AI combination can work perfectly in this case with the advantages of the datapoint-to-datapoint approach for documenting decisions. As a result, it also presents prolific opportunities for improving the credibility of AI.

Blockchain Integration with Artificial Intelligence

Artificial Intelligence using Blockchain, combined. A.I. is the capability of a machine to simulate human behavior, mostly for problem solving, language, and identification. Machine learning, a subset of AI, is a method of data analysis that enables machines to learn from data, identify patterns and draw conclusions without being programmed to do so.

Blockchain is a data structure that makes it possible to create a tamper-proof, distributed, peer-to-peer system of ledgers containing immutable, time-stamped, and cryptographically connected blocks of data.

AI is an active technology—it analyzes what is around and formulates solutions based on the history of what it has been exposed to. Blockchain is an inactive technology—its cryptographically secured blocks are data-agnostic about what is written into the network. Because of this balance, each technology augments its strengths and tempers the weaknesses of the other.

### Blockchain Transformation of AI

Many shortcomings of AI and blockchain can be addressed effectively by combining both technological ecosystems. AI algorithms rely on data or information to learn, infer, and make final decisions. Machine learning algorithms work better when data are collected from a data repository or a platform that is reliable, secure, trusted, and credible. Blockchain serves as a distributed ledger on which data can be stored and transacted in a way that is cryptographically signed, validated, and agreed on by all mining nodes. Blockchain data are stored with high integrity and resiliency and cannot be tampered with. When smart contract and/or Ricardian contracts are used for machine learning algorithms to make decisions and perform analytics, the outcome of these decisions can be trusted and undisputed. The consolidation of AI and blockchain can create secure, immutable, decentralized system for the highly sensitive information that AI-driven systems must collect, store, and utilize. This concept results in significant improvements to secure the data and information in various fields, including medical, personal, banking, and financial, trading, and legal data. AI can benefit from the availability of many blockchain platforms for executing machine learning algorithms and tracing data that are stored on decentralized P2P storage systems such as IPFS. These data are typically originated by smart connected products that include variety of sources such as IoT devices, IP surveillance cameras, smart cities, UAV/Drones, and vehicles. The features and services of the platform can be also harnessed for off-chain machine learning analytics and intelligent decision making, and for data visualization.

Some of the significant features of leveraging blockchain for AI can be summarized as follows:

### Enhanced Data Security.

Information held within blockchain is highly secure. Blockchains are very well known for storing sensitive and personal data in a diskless environment. Blockchain databases hold data that are digitally signed, which means only the “respective private keys” must be kept secure. This allows AI algorithms to work on secure data, and thereby ensuring more trusted and credible decision outcomes.

### Decentralized Intelligence.

For taking smart high-level decisions which involve multiple agents to perform different subtasks that have access to the common training data (e.g., in case of supervised learning), different individual cybersecurity AI agents can be combined to provide fully coordinated security across the underlying networks and to solve scheduling issues.

### High Efficiency.

Multiuser business processes, which involve multiple stakeholders such as individual users, business firms, and governmental organizations, are inherently inefficient due to multiparty authorization of business transactions. The integration of AI and blockchain technologies enables intelligent Decentralized Autonomous Agents (or DAOs) for automatic and fast validation of data/value/asset transfers among different stakeholders.

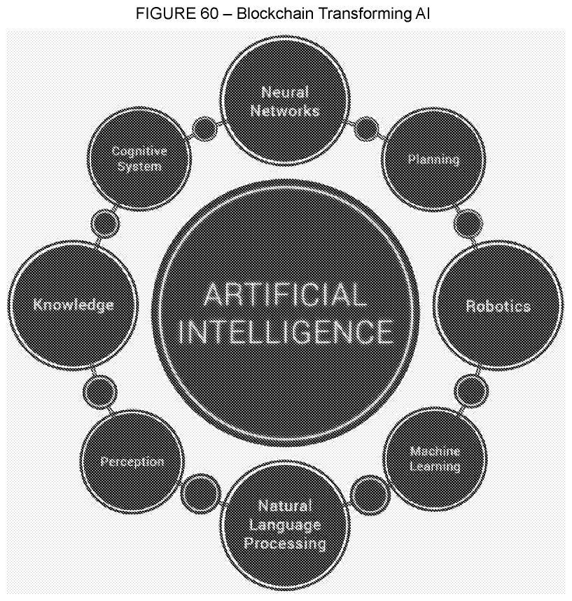

### FIG. 60

FIG. 60 is a diagram illustrating how Blockchain is used to transform AI. FIG. 60 shows how Artificial Intelligence is a central core connecting Neural Networks, Planning, Robotics, Machine Learning, Natural Language Processing, perception, Knowledge, and Cognitive Systems.

### Web3 Decentralized AI Applications

AI applications operate autonomously to perform informed decisions by executing different planning, search, optimization, learning, knowledge discovery, and knowledge management strategies. However, the decentralization of AI operations is a complex and challenging task.

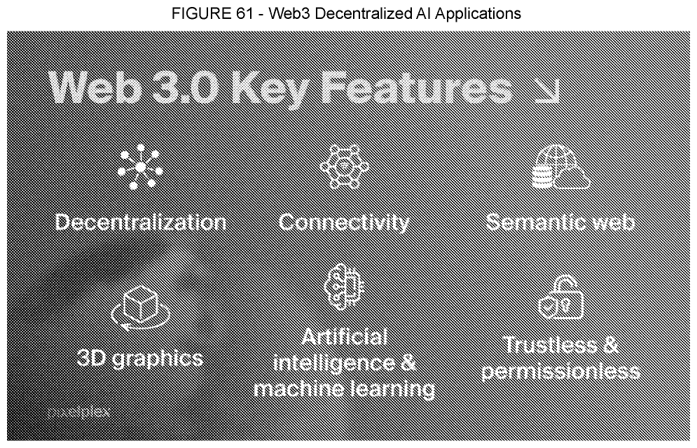

### FIG. 61

FIG. 61 is a diagram of Web3 Decentralized AI Applications. FIG. 61 shows Web3 features include decentralization, connectivity, semantic web, 3D graphics, Artificial Intelligence & machine learning, and trustless and permissionless access and movement.

### Adaptive Computing

One of the key goals of AI applications is to enable fully (or partially) autonomous operations whereby multiple intelligent agents (i.e., small computer programs) perceive their constituent environments, preserve their internal states, and perform specified actions accordingly. To operate autonomously, modern computing systems need to handle massive heterogeneity at all verticals including data sources, devices, data processing systems, data storage systems, and application interfaces, to name a few. The enablement of multiagent systems at all verticals does not only facilitate the handling of heterogeneity but it also helps in establishing inter-layer and intralayer operability across entire systems. The blockchain architecture can play a vital role by ensuring operational decentralization and keeping permanent footprints of interactions between users, data, applications, devices, and systems which leads toward the development of fully decentralized autonomous systems.

### Optimization

Finding a set of best solutions from all possible solutions is one of the main features of AI-enabled applications and systems. Modern AI applications and systems operate in various environments including pervasive and ubiquitous environments (e.g., edge computing systems), resource constrained environments (e.g., mobile devices/systems), geographically bounded systems (e.g., personal area networks, wireless local area networks, etc.), and centralized massively parallel and distributed computing systems. Based upon application-level and system-level objectives, the optimization strategies work in constrained or unconstrained environments. These strategies facilitate finding best solutions such as selecting most relevant data sources in pervasive environments, best candidate Blockchain platforms for data and application processing or enabling the resource-efficient data management in large-scale distributed computing environments. The enablement of decentralized optimization strategies using blockchain opens a new window of research and development opportunities. Decentralized optimization leads to increased system performance by processing highly relevant data. Decentralized optimization is also beneficial when multiple strategies with different optimization objectives need to be run simultaneously across applications and systems.

### Organization and Planning

AI applications and systems execute planning strategies to collaborate with other applications and systems and solve complex problems in new environments. Planning strategies help in operational efficiency and resilience of AI applications and systems by taking current input state and executing different logic and rule-based algorithms to reach predefined goals. Currently, centralized planning is a complicated and time-consuming task; therefore, blockchain based decentralized AI planning strategies are needed to offer more robust strategies with permanent tracking and provenance history. The blockchain is also useful for devising critical and immutable plans for strategic applications and mission critical systems.

### Discovery and Management

Modern AI applications handle large amounts of data streams and require support for centralized big data processing systems. The centralized knowledge discovery and knowledge management benefits the provisioning of application-wide and system-wide intelligence; however, the applications enable customized knowledge patterns for specific groups of users, applications, devices, and systems. The decentralization of knowledge discovery processes and decentralized knowledge management is envisaged to provide personalized knowledge patterns considering the needs of all stakeholders in the system. In addition, blockchain technologies can facilitate in secure and traceable knowledge transfer among different stakeholders in AI applications and systems.

### Intelligent Agents

Intelligent agents in AI applications and systems continuously collect, interpret, select, and organize data from their ambient environments using centralized perception strategies which results in monolithic data collection. Decentralized perception strategies can facilitate the collection of data from different views. The blockchain based decentralization facilitates tracing the perception trajectories, secure transfer of collected data, and immutable data storage. The decentralized perception strategies are useful because the applications and systems do not need to collect the data streams for successful and high-quality perceptions repeatedly. Considering the permanent nature of blockchain, only the footprints of successful perceptions should be stored on blockchain.

### Learning Algorithms

The learning algorithms stay at the heart of AI applications to enable automation and knowledge discovery processes. Learning algorithms vary in terms of supervised, unsupervised, semi-supervised, ensemble, reinforcement, transfer, and deep learning models. These learning models solve different machine learning problems from classification to clustering and regression analysis to frequent pattern mining. The decentralized learning models can help in achieving highly distributed and autonomous learning systems that support fully coordinated local intelligence across all verticals in modern AI systems. In addition, the blockchain enables immutable and highly secure versioning of learning models by maintaining provenance and historical aspects of data. However, considering the permanent nature of smart contract and/or Ricardian contracts, learning models need to be trained and tested well prior to deployment on blockchain.

### Search Algorithms

AI applications need to operate in large and sparse search spaces (i.e., big datasets or multivariable high dimensional data streams); therefore, efficient search strategies become the essence of AI technologies. The search strategies are designed by considering different factors such as completeness, complexity (i.e., time and space), and optimality. These strategies generally operate on nonlinear data structures such as trees and graphs whereby the algorithms start their expansion from an initial state and gradually expand until finding the required variable or completing the traversals in whole search spaces. Normally, search strategies are implemented using large-scale centralized and distributed infrastructure to maximize operational efficiency.

### Logic Programming

Logic programming is an essential component of AI applications that allows to develop inductive or deductive reasoning rules to reach decisions. The centralized reasoning in AI applications leads toward generalized global behavior across all application components. To handle this issue, blockchain based distributed reasoning strategies are envisaged to facilitate the development of personalized reasoning strategies which could be more beneficial during perception, learning, and model deployment. In addition, smart contract and/or Ricardian contract based decentralized distributed reasoning on blockchain ensures the availability of unforgettable reasoning processes which may help in future executions of similar reasoning strategies.

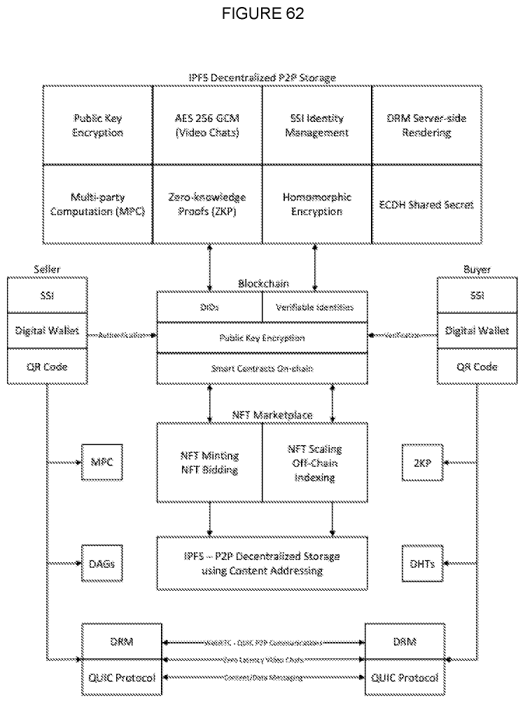

### FIG. 62

FIG. 62 is a diagram illustrating a Private NFT Patent Marketplace Interworking with Zero Trust Security Enclave

The application layer for this use-case includes IPFS decentralized P2P storage module having public key encryption, AES 256 GCM (video chats), SSI identity management, DRM file rendering, multi-party computation (MPC), zero knowledge proofs (ZKP), homomorphic encryption, and ECDH shared private.

The IPFS decentralized P2P storage module is in communication with a blockchain module having DIDs, verifiable identities, public key encryption, and smart contract and/or Ricardian contracts on-chain.

The Blockchain module is connected using authentication to both a seller module and a buyer module. The buyer module and the seller module each have SSI, a digital wallet, and a QR code.

The Blockchain module is also connected to an NFT marketplace having NFT minting, NFT bidding, and NFT off-chain indexing.

The seller module is connected to an MPC module, a DAGs module, and a DRM/QUIC protocol module. The buyer module is connected to a ZKP module, a DHTs module, and a DRM/QUIC protocol module.

The DRM/QUIC protocol modules communicate with each other using WebRTC—QUIC P2P communication, and (programming for) zero latency video chats, and content and data messaging.

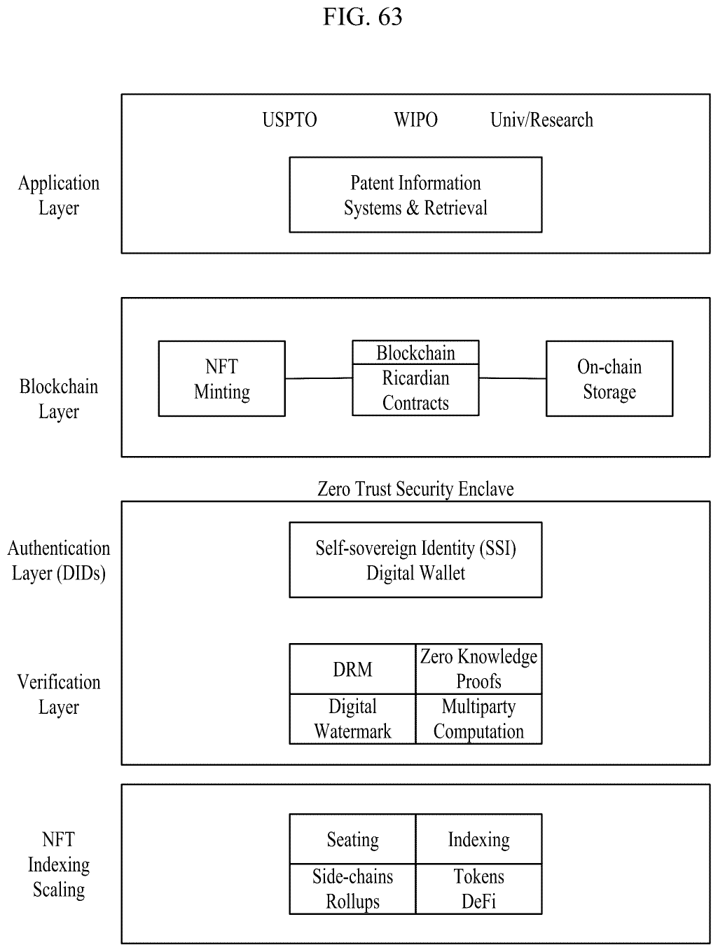

### FIG. 63

FIG. 63 is a diagram illustrating Part 1 of an NET framework for IPR ownership validation and verification integrated with IPR databases, such as USPTO, WIPO, and University Research publications.

In one aspect, the invention includes as a “Use application”, a private Blockchain based Private NET framework and marketplace where validly issued patents can be traded or licensed using non-fungible tokens (NFTs) on Ethereum 2.0—EVM. The system is designed and implemented on a Private NFT trading platform to support private NFT patent auctions between patent buyers and sellers who desire complete anonymity and confidentiality using the NFT patent marketplace. The Ethereum Blockchain NFT architecture can be adapted and modified to operate with other Blockchains that support private NFT trading using cross-chain Dynamic NFTs interworking with decentralized oracles and cross-chain p2p protocols, including for Cardano, Solana, Tezos, Binance, Flow and Polkadot.

International Patent Marketplace—The inventive international patent NFT marketplace system is integrated with the USPTO patent and copyright database and WIPO patent scope database to access legally approved and issued patents and to verify patent ownership and any licensing contracts, pledges, commitments, or patent restrictions subsequently filed on the patents.

Private NFT Patent Framework—The Private NFT patent system uniquely integrates Ethereum 2.0 Blockchain (EVM), Self-Sovereign IDM, smart contract and/or Ricardian contracts, Decentralized IDs (DIDs), on-chain storage, patent minting, NFT scaling, off-chain indexing and Self Sovereign digital wallets with Web3 decentralized client applications. Additionally, the system integrates with WebRTC-QUIC P2P communications to provide secure real-time multimedia services, such as video chats, videoconferencing and messaging between buyers and sellers using any smartphone browser such as Chrome, Safari, and Firefox. The system is also integrated with the IPFS P2P network for off-chain storing and sharing of patent data and smart contract and/or Ricardian contract transactions in a decentralized file system using content addressing technology and advanced cryptography.

Private NFT Patent Framework Interworking with Zero Trust Security Enclave—The Private NFT patent framework has been designed and architected to support private NFT patent auctions between buyers and sellers who require complete anonymity and confidentiality with private NFT patent transactions. The Private NFT patent system and methods integrate advanced security-based technologies to restrict user access to the private NFT auctions only to authorized buyers and sellers.

### EXAMPLE

### An International Private NFT Marketplace for Patents, Copyrights, and Intellectual Property

Applying for a patent and trademark is a time-consuming and lengthy process, but it is also costly. That is, registering a copyright or trademark may take months, while securing a patent can take years. With the introduction of Blockchain NFT technology, it is feasible to implement a Blockchain based private patent NFT marketplace to make the buying and selling of NFT patents easier, offering new opportunities for companies, universities, and inventors to monetize their innovations. Patent holders can benefit by giving them the ability to ‘tokenize’ their patents for electronic sale in an open, transparent trading forum. Because every transaction would be logged on a Blockchain, it will be much easier to trace patent ownership changes. In essence, a private patent NFT marketplace would facilitate the revenue generation of patents to owners by democratizing patent licensing via NFT for patent licensing or outright sale.

NFTs support the IP market by embedding automatic royalty collecting methods inside inventors' works, providing them with financial benefits anytime their innovation is licensed. For example, each inventor's patent would be minted as an NFT, and these NFTs would be joined together to form a commercial IP portfolio and could be further minted as a compounded NFT. Each patent holder and patent investor would automatically get their fair share of royalties whenever the licensing revenue is generated without having to track down each buyer or buyer groups. It's all managed by Blockchain and NFTs.

While Blockchain and NFTs have been implemented for numerous applications that represent tradable rights of digital assets (pictures, music, films, and virtual creations) where ownership is recorded in blockchain and smart contract and/or Ricardian contracts, there is a growing need to provide a generalized conceptual private patent NFT framework for generating, recording, and tracing NFT based-IP in a blockchain-smart contract and/or Ricardian contract network integrated with on-chain and decentralized off-chain storage and with peer-to-peer video and messaging communications between buyers and sellers of patents during scheduled NFT patent auctions. The private NFT architecture for patents is seamlessly integrate with IPFS off-chain decentralized smart contract and/or Ricardian contract storage and with WebRTC-QUIC real-time multimedia communications platform for secure video chats and DRM protected content messaging between NFT patent buyers and sellers.

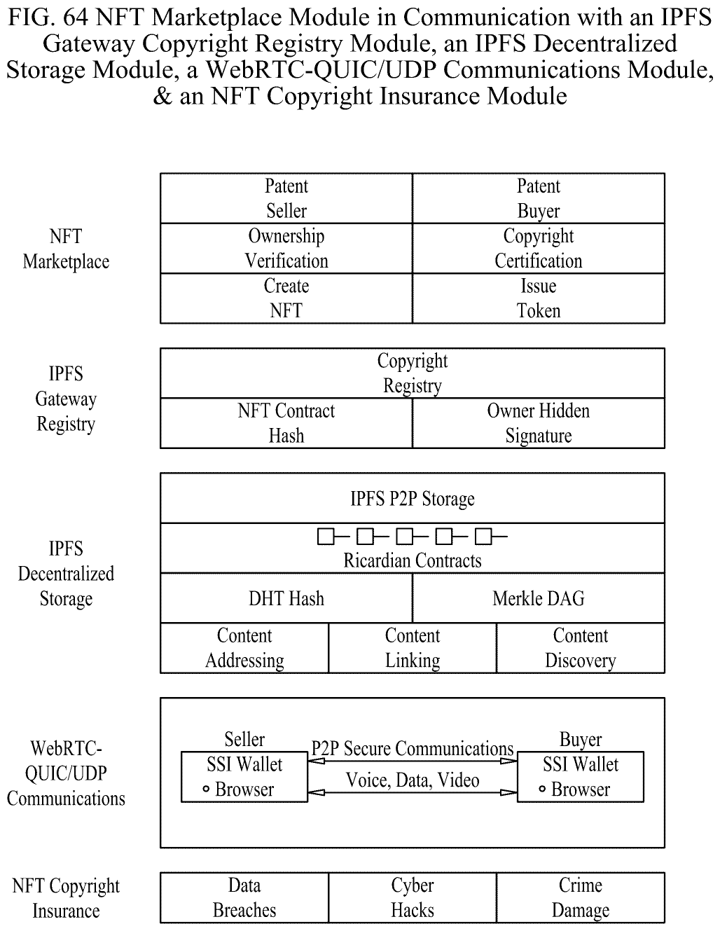

### FIG. 64

FIG. 64 is a diagram illustrating Part 2 of an NFT Based Patent Framework and Copyright Validation and verification System Integrated with the USPTO and WIPO. An application layer module includes connections to external databases, such as the US PTO, WIPO, university, research, and so forth to provide a patent information system and retrieval. A Blockchain layer module includes an NFT Minton component connected to a Blockchain having Ricardian contracts and connected to unchain storage. An authentication layer parentheses DIDS and parentheses module and verification layer module can include a zero trust security enclave. That includes a self-sovereign identity parentheses SSI and parentheses digital wallet. The zero trust security enclave can also include a DRM component, a zero knowledge, proofs, component, a digital watermark component, and a multi-party computation compose an NFT indexing scaling module includes for scaling, a side, chains, rollup, and for indexing tokens and DeFi distributed finance.

FIG. 64 shows the NFT Marketplace module in communication with an IPFS Gateway Copyright Registry module, an IPFS Decentralized Storage module, a WebRTC-QUIC/UDP Communications module, and an NFT Copyright Insurance module. In an NFT marketplace, there is a patent seller and a patent buyer. The patent seller is concerned with ownership, verification, and creation of an NFT. The patent buyer is concerned with copyright certification and issuing a token an IPFS gateway registry has a copyright registry, an NFT, contract, hash, and an owner hidden signature. An IPFS decentralized storage module has an IPFS peer to peer storage component, regarding contract component, DHT hash, Merkel, the AG, content, addressing, content, linking, and content discovery components. A web RTC-QUIC/UDP communications module has a seller SSI wallet with a browser extension and a buyer SSI wallet with a browser extension that are in peer-to-peer secure communication for transferring voice data and video communications. An NFT copyright insurance module includes a data breach component, a cyber hack component, and a crime damage component.

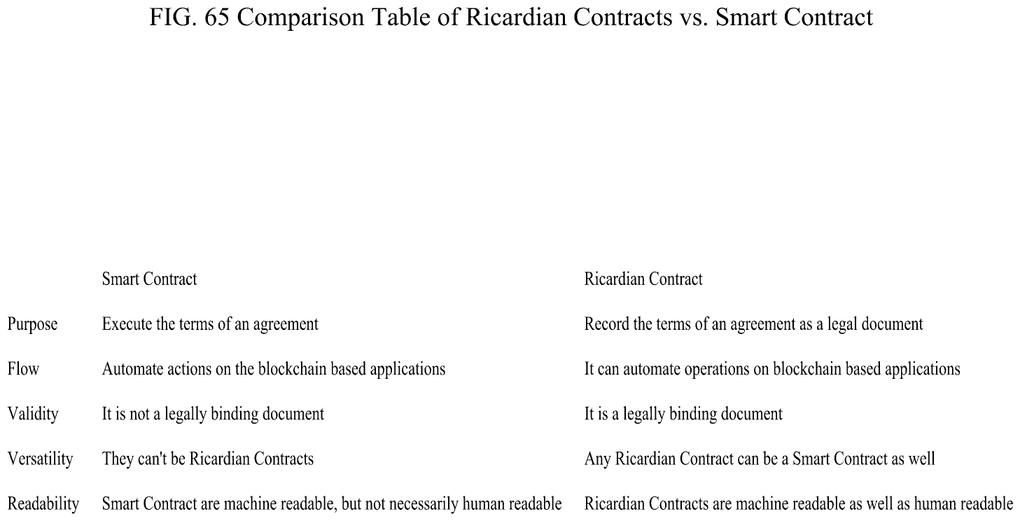

### FIG. 65

FIG. 65 is a diagram illustrating a Comparison Table of Ricardian Contracts vs. Smart contract and/or Ricardian contracts. A smart contract and/or Ricardian contract, and a Ricardian contract can be compared in terms of purpose, flow, validity, versatility, and readability. A smart contract and/or Ricardian contract has a purpose to execute the terms of an agreement. The flow is to automate actions on the Blockchain based applications. For validity it is not a legally binding document. For versatility, it can't be Ricardian contract. For readability, a smart contract and/or Ricardian contract, our machine readable, but not necessarily human readable. In contrast, a Ricardian contract has the purpose of recording the terms of an agreement as a legal document. The flow can automate operations and Blockchain based applications. For validity, it is a legally binding document. For versatility, any Ricardian contract can be a smart contract and/or Ricardian contract as well. For readability, Ricardian contracts are machine readable, as well as human readable.

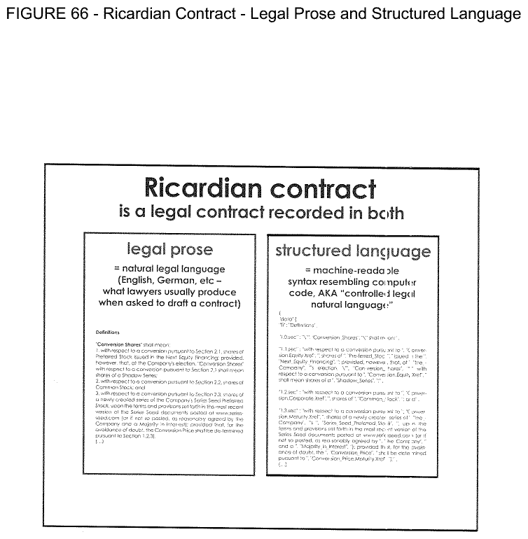

### FIG. 66

FIG. 66 is a diagram illustrating a Ricardian contract exemplified in legal prose vs. structured language.

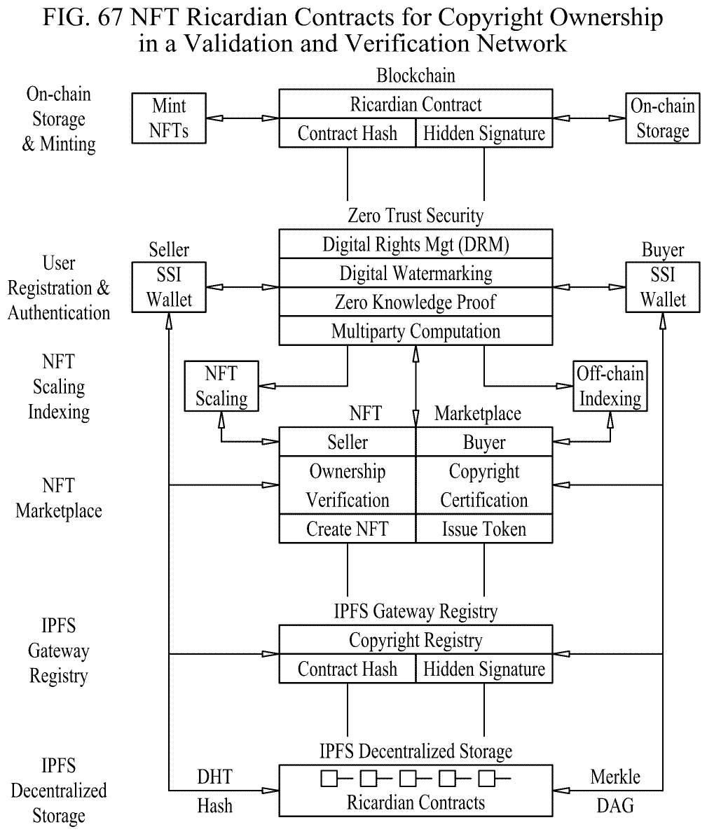

### FIG. 67

FIG. 67 is a diagram illustrating NFT Ricardian Contracts for Copyright Ownership in a Validation and Verification Network. FIG. 67 shows a mint NFT module in communication with the Blockchain module, having Ricardian contracts, contract, hash, and hidden signature. The Blockchain module is in communication with on chain storage. The Blockchain module is connected to a zero trust security module, having digital rights management parentheses DRM, and parentheses, digital watermarking, zero knowledge, proof, and multi-party computed a seller SSI wallet and a buyer SSI wallet are in communication with the zero trust security module. An NFT scaling module receives input from the zero trust security module. And off the chain indexing module receives input from the zero trust security module. An NFT marketplace module includes a seller component, buyer component, ownership component, verification component, copyright component, certification component, create NFT module, and issue token module. NIPFS gateway Registry module receives input from the NFT marketplace module. The IPFS gateway registry module includes a copyright, registry, contract, hash, and hidden signature. An IPFS decentralized storage module is connected to the IPFS gateway registry module. The IPFS decentralized storage module includes Ricardian contracts and receives input as a DHT hash and Merkel DAG.

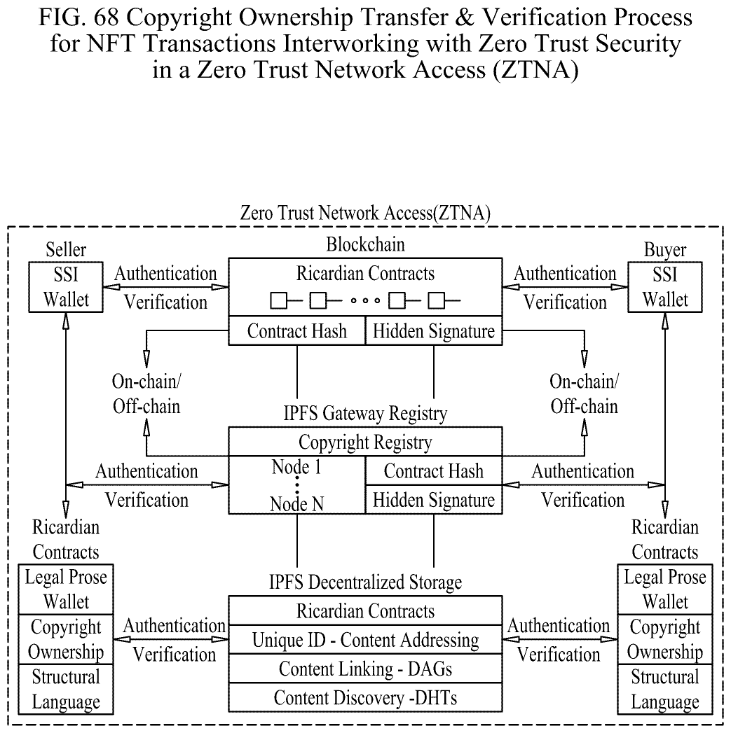

### FIG. 68

FIG. 68 is a diagram illustrating Copyright Ownership Transfer and Verification Process for NFT Transactions Interworking with Zero Trust Security in a Zero Trust Network Access (ZTNA). FIG. 68 shows a zero trust Network access platform. The ZTNA platform has a seller and buyer SSI wallet that are in communication with a Blockchain module using authenticated and verified communications. The Blockchain module provides Ricardian contracts, a contract hash, and a hidden signature. An IPFS gateway registry module is in communication with the block chain module to provide on chain and off chain communications. The IPFS gateway registry module provides a copyright registry, a list of nodes, a contract, hash, and a hidden signature. The IPFS gateway registry is also authenticated and verified communication with the SSI wallets of the seller and the buyer. An IPFS decentralized storage module is in communication with the IPFS gateway registry module. The IPFS decentralized storage module provides Ricardian contracts, a unique ID, content, addressing, content, linking using DAGs, and Content discovery using DHTs. A seller side, Ricardian, contract module, and a buyer side, Ricardian contract module provides Ricardian contracts, having legal prose, copyright ownership, and structured language.

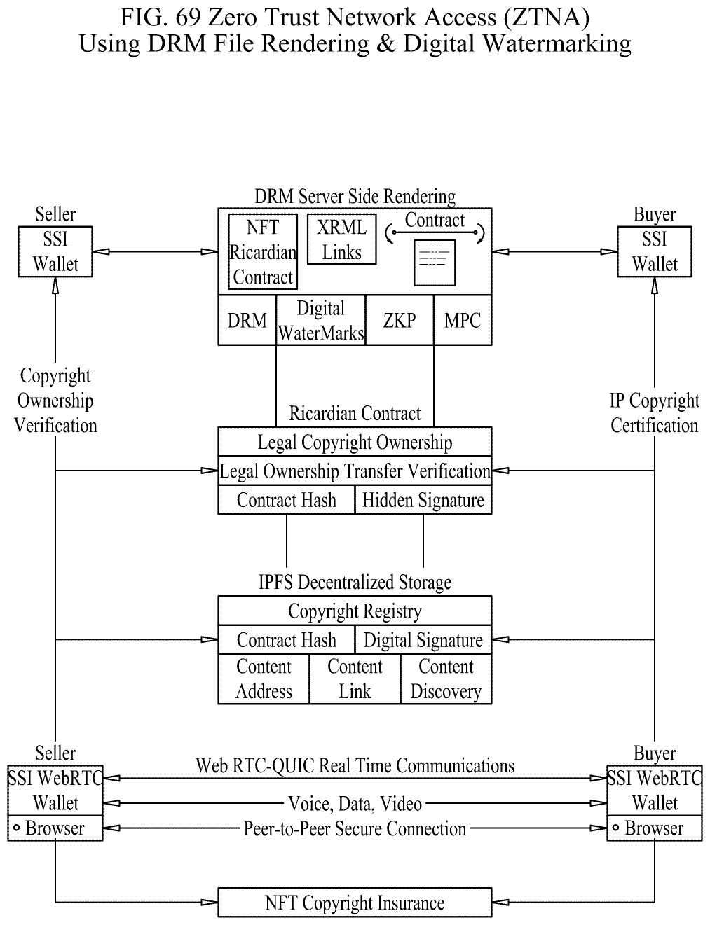

### FIG. 69

FIG. 69 is a diagram illustrating Zero Trust Network Access (ZTNA) Using DRM File Rendering and Digital Watermarking. FIG. 69 shows a seller SSI wallet and a buyer SSI wallet in communication with a DRM server. The DRM server performs DRM service side rendering. The DRM server has a NFT Ricardian, contract, module, and XRML, links, module, and a contract module. The DRM server also has a DRM module, a digital watermarks module, a ZKP,0 knowledge module, and an MPC module. The DRM server is in communication with a Ricardian contract module. The Ricardian contract module establishes legal copyright ownership, legal ownership, transfer, verification, a contract, hash, and a Hidden signature. The seller SSI wallet provides copyright ownership verification, and the buyer SSI wallet provides IP copyright certification to the Ricardian contract module. The Ricardian contract module, then communicates with an IPFS decentralized storage module. The IPFS decentralized storage module provides a copyright registry, a contract, hash, a digital signature, a content address, a contact link, and contact content discovery. Both the seller and the buyer each have an SSI web RTC wallet with a browser extension the SSI web RTC wallets with browser extensions, provide duplex, communication, using web RTC-QUIC, real-time communications. The web RTC-QUIC real time communications provide duplex, voice, data, and video communications through a peer-to-peer secure connection. An NFT copyright insurance module, then receives instructions from both the seller, SSI web, RTC wallet, and the buyer SSI web RTC wallet.

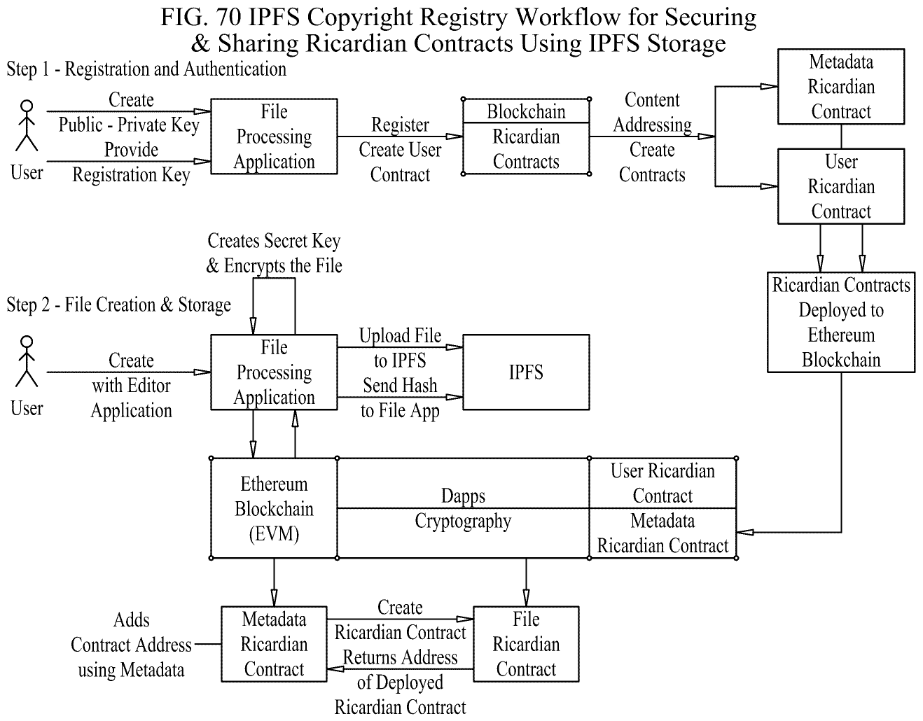

### FIG. 70

FIG. 70 is a diagram illustrating IPFS Copyright Registry Workflow for securing and sharing Ricardian Contracts Using IPFS Storage.

FIG. 70 shows Step 1 for Registration & Authentication where User sends Create instructions to a File Processing Application module and provides a Registration Key. The File Processing Application module then sends a create User Contract instruction to a Blockchain, Ricardian Contract module. The Blockchain, Ricardian Contract module then sends a Content Addressing and Create Contract instruction to a Metadata Ricardian Contract module and a User Ricardian Contract module, which then send instruction to a Ricardian Contract Deployed to Ethereum Blockchain module.

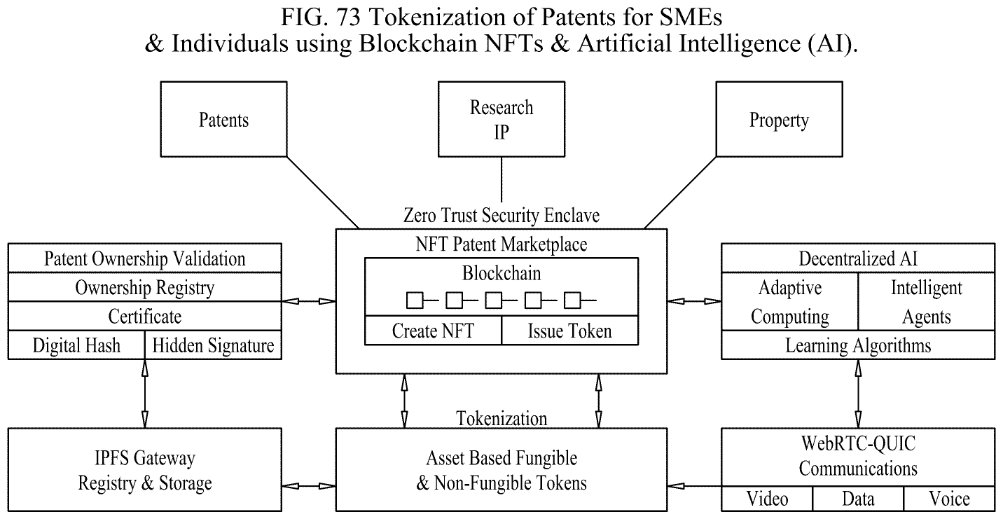

FIG. 70 also shows Step 2 for File Creation and Storage. FIG. 73 also shows step two for file creation and storage. A user a user sends a create with editor application instruction to a file processing application module. The file processing application module then creates a private key and encrypts the file and uploads the file to IPFS. The IPFS file is sent to IPFS storage, and a hash is returned to the file processing application. The file processing application then communicates with an Ethereum Blockchain module. Ethereum Blockchain module has a decentralized app DApps module, cryptography module, a user Ricardian contract, module, and a meta-data Ricardian contract module. The Ethereum Blockchain module sends instructions to a meta-data Ricardian contract module that adds the contract address using meta-data. The metadata Ricardian contract module sends a create instruction for the Ricardian contract to a file Ricardian contract module. The file Ricardian contract module returns and instructions to with the address of the deployed regarding contract to the meta-data regarding contract module.

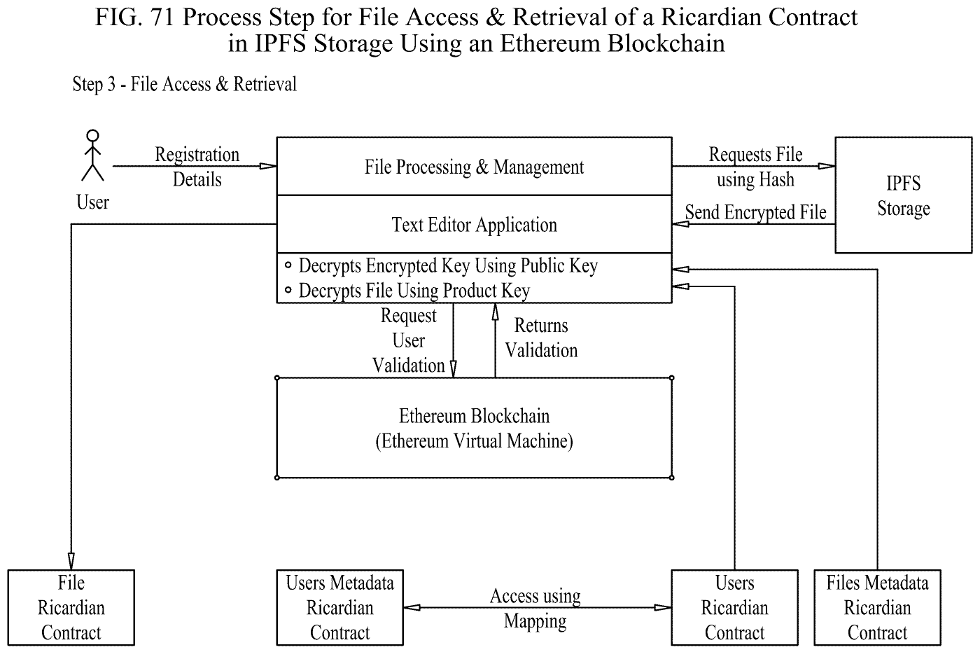

### FIG. 71

FIG. 71 is a diagram illustrating a Process Step for File Access and Retrieval of a Ricardian Contract in IPFS Storage Using an Ethereum Blockchain. FIG. 71 shows a user entering registration details into a File Processing & Management module having a text editor application and an encryption/decryption module. The File Processing & Mgmt module requests a file using HASH from the IPFS. the IPFS sends an encrypted file to the text editor application, which files a Ricardian Contract. The encryption/decryption module requests user validation from an Ethereum Blockchain on an Ethereum Virtual Machine. The Ethereum Blockchain returns a validation to the encryption/decryption module.

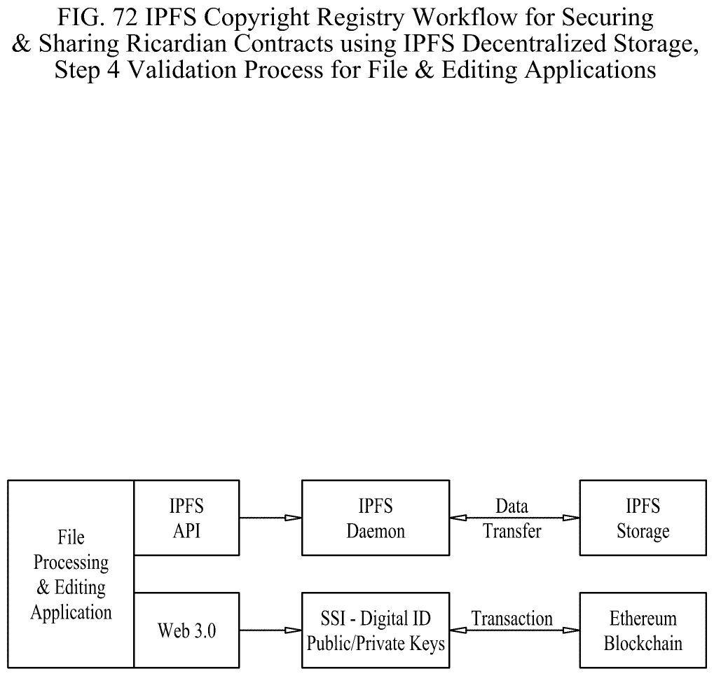

### FIG. 72

FIG. 72 is a diagram illustrating a Process Step for IPFS Validation Process for File and Editing Application. FIG. 72 shows a File Processing and Editing Application in communication with an IPFS API and a Web 3.0 module. The IPFS API communicates with an IPFS daemon which has duplex communication with the IPFS storage. The Web 3.0 module communicates with an SSI-Digital ID module for public and private key management, which has duplex transactions communications with Ethereum Blockchain.

### EXAMPLES

### Example—Music Transfer or Sharing

A song or collection of songs (transfer item) is identified and uploaded to the Web3 Platform using a Seller device having a Web3 Platform application. The inventive system for implementing a Blockchain based private NFT framework facilitates a private NFT auction of the transfer item in an NFT market for NFT buyers and sellers. All communications and transfers are performed using a high level of security, anonymity, and confidentiality. The Web3 Client Platform (“Platform”) has application logic, JavaScript, HTML, and CSS, and is in operative communication with the Ethereum Blockchain module (“EB module”), the EB module having Smart contract and/or Ricardian contract, Ricardian Contract, and Decentralized IDs. The Zero Trust Security Platform (“ZTS Platform”) communicates with the EB module and provides public key encryption, Self-Sovereign Identity Management (SSI), Digital Rights Management (DRM), Zero Knowledge Proofs, Multi-Party Computation, Homomorphic Encryption, and Elliptical curve Diffie Hellman (ECDH) encryption. The NFT Marketplace module (“NFT module”) communicates with the ZTS Platform to provide seller side ownership verification, creation of the NFT using NFT creation modules, and to provide buyer side certification and issue a token using a token issue module. The Peer-to-Peer Decentralized Network (“P2P de-Net”) communicates with the NFT module and provides DRM, IPFS, and WebRTC-QUIC, and using a HTTP/3-QUIC-UDP Transport layer protocol. The Mint NFT module communicates with the EB module and receives registration from a Seller-side module having SSI, a Wallet, and a browser. The Seller-side module communicates with the ZTS Platform, and the module having Ethernet Layer 2 NFT Scaling to communicate with the NFT module. The On-chain module communicates with the EB module and receives authentication from a Buyer-side module having SSI, a Wallet, and a browser, the Buyer-side module communicates with the ZTS Platform and the Buyer-side module communicates with an off-chain indexing protocol such as the Graph and with the NFT module.

### Example—Gaming

A game for sale or rental, or an in-game asset (transfer item) is identified and uploaded to the Web3 Platform using a Seller device having a Web3 Platform application. The inventive system for implementing a Blockchain based private NFT framework facilitates a private NFT auction of the transfer item in an NFT market for NFT buyers and sellers. All communications and transfers are performed using a high level of security, anonymity, and confidentiality using the system described herein.

### Example—Sports Betting

A bet (transfer item) is identified and uploaded to the Web3 Platform using a Seller device having a Web3 Platform application. The inventive system for implementing a Blockchain based private NFT framework facilitates a private NFT auction of the transfer item in an NFT market for NFT buyers and sellers. All communications and transfers are performed using a high level of security, anonymity, and confidentiality using the system described herein.

### Example—Book/Magazine/Print Transfer or Sharing

A book or magazine publication (transfer item) is identified and uploaded to the Web3 Platform using a Seller device having a Web3 Platform application. The inventive system for implementing a Blockchain based private NFT framework facilitates a private NFT auction of the transfer item in an NFT market for NFT buyers and sellers. All communications and transfers are performed using a high level of security, anonymity, and confidentiality using the system described herein.

### Example—Film Transfer or Sharing

A film (transfer item) is identified and uploaded to the Web3 Platform using a Seller device having a Web3 Platform application. The inventive system for implementing a Blockchain based private NET framework facilitates a private NFT auction of the transfer item in an NFT market for NFT buyers and sellers. All communications and transfers are performed using a high level of security, anonymity, and confidentiality using the system described herein.

### Example—Video Transfer or Sharing

A video (transfer item) is identified and uploaded to the Web3 Platform using a Seller device having a Web3 Platform application. The inventive system for implementing a Blockchain based private NET framework facilitates a private NFT auction of the transfer item in an NFT market for NFT buyers and sellers. All communications and transfers are performed using a high level of security, anonymity, and confidentiality using the system described herein.

### Example—Photo/Photo Collection Transfer or Sharing

A photo or collection of photos (transfer item) is identified and uploaded to the Web3 Platform using a Seller device having a Web3 Platform application. The inventive system for implementing a Blockchain based private NFT framework facilitates a private NFT auction of the transfer item in an NFT market for NFT buyers and sellers. All communications and transfers are performed using a high level of security, anonymity, and confidentiality using the system described herein.

### Example—Visual Arts/Collection Transfer or Sharing

A work of art or a collection of works (transfer item) is identified and uploaded to the Web3 Platform using a Seller device having a Web3 Platform application. The inventive system for implementing a Blockchain based private NFT framework facilitates a private NFT auction of the transfer item in an NFT market for NFT buyers and sellers. All communications and transfers are performed using a high level of security, anonymity, and confidentiality using the system described herein.

### Example—Home Real Estate Title and Documents Transfer

A set of real estate sales or leasing documents (transfer item) is identified and uploaded to the Web3 Platform using a Seller device having a Web3 Platform application. The inventive system for implementing a Blockchain based private NFT framework facilitates a private NFT auction of the transfer item in an NFT market for NFT buyers and sellers. All communications and transfers are performed using a high level of security, anonymity, and confidentiality using the system described herein.

### Example—Vehicle Title and Documents Transfer

A set of vehicle sales or leasing documents (transfer item) is identified and uploaded to the Web3 Platform using a Seller device having a Web3 Platform application. The inventive system for implementing a Blockchain based private NFT framework facilitates a private NFT auction of the transfer item in an NFT market for NFT buyers and sellers. All communications and transfers are performed using a high level of security, anonymity, and confidentiality using the system described herein.

### Example—Intellectual Property Transfer

A set of documents relating to an intellectual property or set/portfolio of intellectual properties, such as a patent, trade secret, trademark, copyright, design, and/or know-how (transfer item) is/are identified and uploaded to the Web3 Platform using a Seller device having a Web3 Platform application. The inventive system for implementing a Blockchain based private NFT framework facilitates a private NFT auction of the transfer item in an NFT market for NFT buyers and sellers. All communications and transfers are performed using a high level of security, anonymity, and confidentiality using the system described herein.

### FIG. 73

FIG. 73 is a diagram illustrating Tokenization of Patents for SMEs and Individuals using Blockchain NFTs and Artificial Intelligence (AI).

FIG. 73 describes the tokenization of physical assets and intellectual property (IP) such as patents and university research papers using a Private NFT Patent Platform design described herein comprising a Blockchain-based NFT technology with an integrated Artificial Intelligence (AI) module to provide adaptive computing, intelligent agents and learning algorithms to monetize physical assets such as patents and university research IP both traded and non-traded. Key benefits of tokenization include increased liquidity, faster settlement, lower costs, and bolstered risk management.

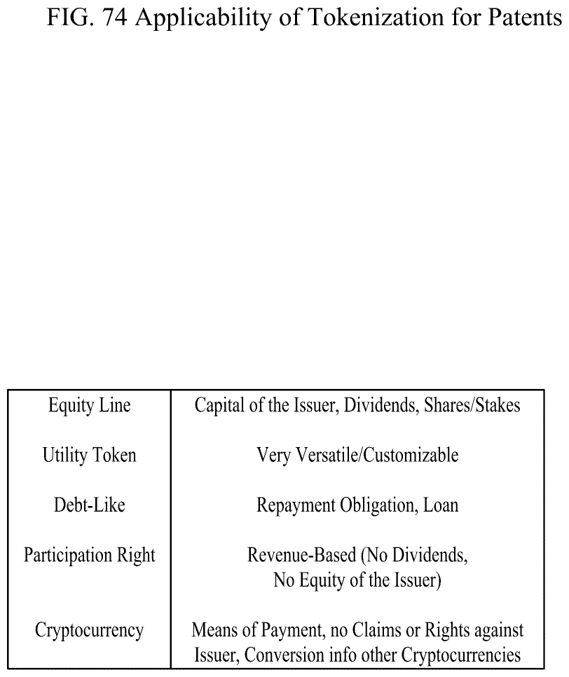

### FIG. 74

FIG. 74 is a diagram illustrating the Applicability of Tokenization for Patents

FIG. 74 shows that capital markets are still in the early phases of the adoption of Blockchain, and distributed ledger technologies (DLT) and the industry continues to seek viable use cases. One broad category of such use cases is the creation of digitally tokenized assets, in which the token either represents a property interest that exists only in the Blockchain (such as non-certificated securities) or represents an asset existing off the Blockchain. The tokenization of real-world assets continues to gain momentum, and investments are being made across the industry.

### Tokenization of Illiquid Assets Such as Patents and University Research IP for Investors, Banks and for Collateral Based Financial Transactions

While not new to the blockchain world, the tokenization of real-world assets is now attracting industry attention. Fundamentally, tokenization is the process of converting rights—or a unit of asset ownership—into a digital token on a blockchain. Tokenization can be applied to regulated financial instruments such as equities and bonds, tangible assets such as real estate, precious metals, and even to Tokenization of Copyright to works of authorship (e.g., music) and intellectual property such as patents. The benefits of tokenization are particularly apparent for assets not currently traded electronically, such as works of art or exotic cars, as well as those needing increased transparency in payment and data flows to improve their liquidity and tradability.

### The Benefits of Tokenization

The tokenization of physical assets brings a range of benefits to market participants:

Broader investor base: There is a limit to the level of fractionalization possible with real-world assets. Selling 1/20 of an apartment or a fraction of a company share is not currently practicable. However, if that asset is tokenized, this limitation is removed, and it becomes possible to buy or sell tokens representing fractions of ownership, allowing a far broader investor base to participate. A good example of how tokenization could change the dynamic of numerous assets is in the fine art market. The prohibitive prices that some artists command at auction means that only a highly restricted number of high-net-worth individuals have the means to invest in this asset, with most retail investors unable to participate. Issuing tokens that represent fractional ownership of an artwork may fundamentally change the situation. For example, the property rights in the most valuable painting by Jean-Michel Basquiat—sold for an eyewatering $110 million by Sotheby's in 2017—could be tokenized, affording even small retail investors the opportunity to acquire a fractional interest in the painting. Tokenization would therefore open the market to a whole new set of investors, now able to diversify their investment portfolios into asset classes previously well out of their reach.

Broader geographic reach: Public blockchains are inherently global in nature because they present no external barrier to the global population and investor. However, in the Institutional Market, relevant KYC (Know Your Client) and AML (Anti-Money Laundering) laws and programs must be followed, and hence the broader adoption of public blockchains has been curbed. Nonetheless, several public blockchains are now performing KYC and AML—and this evolution and trust is expanding the footprint of these digital, Tokenized assets. Importantly, permissioned blockchains are also evolving, providing an important step for the Institutional investor.

Tokenization has potential to improve investment managemenReduced settlement times: Tokenization can reduce transaction times, potentially by permitting 24×7 trading, and as smart contracts triggered by predefined parameters can instantaneously complete transactions, reduce settlement times from the current durations, at best T+2, to essentially real-time transactions. This can reduce counterparty risk during the transaction and reduce the possibility of trade breaks. Infrastructure upgrade: For many asset classes, fundraising and trading remain slow, laborious, and require an exchange of paper-based documents. By digitizing these assets on a DLT infrastructure, efficiency in these markets can be vastly improved, with effects further amplified in areas that currently have non-existent traditional infrastructure

Decreased cost for reconciliation in securities trading: The blockchain infrastructure provides a digital ledger for the record keeping of each shareholder position. For the issuer, this will greatly improve the efficiency of numerous administrative processes, such as profit sharing, voting rights distribution, buy-backs, and so on. Further, the existence of a secondary market will also facilitate the accounting operations of professional investors, such as net-asset-value calculations. As the market becomes more comfortable with the digital ledger as the “golden copy” of data, reconciliation may be completely obviated, as the parties will rely on and accept this record.

Regulatory evolution: There is a slow but steady movement by regulators in developed markets to lay the foundation of regulatory frameworks for the creation and exchange of digital asset tokens. Importantly, the real-time data and immutability of data held in a digital ledger will enhance the role that regulators aim to improve—clarity and protection for investors.

Improved asset-liability management: Tokenization will improve the ability to manage asset-liability risk through accelerated transactions and improved transparency.

Increase in available collateral: By accelerating and improving the fractionalization of new asset classes, tokenization will expand the range of available and acceptable collateral beyond traditional assets. This will significantly increase the options available to market participants when selecting non-cash assets as collateral in the securities lending or repo markets. Coupled with the holistic benefits of Tokenization described above, collateral management globally may be more efficient, transparent, and relevant in new asset classes.

### EQUIVALENTS

Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited, unless so stated, to methods, order of processing steps, components, materials, systems, partial aspects of processes, components or systems, uses, compounds, compositions, standards, routines, modes, computers, hardware, firmware, and software programming which can, of course, vary. It is also to be understood that the terminology used herein is for the purpose of describing embodiments only and is not intended to be limiting unless specifically stated.

While various embodiments have been described above, they have been presented by way of example only, and not limitation. Where methods described above indicate events occurring in specific order, the ordering of events is sequential, but the invention contemplated herein may also include modifications that do not depart from the scope and spirit of the invention. Additionally, certain of the events may be performed concurrently in a parallel process, when possible, as well as performed sequentially as described above.

Where schematics and/or embodiments described above indicate certain components arranged in certain orientations or positions, the arrangement of components is specified, but the invention contemplated herein may also include modifications that do not depart from the scope and spirit of the invention.

While the embodiments have been particularly shown and described, it will be understood that various changes in form and details may be made. Any portion of the apparatus and/or methods described herein may be combined in any combination, except mutually exclusive combinations. The embodiments described herein can include various combinations and/or sub-combinations of the functions, components, and/or features of the different embodiments described that do not depart from the scope and spirit of the invention. Various of the above-disclosed and other features and functions, or alternatives thereof, may be combined into many other different systems or applications that do not depart from the scope and spirit of the invention.

Various presently unforeseen or unanticipated alternatives, modifications, variations, or improvements therein may be subsequently made by those skilled in the art, each of which is also intended to be encompassed by the disclosed embodiments. It is therefore to be understood that within the novel, unobvious, enabled, and described scope of the broadest reasonable interpretation of the appended claims, the invention may be practiced otherwise than as narrowly described. Accordingly, all such modifications are intended to be included within the novel, unobvious, enabled, and described scope of this invention as defined in the broadest reasonable interpretation of the following claims.

What is claimed as the invention:

1. A system for private NFT architecture with Zero Trust Security platform, comprising:
a Web3 Client Platform (“Platform”) having application logic, JavaScript, HTML, and CSS;
an Ethereum Blockchain module (“EB module”) in operative communication with the Platform, the EB module having a Smart contract and/or Ricardian contract module, and a Decentralized ID module;
a Zero Trust Security Platform (“ZTS Platform”) in operative communication with the EB module, the ZTS platform having a public key encryption module, a Self-Sovereign Identity Management (SSI) module, a Digital Rights Management (DRM) module, a Zero Knowledge Proofs module, a Multi-Party Computation module, a Homomorphic Encryption module, and an Elliptical curve Diffie Hellman (ECDH) encryption module;
an NFT Marketplace module (“NFT module”) in operative communication with the ZTS Platform and having a seller side ownership verification module and an NFT creation module, and a buyer side certification and token issue module;
a Peer-to-Peer Decentralized Network (“P2P de-Net”) in operative communication with the NFT module and having a second DRM module, an IPFS module, and a WebRTC-QUIC platform, the P2P de-Net using a HTTP/3-QUIC-UDP Transport layer protocol;
a Mint NFT module in operative communication with the EB module and configured to receive registration from a Seller-side module, the Seller-side module having SSI, a Wallet, and a browser, the Seller-side module in operative communication with the ZTS Platform, and the Seller-side module in operative communication with an Ethernet Layer 2 NFT Scaling module, the Ethernet Layer 2 NFT Scaling module in operative communication with the NFT module; and
an On-chain module in operative communication with the EB module and configured to receive authentication from a Buyer-side module having SSI, a Wallet, and a browser, the Buyer-side module in operative communication with the ZTS Platform and the Buyer-side module in operative communication with an off-chain indexing protocol comprising the Graph with open API subgraphs configured for querying networks selected from Ethereum and IPFS to make data easily accessible for off-chain indexing and where the Buyer-side module is in operative communication with the NFT module.

2. A method, comprising:
implementing a Blockchain based private NFT framework to facilitate both public and private or private NFT auctions in an NFT market for NFT buyers and sellers who require security, anonymity, and confidentiality for NFT applications including art, gaming, intellectual property including patents, university research publications, sports betting, real estate, and music,
the Blockchain based private NET framework comprising:
a Web3 Client Platform (“Platform”) having application logic, JavaScript, HTML, and CSS;
an Ethereum Blockchain module (“EB module”) in operative communication with the Platform, the EB module having a Smart contract and/or Ricardian contract module, and a Decentralized ID module;
a Zero Trust Security Platform (“ZTS Platform”) in operative communication with the EB module, the ZTS platform having a public key encryption module, a Self-Sovereign Identity Management (SSI) module, a Digital Rights Management (DRM) module, a Zero Knowledge Proofs module, a Multi-Party Computation module, a Homomorphic Encryption module, and an Elliptical curve-Diffie Hellman (ECDH) encryption module;
an NFT Marketplace module (“NFT module”) in operative communication with the ZTS Platform and having a seller side ownership verification module and an NFT creation module, and a buyer side certification and token issue module;
a Peer-to-Peer Decentralized Network (“P2P de-Net”) in operative communication with the NFT module and having a second DRM module, an IPFS module, and a WebRTC-QUIC platform, the P2P de-Net using a HTTP/3-QUIC-UDP Transport layer protocol;
a Mint NFT module in operative communication with the EB module and configured to receive registration from a Seller-side module, the Seller-side module having SSI, a Wallet, and a browser, the Seller-side module in operative communication with the ZTS Platform, and the Seller-side module in operative communication with an Ethernet Layer 2 NFT Scaling module, the Ethernet Layer 2 NFT Scaling module in operative communication with the NFT module; and
an On-chain module in operative communication with the EB module and configured to receive authentication from a Buyer-side module having SSI, a Wallet, and a browser, the Buyer-side module in operative communication with the ZTS Platform and the Buyer-side module in operative communication with an off-chain indexing protocol comprising the Graph with open API subgraphs configured for querying networks selected from Ethereum and IPFS to make data easily accessible for off-chain indexing and where the Buyer-side module is in operative communication with the NFT module.

3. The system of claim 1, comprising a Zero Trust Security Enclave (ZTSE) module configured to secure and restrict user access to a private NFT auction to authorized and vetted buyers and sellers.

4. The system of claim 3, wherein the Zero Trust Security Enclave comprises:
a Zero Trust Architecture module having a Web3 Decentralized Network module with a Blockchain-Smart contract and/or Ricardian contracts module and a UDP-QUIC Protocol Stack module using a HTTP/3-QUIC-UDP Transport layer protocol; and
the Zero Trust Security Architecture module configured with a public key encryption module, a Self-Sovereign Identity Management (SSI) module, Digital Rights Management (DRM) module, a Zero Knowledge Proofs module, a Multi-Party Computation module, an Homomorphic Encryption module, and an Elliptical curve-Diffie Hellman (ECDH) encryption module.

5. The system of claim 1, implemented in a Private NFT Marketplace, comprising: (i) an Ownership Verification module; (ii) a Certification module; (iii) an NFT Creation module; and (iv) a Token Issuance module.

6. The system of claim 1, implemented in a Web 3 Architecture, comprising: (i) a plurality of Digital Wallets based on the SSI module; (ii) a UI/Application Logic module; and wherein the Ethernet Layer 2 NFT Scaling module is a L2 Scaling-Sharding-Rollups module.

7. The system of claim 1, implemented in a Peer-to-Peer Network, comprising: (i) an IPFS Decentralized p2p Storage module; and (ii) a WebRTC-QUIC p2p Multimedia Communications module using a HTTP/3-QUIC-UDP Transport layer protocol and having a Video Channel—Zero latency module, a Data Channel—Content Messaging+Attachments module, and a Voice Channel—VOIP module.

8. A Web3 Technologies system, comprising: (i) Web3 Clients; (ii) Self-Sovereign Identity Management (SSI) and Digital Wallet; (iii) UI/Application Logic (JavaScript, HTML); (iv) Off-chain NFT Indexing; (v) Blockchain; (vi) Smart contract and/or Ricardian contracts—DAPPS; (vii) Layer 2 NFT Scaling.

9. The system of claim 1, comprising an NFT Security module configured to provide:
a User Authentication module;
a Blockchain Smart contract and/or Ricardian contracts module;
an NFT Minting module;
an On-Chain Storage module;
an Off-Chain Indexing module;
an Off-Chain Storage module; and
an External Security Issues module having
a ERC-721 Compliance Vulnerabilities module;
an Counterfeit NFT Product creation module;
a Fraudulent NFT Trading Practices module; and
an External Document & Smart contract and/or Ricardian contract Theft module.

10. The system of claim 1, comprising a IPFS Peer-to-Peer Protocol Network module for storing and sharing Blockchain data and smart contract and/or Ricardian contracts.

11. The system of claim 1, comprising a WebRTC-QUIC for private video chats and secure content messaging between buyers and sellers using real-time communications:
QUIC Transport Layer Network Protocol
Low latency video (P2P)
Content messaging (P2P)

12. The system of claim 1, comprising a Digital Rights Management module configured for using content rendering and watermarking.

13. The system of claim 1, comprising a Blockchain-Artificial Intelligence Integration module having: (i) a Decentralized AI Applications module configured to provide (a) Adaptive computing, (b) Discovery and Management, (c) Intelligent Agents (d) Learning Algorithms; and (ii) a Decentralized AI Operations module configured to provide (a) IPFS Decentralized Storage, (b) Data Management, (c) Learning Models; and (iii) a Decentralized Infrastructure for AI Applications module configured to provide (a) Linear Blockchain, (b) Non-Linear Blockchain and (c) Tokenization of Illiquid Assets such as patents and university research papers using AI Applications in which the token represents a property interest that exists in Blockchain (such as a non-certified security) or represents an asset existing off the Blockchain to securitize the assets, both traded and non-traded for small businesses (SMEs) and individuals.

14. The system of claim 1, comprising a Screen capture Disablement module for Private NFT Images (Pictures Art, Photos) shared Between Private NFT Buyers and Sellers.

15. The system of claim 1, comprising an International Private NFT Patent and IP Marketplace module configured to provide
an Embedded Automatic royalty collecting module;
a Licensed Revenues module;
a Digital Assets (Patents, Movies, Art, Virtual Creations) module; and
an International Patent NFT Marketplace module Integrated with USPTO and WIPO.

16. The system of claim 1, wherein the Web3 client Platform having a UI application in JavaScript; the Web3 platform is connected to a platform having a side chain Oracle gateway with off chain component receiving inputs from a first main chain having Ethereum on-chain and a second main chain having an alternative on-chain Blockchain selected from Cardano, IBM, Polkadot, Solana; the Self-Sovereign ID and digital wallet are configured to input into both first main chain and second main chain; a separate SSI-protected digital wallet configured to input into a second main chain; the Oracle gateway module is in communication with an IPFS file processing and management system module; the IPFS file processing and management system module is configured to provide registration and authentication functions, file, creation, and storage functions, file access and retrieval functions, and file, validation and editing functions; the SSI digital wallets are in communication with the IPFS file processing and management system and configured to authenticate the communications; an IPFS P2P storage gateway module configured to use web transport UDP-QUIC protocols to communicate with the IPFS file processing and management system; the IPFS P2P storage gateway module configured to include smart contract and/or Ricardian contracts, content addressing, content linking, directed acyclic graphs, (DAG), and Content discovery via DHT; the SSI digital wallet configured to provide authenticated communication with the IPFS P2P storage gateway module; a private NFT module having a smart contract and/or Ricardian contract, a digital wallet, and DRM functions, configured to use Web Transport UDP-QUIC communications protocol to communicate with the IPFS P2P storage gateway; the buyer private NFT module, and the seller private NFT module configured to be in duplex communication across a media channel, a separate data channel, and configured to use the WebRTC-UDP/QUIC protocol(s).

17. The system of claim 1, implemented to manage an NFT Based Patent Framework and Copyright Validation and verification System Integrated with the USPTO and WIPO, comprising: an application layer module includes connections to external databases selected from a USPTO database, a WIPO database, and a university research database, configured to provide a patent information and retrieval system; the Blockchain layer module includes the NFT Minting component connected to the Blockchain having Ricardian contracts and connected to the on-chain storage; an authentication layer (DIDs) module and verification layer module is connected to a zero trust security enclave; the zero trust security enclave includes self-sovereign identity (SSI) and digital wallet; the zero trust security enclave also includes a DRM component, a zero knowledge proofs component, a digital watermark component, and a multi-party computation (MPC) component; an NFT indexing scaling module includes components for scaling, sidechains, rollup, and indexing tokens and DeFi distributed finance.

18. The method of claim 2, implemented in a system for managing an NFT Marketplace, comprising: providing an NFT marketplace module in communication with an IPFS Gateway Copyright Registry module, an IPFS Decentralized Storage module, a WebRTC-QUIC/UDP Communications module, and an NFT Copyright Insurance module; the NFT marketplace includes a patent seller having an NFT marketplace application on a seller smart device and a patent buyer having the NFT marketplace application on a buyer smart device, the NFT marketplace application is configured to input the patent seller ownership information, verification and creation of an NFT, and the NFT marketplace application is configured to input the patent buyer copyright certification requirement, and to issue a token; an IPFS gateway registry has a copyright registry, an NFT, contract, hash, and an owner hidden signature; an IPFS decentralized storage module has an IPFS peer to peer storage component, Ricardian contract component, DHT hash component, Merkel DAG component, content addressing component, content linking component, and content discovery component; a WebRTC-QUIC/UDP communications module has a seller SSI digital wallet with a browser extension and a buyer SSI digital wallet with a browser extension that are in peer to peer secure communication for transferring voice, data, and video communications; an NFT copyright insurance module includes a data breach component, a cyber hack component, and a crime damage component;
inputting the patent seller ownership information into the NFT marketplace application;
verifying and creating the NFT;
inputting the patent buyer copyright certification requirement, and issuing a token; and
transacting the sale from seller to buyer.

19. The method of claim 18, the NFT scaling module receives input from the zero trust security module; the off chain indexing module receives input from the zero trust security module; the NFT marketplace module includes the seller component, buyer component, ownership component, verification component, copyright component, certification component, the create NFT module, and the issue token module; the IPFS gateway registry module receives input from the NFT marketplace module; the IPFS gateway registry module includes the copyright component, the registry component, the contract component, the hash, and hidden signature; the IPFS decentralized storage module is connected to the IPFS gateway registry module; the IPFS decentralized storage module includes a Ricardian contract and receives input as a DHT hash and Merkel DAG.
